(19) United States
(12) Patent Application Publication
(10) Pub. No.: US 2019/0098723 A1
(43) Pub. Date: Mar. 28, 2019

(54) High Capacity Flexible Lighting Fixture, System and Method

(71) Applicant: InnoSys, Inc., Salt Lake City, UT (US)

(72) Inventors: Laurence P. Sadwick, Salt Lake City, UT (US); Trent Mortensen, Salt Lake City, UT (US); Derrick K. Kress, Salt Lake City, UT (US); Ruey-Jen Hwu, Salt Lake City, UT (US)

(21) Appl. No.: 16/116,670

(22) Filed: Aug. 29, 2018

Related U.S. Application Data
(60) Provisional application No. 62/564,693, filed on Sep. 28, 2017.

(51) Int. Cl. H05B 33/08; F21V 23/06; F21K 9/272

(52) U.S. Cl. CPC H05B 33/0866; H05B 33/0896; F21K 9/272; F21V 23/06

(57) ABSTRACT

A flexible lighting system includes a number of lamp fixtures, at least one solid state lighting driver connected to the lamp fixtures, a controller configured to control electrical current through the at least one solid state lighting driver, a monitor configured to monitor at least one electrical characteristic of power to the lamp fixtures, and at least one sensor connected to the controller.

### BACKGROUND

Fluorescent lamps are widely used in a variety of applications, such as for general purpose lighting in commercial and residential locations, in backlights for liquid crystal displays in computers and televisions, etc. Conventional fluorescent tubes used for general lighting cannot, in general, be directly plugged into alternating current (AC) voltage lines. Fluorescent lamps generally include a glass tube, circle, spiral, ‘U-shaped’ or other shaped bulbs containing a gas at low pressure, such as argon, xenon, neon, or krypton, along with low pressure mercury vapor. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies.

Electronic ballasts convert the input AC voltage supplied (typically at a low AC frequency of 50 or 60 Hz) power into generally a sinusoidal AC output waveform typically designed for a constant current output in the frequency range of above 20 to 40 kHz to typically less than 100 kHz and sometimes greater than 100 kHz.

Fluorescent lamps can suffer from a number of disadvantages, such as a relatively short life span, flickering, difficulty with being dimmed, etc.

### SUMMARY

Various embodiments of the present invention provide solid state lighting systems that can be used to replace fluorescent lamps in existing fluorescent lighting fixtures, either with the ballast in place or removed. The present invention also relates to lighting systems with controllable color and/or illumination levels to provide appropriate wavelength lighting at appropriate times as determined by, for example, time of day or night, timing, scheduling, events, environment, purpose, use, need, etc.

The embodiments shown and discussed are intended to be examples of the present invention and in no way or form should these examples be viewed as being limiting of and for the present invention.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Additional embodiments are disclosed in the following detailed description, the appended claims and the accompanying drawings.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIGS. 1-44 depict block diagrams of a lighting system in various arrangements, with and without auxiliary power outputs, rectifiers, and with various types of regulation.

FIG. 45 is a block diagram of an embodiment of a solid state fluorescent replacement lighting system receiving power from both AC input and ballast output in accordance with some embodiments of the invention.

FIG. 46 is a block diagram of an embodiment of a solid state fluorescent replacement lighting system receiving power from both AC input and ballast output and with rectified and optional EMI filtering in accordance with some embodiments of the invention.

FIG. 47 is a block diagram of an embodiment of a solid state fluorescent replacement lighting system receiving power from both AC input and ballast output and with rectified and optional EMI filtering in accordance with some embodiments of the invention.

FIG. 48 is a block diagram of an embodiment of a solid state fluorescent replacement lighting system receiving power from a ballast output and with lighting and power supply outputs in accordance with some embodiments of the invention.

FIG. 49 is a block diagram of an embodiment of a solid state fluorescent replacement lighting system receiving power from both AC input and ballast output and with lighting and power supply outputs in accordance with some embodiments of the invention.

FIG. 50 is a block diagram of an embodiment of a solid state fluorescent replacement lighting system receiving power from both AC input and ballast output, with a switching regulator, and with lighting and power supply outputs in accordance with some embodiments of the invention.

FIG. 51 is a block diagram of an embodiment of a solid state fluorescent replacement lighting system receiving power from both AC input and ballast output, with a series regulator, and with lighting and power supply outputs in accordance with some embodiments of the invention.

FIGS. 52-61 depict block diagrams of solid state lighting systems that can be powered by both AC lines and ballast outputs and can be remote controlled and dimmed, and in some embodiments color or color temperature tuned, in both modes in accordance with some embodiments of the invention.

FIG. 62 depicts a solid state lighting system with intelligent controller providing current control feedback based on a variety of sources, such as, but not limited to, one or more of an output current sensor, output voltage sensor, powerline interface, serial interface and/or other interfaces in accordance with some embodiments of the invention.

FIG. 64 depicts a power conversion stage circuit in accordance with some embodiments of the invention.

FIG. 65 depicts a dual power source circuit in accordance with some embodiments of the invention.

FIG. 66 depicts a dual power source circuit with tagalong inductor to power internal circuits in accordance with some embodiments of the invention.

FIG. 67 depicts a boost power supply circuit that can be used in some embodiments of a solid state fluorescent replacement lighting system for either or both lighting or secondary power supply in accordance with some embodiments of the invention.

FIG. 68 depicts a buck-boost power supply circuit that can be used in some embodiments of a solid state fluorescent replacement lighting system for either or both lighting or secondary power supply in accordance with some embodiments of the invention.

FIG. 69 depicts a flyback converter power supply circuit that can be used in some embodiments of a solid state fluorescent replacement lighting system for either or both lighting or secondary power supply in accordance with some embodiments of the invention.

FIG. 70 depicts a flyback converter power supply circuit with half bridge that can be used in some embodiments of a solid state fluorescent replacement lighting system for either or both lighting or secondary power supply in accordance with some embodiments of the invention.

FIG. 71 depicts a buck-boost power supply circuit with inverted output that can be used in some embodiments of a solid state fluorescent replacement lighting system for either or both lighting or secondary power supply in accordance with some embodiments of the invention.

FIG. 72 depicts a buck power supply circuit that can be used in some embodiments of a solid state fluorescent replacement lighting system for either or both lighting or secondary power supply in accordance with some embodiments of the invention.

FIG. 73 depicts a forward converter power supply circuit with full bridge that can be used in some embodiments of a solid state fluorescent replacement lighting system for either or both lighting or secondary power supply in accordance with some embodiments of the invention.

FIG. 74 depicts a power supply circuit with feedback control that can be used in some embodiments of a solid state fluorescent replacement lighting system in accordance with some embodiments of the invention.

FIG. 75 depicts a power supply circuit with feedback control and variable input capacitor that can be used in some embodiments of a solid state fluorescent replacement lighting system in accordance with some embodiments of the invention.

FIG. 76 depicts a solid state fluorescent lamp replacement input stage for receiving power from a ballast output in accordance with some embodiments of the invention.

FIG. 77 depicts a solid state fluorescent lamp replacement input stage with heater emulation circuits for receiving power from a ballast output in accordance with some embodiments of the invention.

FIG. 78 depicts a solid state fluorescent lamp replacement input stage with EMI filtering for receiving power from a ballast output in accordance with some embodiments of the invention.

FIG. 79 depicts a power supply circuit with output control that can be used in some embodiments of a solid state fluorescent replacement lighting system in accordance with some embodiments of the invention.

FIG. 80 depicts a solid state fluorescent lamp replacement input stage with variable capacitance circuit in accordance with some embodiments of the invention.

FIG. 81 depicts a pulse-width modulated (PWM) or one-shot controller or other control signal including, but not limited to a linear signal(s), that can be used to generate the variable capacitance control signal to control the AC switch across the power input of FIG. 55 to regulate the output current and/or power in accordance with some embodiments of the invention.

FIG. 82 depicts a circuit schematic of an example embodiment of a solid state fluorescent lamp replacement where, among other things, shunting is used to set the solid state light output that can be remote controlled and monitored in accordance with some embodiments of the invention.

FIG. 83 depicts a ballast sequencing circuit in accordance with some embodiments of the invention.

FIG. 84 depicts a solid state lighting power supply that can draw power from a fluorescent lamp fixture to power a lighting system and to provide power for internal circuits, sensors or other applications in accordance with some embodiments of the invention.

FIG. 85 depicts a ballast detection circuit that can be used, for example, to gate other circuits to enable or disable power from a ballast output or to detect whether a ballast is present in accordance with some embodiments of the invention.

FIGS. 86-88 depict block diagrams of identification circuits that can be used to identify, interact, work with, turn on or off, dim, etc. solid state fluorescent lamp replacements in a solid state lighting system, powered by one or more of multiple sources in accordance with some embodiments of the invention.

FIGS. 89-91 depict block diagrams of solid state lighting systems with isolated control inputs in accordance with some embodiments of the invention.

FIG. 92 depicts a lighting control system with wireless communications in accordance with some embodiments of the invention.

FIG. 93 depicts a lighting control system with wired and wireless communications in accordance with some embodiments of the invention.

FIG. 94 depicts an in-socket solid state lighting-compatible flexible fixture that allows for analog and/or digital control/interface pins/connections that allows for safe electrical, mechanical and other connections and installation in accordance with some embodiments of the invention.

FIG. 95 depicts a lighting fixture that allows a flexible number of lamps from 1 to N (N=12 in FIG. 1). Such a complete system could include typically a controller and monitor and one or more (i.e., multiple) solid state lighting drivers and sensors including Internet of Things (IOT) sensors and other devices in accordance with some embodiments of the invention.

FIG. 96 depicts another example solid state lighting-compatible flexible fixture including the arrangements of the lamps and example connections in accordance with some embodiments of the invention.

FIG. 97 depicts a solid state light mounted in an in-socket solid state lighting-compatible controller/dimmer with a holding bar in an open position, enabling tombstones and/or other similarly functioning electrical and mechanical connections to be attached and moved in accordance with some embodiments of the invention.

FIG. 98 depicts a solid state light mounted in an in-socket solid state lighting-compatible controller/dimmer with a holding bar in a closed position, holding tombstones and/or other similarly functioning electrical and mechanical connections in place in accordance with some embodiments of the invention.

### DETAILED DESCRIPTION OF THE INVENTION

The present invention relates to solid state lighting systems that can be used to replace fluorescent lamps in existing fluorescent lighting fixtures, either with the ballast in place or removed. Embodiments of the present invention also allows either direct ballast or direct alternating current (AC) power or combinations of these to be applied or direct DC power to be applied including but not limited to off grid, solar or other alternative energy sources, emergency backup generation, combinations of these, etc. The present invention also relates to lighting systems with controllable color and/or illumination levels to provide appropriate wavelength lighting at appropriate times as determined by, for example, time of day or night, timing, environment, purpose, use, need, etc.

The present invention can, for example, use shorter (i.e., blue) wavelength light to stimulate and awaken or support waking and healthy state functionality and use longer (i.e., yellow, amber, red, etc.) wavelength light to promote sleep and rest state. For example, amber light emitting diodes (LEDs) and/or organic light emitting diodes (OLEDs) can be used for sleep and blue LED(s) or OLED(s) or other sources of light including but not limited to quantum dots (QDs) for waking and to simulate the exposure to natural sunlight. Other colors including but not limited to orange, yellow-orange, yellow, etc. can also be used. The LEDs, OLEDs, QDs, etc. can be separate colors, panels, or integrated, layered, etc. colors on the same panel and can be of any type and construction. Embodiments of the present invention can use external information such as time of day/night, light levels, computers, websites, smart phones, clocks, atomic clocks, Internet of Things (MT) devices or sources and other wired and wireless timing information including weather and weather-related information, time of sunrise and/or time of sunset, etc. combinations of these, etc., to determine whether to have amber (or yellow or red, etc.), blue or both turned on. AC power, solar power, wind power, geothermal power, mechanical vibration, alternative energy, batteries, or a combinations of these, etc. can be used to provide power to the OLEDs, LEDs, QDs, other types of SSL, combinations of these, etc. Embodiments of the present invention can use a portable LED, OLED, QD, combinations of these, etc. tube, tubes, panel or panels, other types and sizes (from small to very larger and bigger including tiled, stacked, etc.) panels including troffers, task lamps, bed lamps, table lamps, under counter, over counter, vanity, wall, ceiling, sconce, luminaires, sleep detectors, wearable sleep detectors and circadian rhythm detectors, etc. Embodiments of the present invention can be a fluorescent tube replacement of any length and any diameter that contains multiple color light sources with or without a white light source which can be controlled (i.e., turned on, dimmed) in ways to produce shorter visible wavelength containing light for waking up and waking hours and produce longer visible wavelength containing light with the absence of or greatly reduced shorter wavelength content light for sleeping and resting as well as other types of lights including but not limited to A lamps (including E26 and E27 socket lamps), PAR lamps (including PAR30 and PAR38), R lamps (including R30), flood lamps, PL 2 or 4 pin lamps, MR lamps (including MR16), GU lamps (including GU10), low voltage lamps, low voltage magnetic lighting, etc., combinations of these, etc. Embodiments of the present invention can include circuit implementations that are able to receive and ‘read’, for example, ‘atomic clock’ signals that can be used with other information about geographic location. Such time and position information can, for example, be obtained automatically by using, as an example, a global positioning system (GPS)—which also have their own atomic clocks—which can receive the 60 kHz low frequency transmission, for example sent/transmitted in the USA from Colorado—and the same frequency or relatively similar frequencies in other countries and continents. Such time and position information can be used to set the Circadian Rhythm system to the ‘proper’ phase. In some embodiments of the present invention, the ‘proper’ phase can be overridden and set to a different part of the phase, for example, for shift workers who work at night and sleep during the day or part of the day. This could be manually or automatically determined and set based on, for example, the work and sleep schedule of an individual or groups of individuals, along with potentially other information, etc.

Embodiments of the present invention can be used to provide multiple channels of the lighting output that can be separately, individually or collectively, etc. controlled. Such one or more channels can be of the same color, different colors including color temperatures. The one or more channels can be used one at a time or more than one at a time to create particular light spectra, broadband spectra, narrow spectra, spectrum response, wavelength or wavelengths, etc., spectra suitable for plant growth, healthcare, senior care, circadian rhythm, light therapy, etc. The one or more light sources, including but not limited to, solid state lighting (SSL) such as but not limited to LEDs including phosphor coated LEDs, OLEDs, QDs, etc., combinations of these, etc.

Embodiments of the present invention can also provide a power output including isolated (e.g., galvanic) power and one or more control inputs for the one or more light channels that allows various methods, protocols, interfaces to be used to control (i.e., dim, flash, trim, turn off, turn on, etc.) the one or more light channels. For example, one or more 0 to 10 V, 0 to 3 V analog, DALI, DMX, DMX512, RS485, RS232, SPI, I2C, USB, other serial protocol digital control inputs, etc., combinations of these as well as powerline control (PLC) as well as wireless control including but not limited WiFi, Bluetooth, Bluetooth Low Energy (BLE), Zigbee, Zigbee Lite, Zwave, Thread, 6LoWPAN, LoRa, ISM, Sub-GHz, cellular mobile communications, infrared, IrAD, LiFi, other optical communications, etc., combinations of these, etc. The one or more power output(s) can be used to, for example, but not limited to, power sensors, controls, IOT,

In certain embodiments, monitoring, logging, analytics, etc. can be built in to implementations of the present invention so as to allow power monitoring, logging and analytics, etc. of the lighting and associated items, accessories, IOT, sensors, controls, cameras, motion sensors, light sensors, temperature sensors, humidity sensors, carbon monoxide sensors, carbon dioxide sensors, spectrum or spectral sensors, proximity sensors, thermal imaging sensors, etc. Such sensors, including spectral sensors, can be powered by the lamps, drawing current from, for example but not limited to, an AC input or ballast output in a fluorescent lamp fixture, a DC source, solar, wind, geothermal or other alternative energy harvesting sources, methods and approaches, etc., combinations of these, etc.

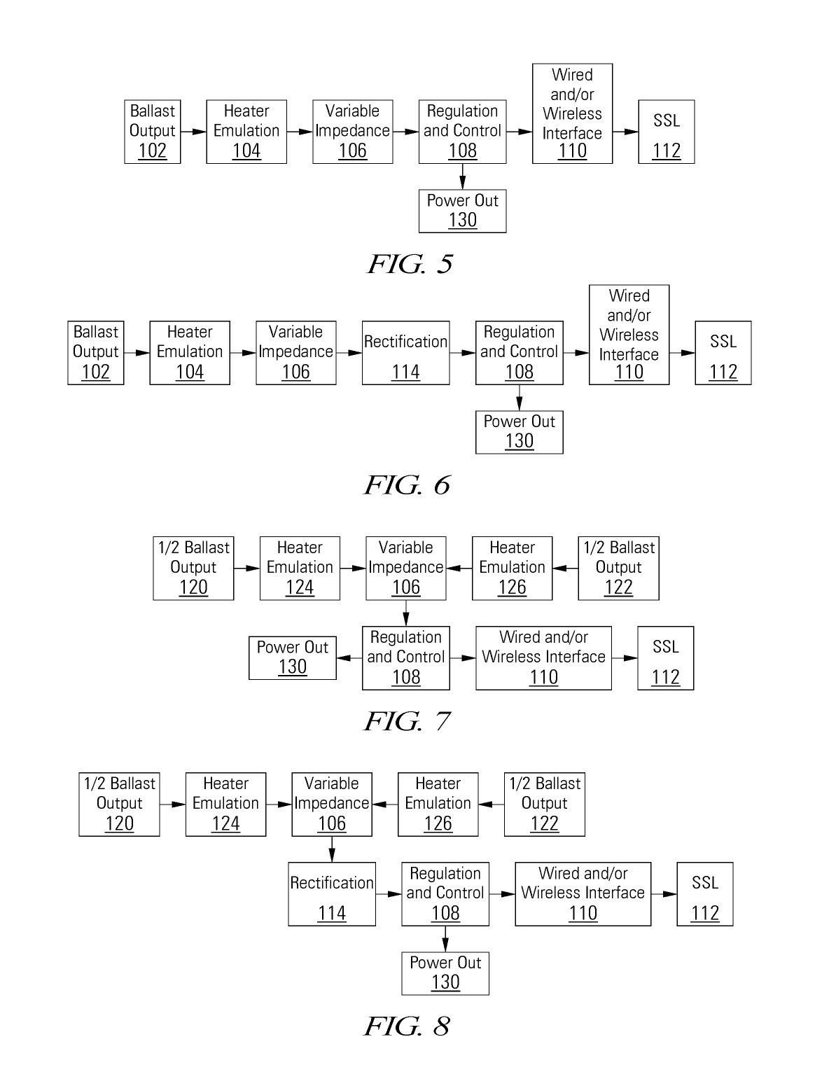

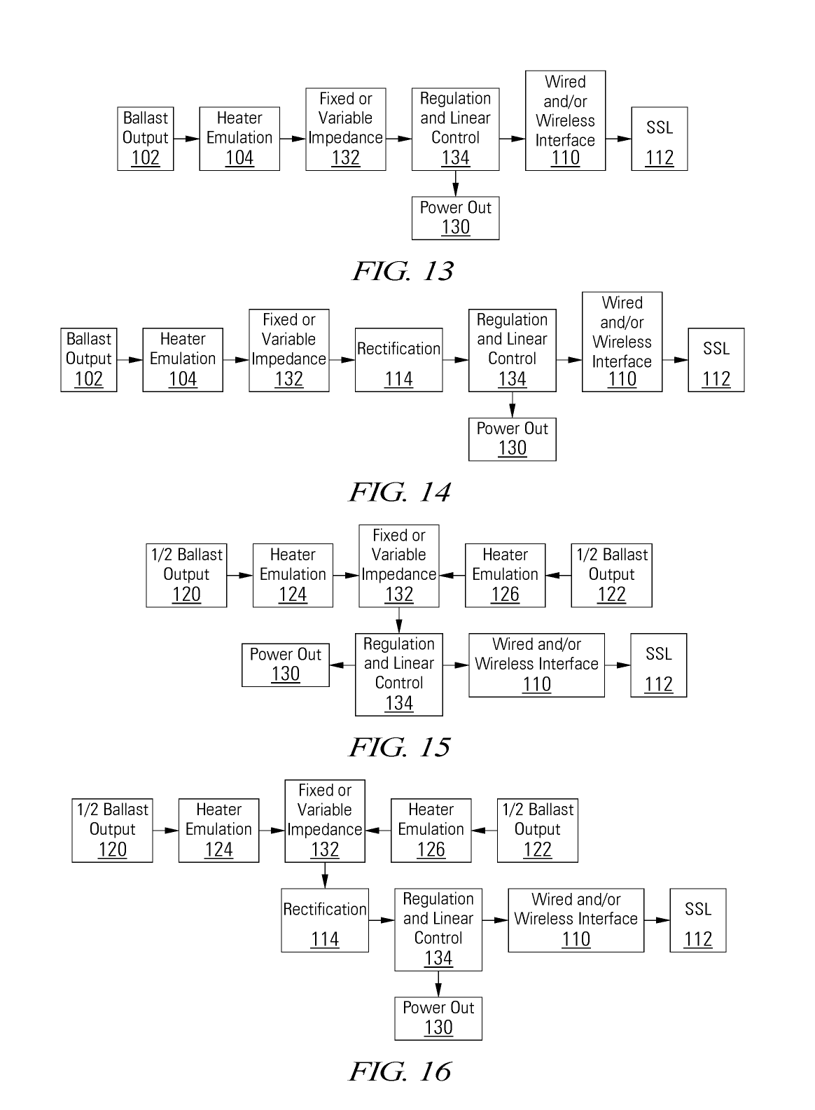

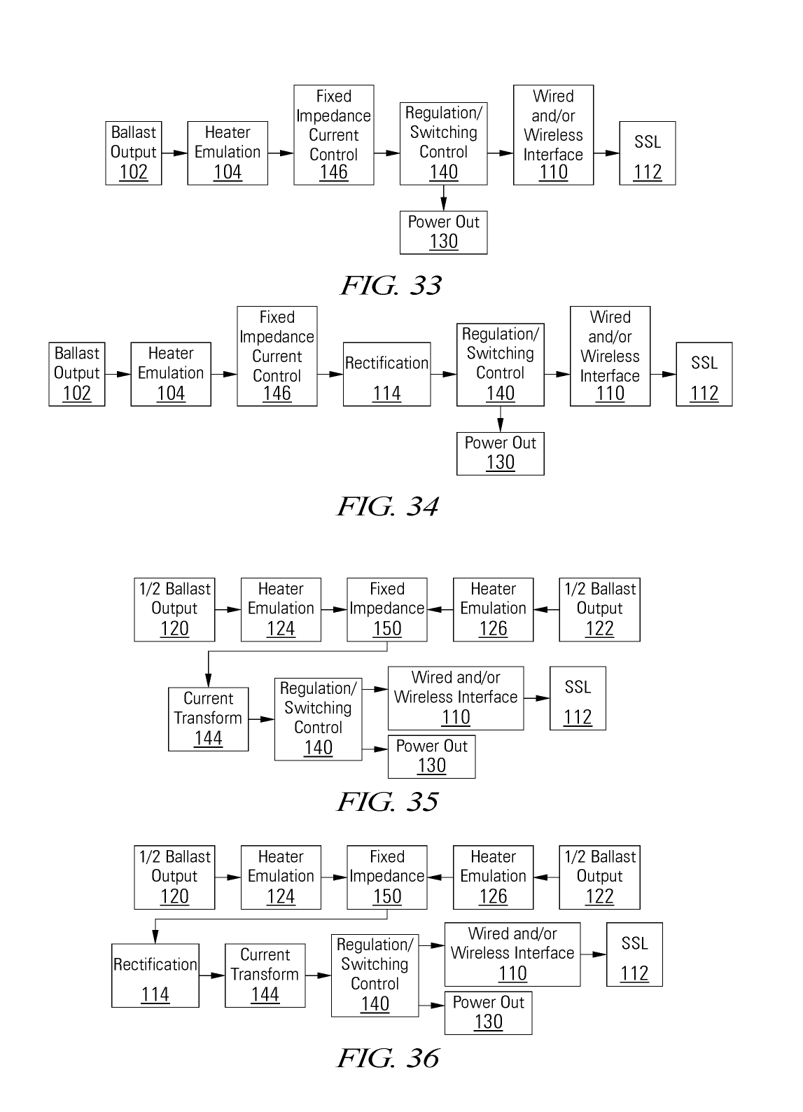

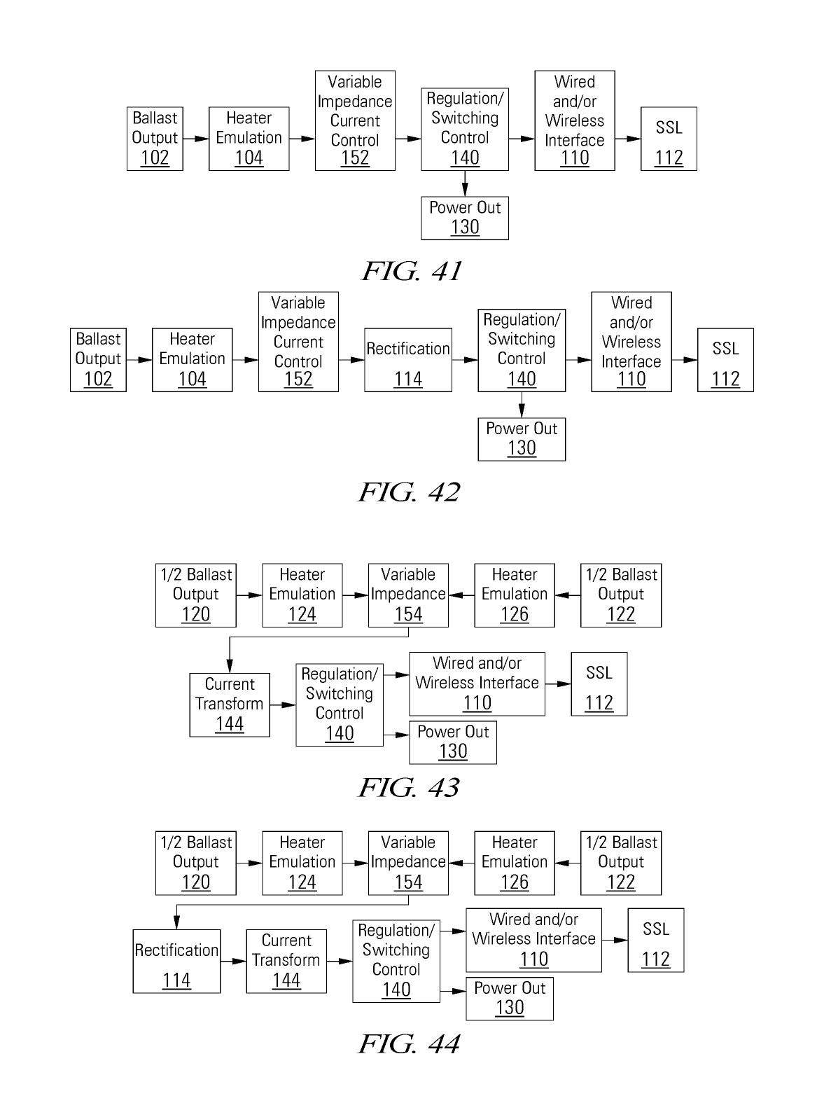

Furthermore, embodiments of the present invention including but not limited to IrDA, the FLRs can be solar/battery powered/charged in full or in part along with or in place of other power sources disclosed herein. In addition, microphones, cameras, infrared imagers, speakers, sirens, any other type of sensors, detectors, IOT, communications, monitoring, reporting including event reporting, logging, storing, power generation, energy harvesting, etc., other types of sensors, controls, devices, etc. including but not limited to those discussed herein, etc. can be incorporated/contained/etc. in embodiments and implementations of this present invention. The battery or batteries can, for example, but not limited to, be trickled charged by embodiments of the present invention that provide power, it can be solar charged including but not limited to charging via light from embodiments of the present invention including but not limited to stray light from the present invention. In some embodiments of the present invention a buck-boost, boost-buck or boost, flyback, forward converter, etc. circuit or capacitance doubler or tripler, etc. can be used to take 5 Volts of output power source provided by the lamp (e.g., Power Out in FIGS. 5 through 8 and 13 through 44 and could optionally be included in the other figures) from, for example, the ballast or the AC line or the DC source) to 10 or 15 (or 12, etc.) volts to use, for example, but not limited to, 0 to 10 V dimmers, controls, systems, sensors, legacy, current or new devices, systems, technology, circuits, detectors, sensors, etc. In other embodiments of the present invention, a buck or other circuit can be used to take the output voltage provided from the lamp as in FIGS. 5 through 8 and 13 through 44 to a lower voltage and higher current output.

In some embodiments of the present invention, the power supply/source/regulator for controlling, dimming, trimming, color temperature, color tuning, selection, etc. can be placed in series with the other elements including the lighting such that the current that flows from the AC line or ballast output either flows through the lamp or around (bypasses) the lamp to partially flow through the power supply/regulator/etc. for the smart/intelligent so as to maintain the voltage at the appropriate level for the, for example, but not limited to, wireless and/or wired controls, interfaces, etc., the microcontrollers, microprocessors, digital signal processors (DSPs), FPGAs, etc. In some embodiments, the series regulation may shunt off excess current to a lower common return or other potential in the circuit. For example, but not limited to, the one or more arrays of LEDs can be put in series with the lamp so that the current from the AC line or ballast output flows through the LEDs or other SSLs, etc. (with some current limiting or dimming by, for example, but not limited to, shunting of the current (as shown in some of the embodiments depicted in the figures), by PWM of one or more switches (also as shown in some of the embodiments depicted in the figures), by series regulation (also as shown in some of the embodiments depicted in the figures), by linear regulation (also as shown in some of the embodiments depicted in the figures), etc., combinations of these, etc. Should the current through the LEDs or SSLs, etc. be too much for the control including but not limited to the smart/intelligent control and other electronic, circuits, systems, etc. including but not limited to wireless and/or wired communications, microprocessors, microcontrollers, DSP, FPGA, etc., shunt control or other approaches can be used to regulate the voltage and current to the controls, sensors, etc. In some embodiments if the current or voltage is too low, a boost, buck-boost, boost-buck, flyback, and/or other topologies, architectures, methods, approaches, etc. can be used to raise the voltage and/or convert or transform the current, etc.

Furthermore, embodiments of the present invention including but not limited to the FLRs can be solar/battery powered/charged in full or in part along with or in place of other power sources disclosed herein. In addition, microphones, cameras, infrared imagers, thermal imagers of any type, form, resolution, optional pixel count, etc., speakers, sirens, any other type of sensors, detectors, IOT, communications, monitoring, reporting including event reporting, logging, storing, power generation, energy harvesting, etc., other types of sensors, controls, devices, etc. including but not limited to those discussed herein, etc. can be incorporated/contained/etc. in embodiments and implementations of this present invention. The sensors can be battery powered, battery back-up powered, etc. by the embodiments of the present invention including but not limited to solar, mechanical, vibrational, and energy harvesting in general of any type and form. The battery or batteries that are optionally used to power sensors, IOT, controls, other lights, accessories, charging, etc. may be trickle charged, alternative energy charged, etc. and may be of any rechargeable or, in some embodiments, non-rechargeable type. These batteries may also be electrically switched out when power from other sources including but not limited to the AC line, ballast and/or DC are available. One or more of the sensors including the optical, light, photo, spectral, etc. sensors can be powered by the lamps or by external means or by batteries, etc. One or more of the sensors can be used in, for example, but not limited to, different locations, physically close or apart, different parts of the same environment, e.g., different walls, different heights, etc. to provide additional data including on transmitted, reflected, natural and artificial light, direct light exposure, indirect light exposure, etc. Some embodiments of the invention can include motion sensors performing multiple duties—turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

The present invention also allows various types of radio frequency (RF) devices such as, but not limited to, window shades, drapes, diffusers, garage door openers, warehouse door openers and controls, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included in the present invention to track the location and, for example, to also make decisions as to where and when the present invention should do certain things including but not limited to turning on or off, dimming, turn on heat or cooling, control and monitor the lighting, etc., control, water, monitor the lawn and other plants, trees etc.

Embodiments of the present invention can use/incorporate/include/etc. thermal imagers including but not limited to IR imagers, IR imaging arrays, non-contact temperature measurements including point temperature and array temperature measurements including in lighting such as, but not limited to, T2, T3, T4, T5, T6, T8, T10, T12, Par, MR, A-lamps, R, BR, HID, PL. Biax, etc., ones discussed herein, combinations of these, etc. replacements where the imagers are powered, for example, but not limited to the ballast, the AC line, or DC power including, but not limited to solar, wind, thermal, geothermal, hydraulic, water, etc., other types of alternative and conventional energy sources, combinations of these, etc. In addition, microphones, cameras, infrared imagers, speakers, sirens, any other type of sensors, detectors, IOT, communications, monitoring, reporting including event reporting, logging, storing, power generation, energy harvesting, etc., other types of sensors, controls, devices, etc. including but not limited to those discussed herein, etc. can be incorporated/contained/etc. in embodiments and implementations of this present invention.

The present invention, may include internal or external or both integrated sensors and controls including but not limited to motion including for example but not limited to occupancy and vacancy sensors and light/photodetection control photometric, IES files, photo-distribution, other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

Embodiments of the present invention support connected lighting, networked lighting, lighting commissioning, self-commissioning, lighting integration as well as sensor and control including but not limited to IOT including but not limited to connected, networked, resetting, calibrating, connecting, programming, grouping, commissioning (commissioned), self-commissioning (self-commissioned), grouping, pairing, integrating (integrated), reconfigurable, scene and sequence, embedded, IOT, etc. of the present invention.

Embodiments of the present invention can perform lumen maintenance, lumen adjustment(s) including adjusting for lumen depreciation, color temperature tuning, color tuning, intensity/level tuning.

Embodiments of the present invention can change color or have additional connected lights that can change color based on stimuli including motion, noise level in dB or other, sound levels, certain frequencies of sound level, patterns, the presence or absence of something such as a car, truck, auto, vehicle or other object or person, pressure, weather, temperature, carbon monoxide levels, carbon dioxide levels, fire, smoke, dangerous situation, break-in, glass breaking, gunshot(s), certain frequencies of noise, etc., in, as examples, but not limited to, libraries, hallways, corridors, stairways, hospitals, nursing stations, work stations, nurse stations, cubical farms, public places, schools, offices, classrooms, etc.

Embodiments and implementations of the present invention can also respond, take action, etc. to Demand Response (DR) including but not limited to automatic demand response (ADR) signals and events for load shedding/load reduction, etc. including but not limited to sending wireless signals of any EM and or sound frequency/wavelength including but not limited to including infrared (IR), IrAD, visible (VIS), ultraviolet (UV), RF, millimeter, sub-millimeter, sub-GHz, sub-MHz, sub-kHz, sub-Hz, sub-THz, far IR, near IR, sound, sound waves, ultra-sound waves, sound waves of any frequency/wavelength, combinations of these etc. including for example, but not limited to those discussed herein. Note that one or more of the embodiments depicted in FIGS. 26-29 can be combined in a single embodiment.

Demand Response circuits and functionality can be included in any of the embodiments disclosed herein or in variations thereof. The present invention can be used in conjunction with automated demand response systems, protocols, interfaces, etc. including, for example, but not limited to Open Automated Demand Response (OpenADR) for energy management and events. For example, embodiments of the present invention can be used to receive and send information and signals to cause electrical power-using devices to be dimmed, curtailed, reduced, turned off, reduce load, shed load, etc. during periods of high demand including the lights, HVAC, power outlets, other electrical, electrical to mechanical equipment, etc. Embodiments of the present can include, but are not limited to, implementations that include Demand Response (DR) which is a set of actions taken to reduce]shed load when electric grid requirements threaten, compromise, will trigger, etc. supply-demand balance that could lead to imbalances, brown-outs, black-out, etc. or market conditions occur that raise electricity costs. Embodiments of the present invention can use such a foundation for interoperable information exchange to facilitate automated demand response using, for example, DR and DER signals. The present invention using or incorporating ADR including, but not limited to OpenADR can be used to implement, as stated by OpenADR: a communications data model designed to facilitate sending and receiving DR signals from a utility or independent system operator to electric customers. The intention of the data model is to interact with building and industrial control systems that are pre-programmed to take action based on a DR signal, enabling a demand response event to be fully automated, with no manual intervention.

Embodiments of the present invention can incorporate and use the Open Automated Demand Response Communications Specification. This specification defines the interface to the functions and features of a Demand Response Automation Server (DRAS) that is used to facilitate the automation of customer response to various DR programs and dynamic pricing through a communicating client.

Embodiments of the present invention can be part of an energy management system (EMS) or work with or be an EMS to, for example, dim and/or turn off lighting, change the HVAC routing or level including reducing or modifying the HVAC temporary capacity, flow, paths, etc. and perform load shedding automatically, manually, scheduled, sequenced, arranged, negotiated, etc. including power and price based, etc. or based on the information transmitted and analyzed associated with the DR and DER events, including event name and identification, event status, operating mode, if it is an emergency, etc. In addition to ADR, the present invention can also work with other energy management systems. Embodiments of the present invention can also use other information such as pricing information to analyze, determine and recognize energy demand optimization, timing, scheduling, etc. for, for example, but not limited to optimum or emergency energy load shedding and curtailment.

Embodiments of the present invention can also interact with, for example, the Facility Smart Grid Information Model and other he energy usage information model to support load shedding and curtailment, load shaping and energy market operations including ones that involve or are centered around demand response. Embodiments of the present invention can use such systems protocols, etc. to control and manage electrical loads and generation sources in response to communications from utilities, and other electrical service providers or market operators. Embodiments of the present invention can be and energy management system and interface to other protocols and systems including BACnet, LonNET, LonMark, other building automation system (BAS) and the Smart Energy Profile including DR, dynamic pricing, and electricity grid reliability.

Blue OLED(s) and/or LEDs can be used in light therapy or circadian rhythm treatments to be controlled (i.e., turned on, dimmed) based on weather and/or ambient light conditions, for example based on weather reports in overcast, stormy, gloomy, rainy, winter or otherwise dismal weather. The weather or other conditions can also be determined by sensors such as, but not limited to, light, solar, humidity, temperatures, moisture, spectral and/or precipitation sensors, in some cases in combination with weather reports from one or more sources.

Embodiments of the present invention can be used, for example, to assist, treat, provide light therapy, etc. seasonal affective disorder (SAD), other illnesses, diseases, injuries, health disorders, cancer, etc.

The present invention can use edge emitting LED light sources and displays, edge lit LED light sources and displays, waveguide LED sources and displays, etc. The present invention can consist of or include quantum dot light sources including blended light QD light sources that can produce individual or blended light sources to create full spectrum or single wavelength/color light including wavelengths in the ultraviolet and/or infrared or both. The present invention can use computer monitors/displays and TVs, smart phones, Arduino systems, Raspberry Pi systems, tablets, iPads, iPhones, iPods, Android devices including, but not limited to, smart cellular phones and tablets, and other color displays, monitors, personal digital assistants, etc. It can use photosensors, motion sensors, audio sensors, acoustic sensors, ultrasonic, sonar, radio frequency (RF), radar, vibration sensors, mechanical sensors, vocal sensors, voice sensors, motion sensors, other types of audible sensors including other types of audio sensors, and microphones, including standalone microphones or microphones in other devices such as television remotes, cellular telephones, cameras, etc., proximity sensors, radio frequency identification (RFID), cell phone signals, Bluetooth, WiFi, WiMax, 6LoWPAN. THREAD, LoRa, Zigbee, Zwave, IrAD, other infrared, optical, light, electromagnetic, electromagnetic waves, radio frequency (RF) including, but not limited to the frequency spectrum from less than 1 MHz or KHz to greater than 1 THz or 10s or 100s of THz, etc., to smart phones, tablets, global positioning systems (GPS), voice activated, voice recognition, sound activation, selective sound activation, temperature activation, humidity action, motion activation, infrared activation, sonar, radar, time-of-flight, ultrasonics, etc. combinations of these, etc.

For example, the present invention can be implemented so that the user can configure and set the hardware and software interface of the circadian rhythm cycle lighting system and/or, for example, the color-changing including white color changing lighting system so as to, for example, but not limited to, individually input, control, program, interact with, monitor, log, etc. the circadian rhythm lighting system. Embodiments of the present invention can include motion detection/proximity detection/RF detection and decide/determine which color(s) of light to produce, in conjunction and coupled with other sensors, detectors, counters, timers, clocks, etc., including for example but not limited to, sound, photo, light, spectrum, voice, detectors and sensors to turn on to maintain the appropriate circadian rhythm cycle regulation, etc. For example, implementations can turn on and set the hall and other lights to blue enhanced light in, for example, the morning, day or afternoon phases of the circadian rhythm cycle and turn on and set the hall or other lights to blue depressed or blue eliminated light in, for example, the evening, night or night time/sleep time phases of the circadian rhythm cycle. In addition the lights/lighting can be dimmed at any point in the cycle that is appropriate or needed especially at nighttime including both automatically and manually. For example, implementations of the present invention can turn on and set the kitchen lights to blue enhanced light at, for example, breakfast or lunch and possibly dinner and turn on and set the hall or other lights to blue depressed or blue eliminated light (i.e., red, amber, orange, yellow, etc.) in, for example, possibly at dinner or for after dinner snacking, etc. Other situations can include, for example, turning on and setting the bedroom lights to blue enhanced light in, for example, the morning, day or afternoon phases of the circadian rhythm cycle and turn on and set the area, room, hall etc. or other lights to blue depressed or blue eliminated light in, for example, the evening, night or night time/sleep time phases of the circadian rhythm cycle. For example, embodiments of the present invention can turn on and set the bathroom lights to blue enhanced light in, for example, the morning, day or afternoon phases of the circadian rhythm cycle and turn on and set the hall lights to blue depressed or blue eliminated light in, for example, the evening, night or night time/sleep time phases of the circadian rhythm cycle. Embodiments of the present invention can use red, green, blue, amber, white LEDs, OLEDs, QDs, other colors of LEDs, OLEDs, QDs and white LEDs, OLEDs, QDs, etc., subsets and combinations of these, etc. Embodiments of the present invention can use RGB OLEDs and LEDs and/or QDs and combinations of RGB OLEDs, LEDs, QDs and white LEDs, OLEDs, QDs, etc. for the lighting.

The present invention can be used to provide one or more wavelengths of light that can be set to turn on or off or dim at various times of the day, night, week, month, etc. to aid in growth and to provide a grow light source, for example for indoor residential plants or gardens, greenhouses, indoor horticulture, vertical farming, urban farming in warehouses, rooms, office areas, greenhouses, subway stations, other buildings, to make indoor farm space, etc. Such embodiments can implement wavelength tuning using any suitable light source, such as, but not limited to, light emitting tubes and/or panels, arrays of LED's in single or multiple colors, other solid state lights either directly or in combination with filters, phosphors, diffusers, etc.

Aspects of the present invention can be powered by any source or combination of sources, such as, but not limited to, AC power, a ballast output of a fluorescent lighting fixture, battery power that can be charged by any method including AC battery chargers, AC/DC battery chargers, inverters, converters, solar energy, mechanical energy, energy harvesting or one or more types, combinations of these, car/automobile chargers, etc. For example but not limited to, one or more batteries can be used to provide standby or low power operation when the electricity is turned off or there is/are no other sources of power. The batteries can be taken out of the circuit by a higher voltage, by a switch, by a relay of any type or form, etc. when AC powered or switched out on AC power or one or more DC sources.

Some embodiments of the present invention can, for example, but not limited to, use a buck-boost or boost circuit or capacitance doubler or tripler to take 5V of a battery or isolated aux power source to 10 or 15 (or 12, etc.) volts to use, for example, but not limited to, 0 to 10 V dimmers, controls, systems, etc.

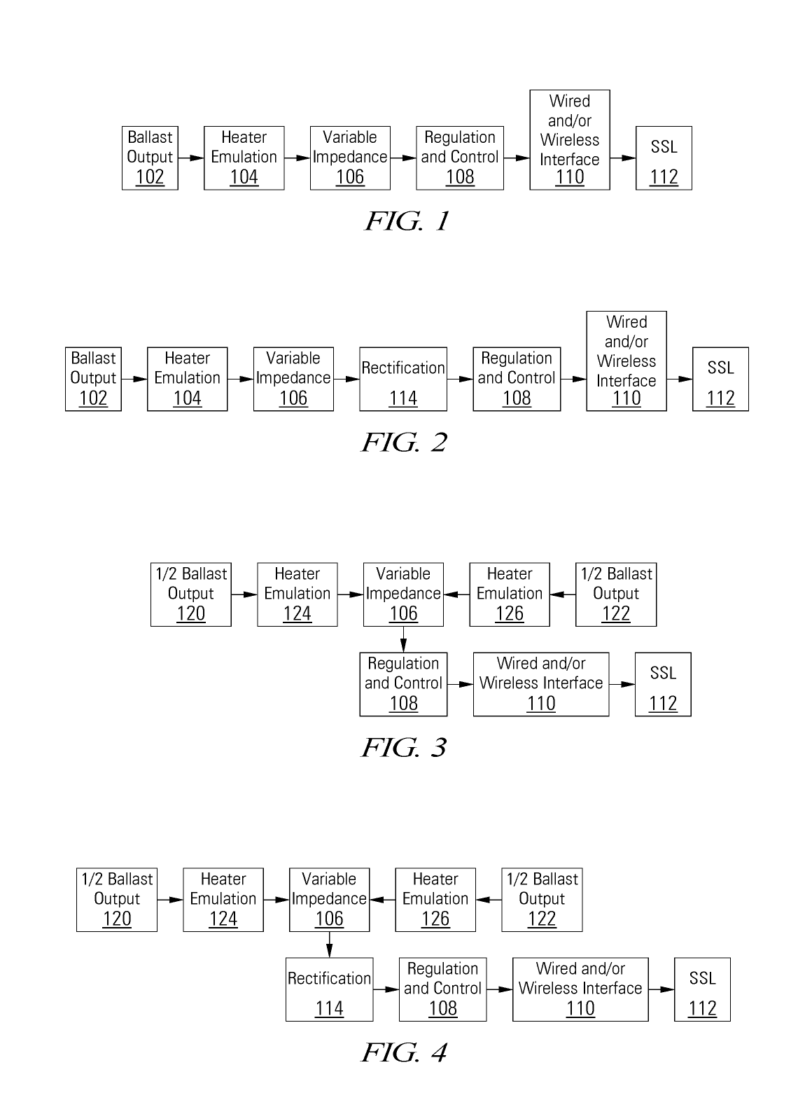

Various embodiments of a solid state fluorescent replacement lighting system are depicted in FIGS. 1-44, illustrating a number of non-limiting combinations and variations of elements. Power can be drawn from a ballast output 102 or from two half ballast outputs 120, 122 to power one or more solid state lights 112. Heater emulation circuits 104, 124, 126 can be included to enable a fluorescent ballast to operate properly, for example by presenting an expected impedance to the ballast. In some embodiments the heater emulation circuit can be simply one or more resistors.

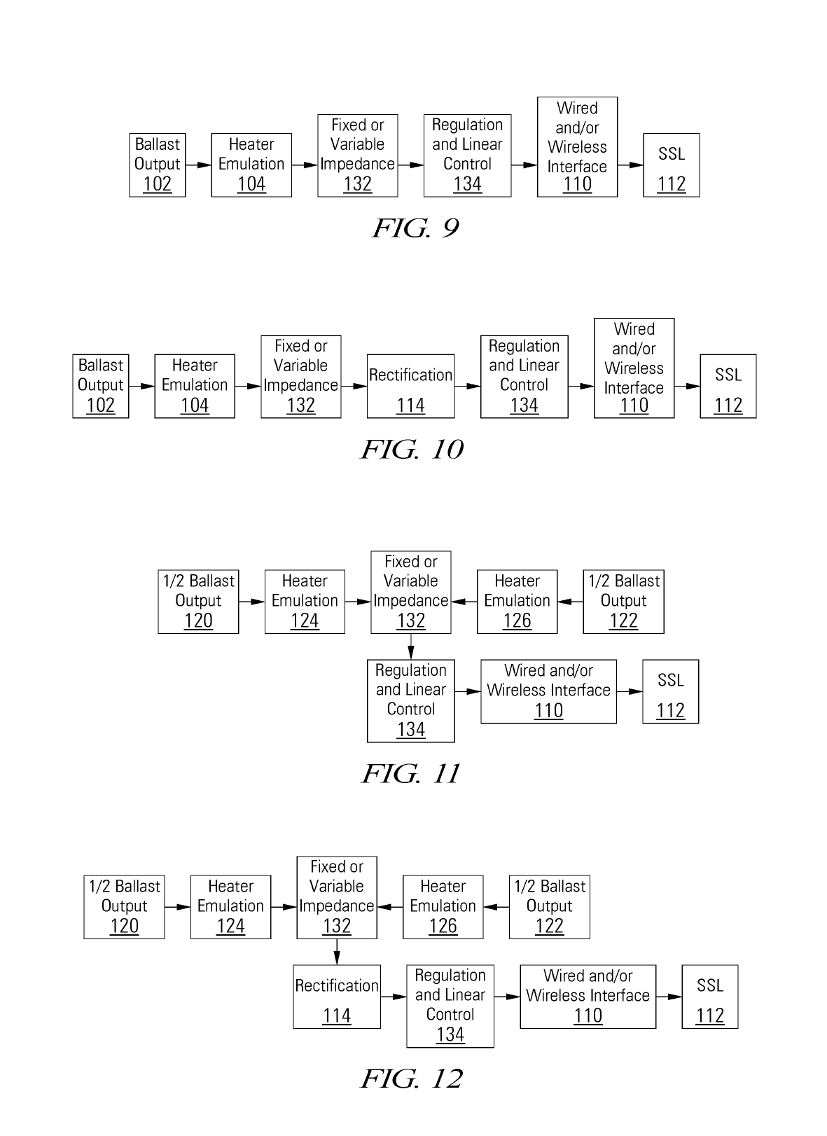

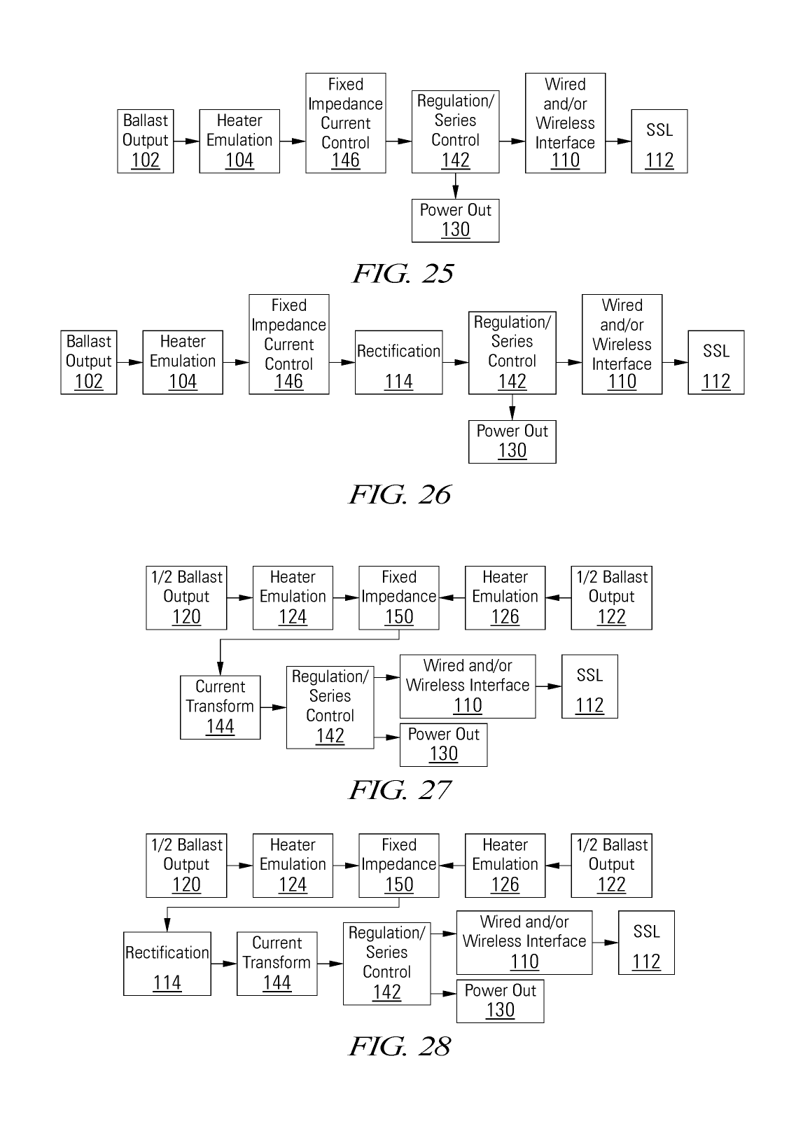

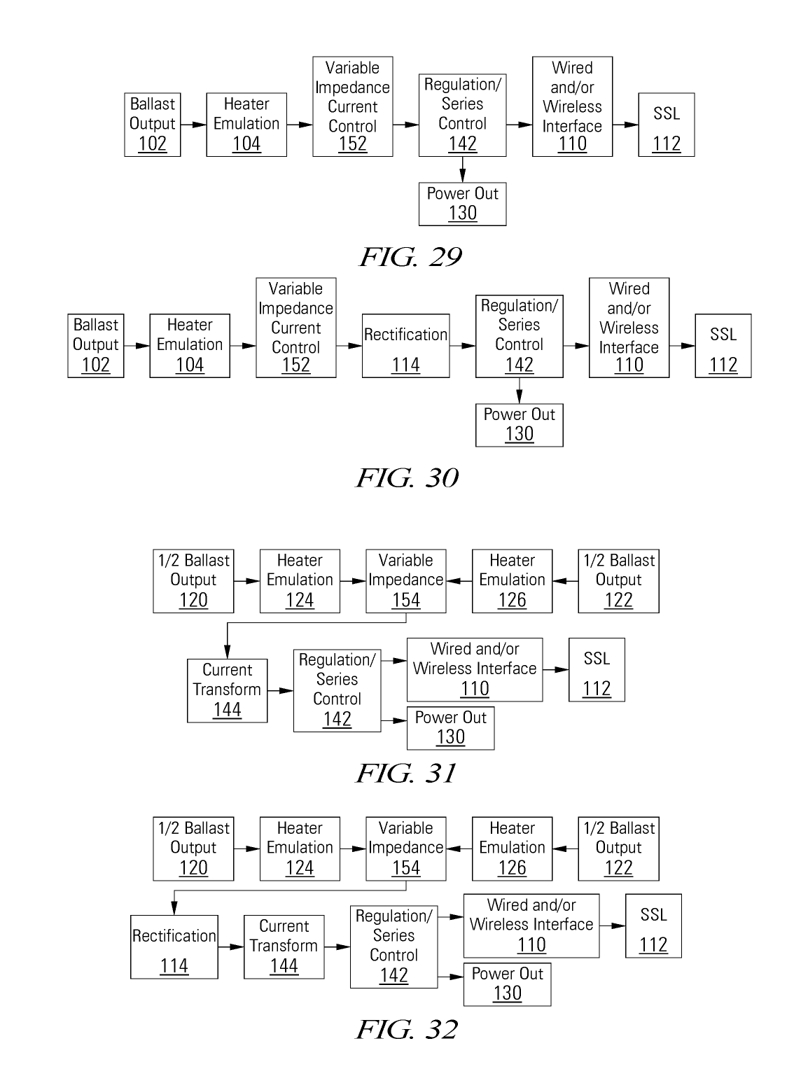

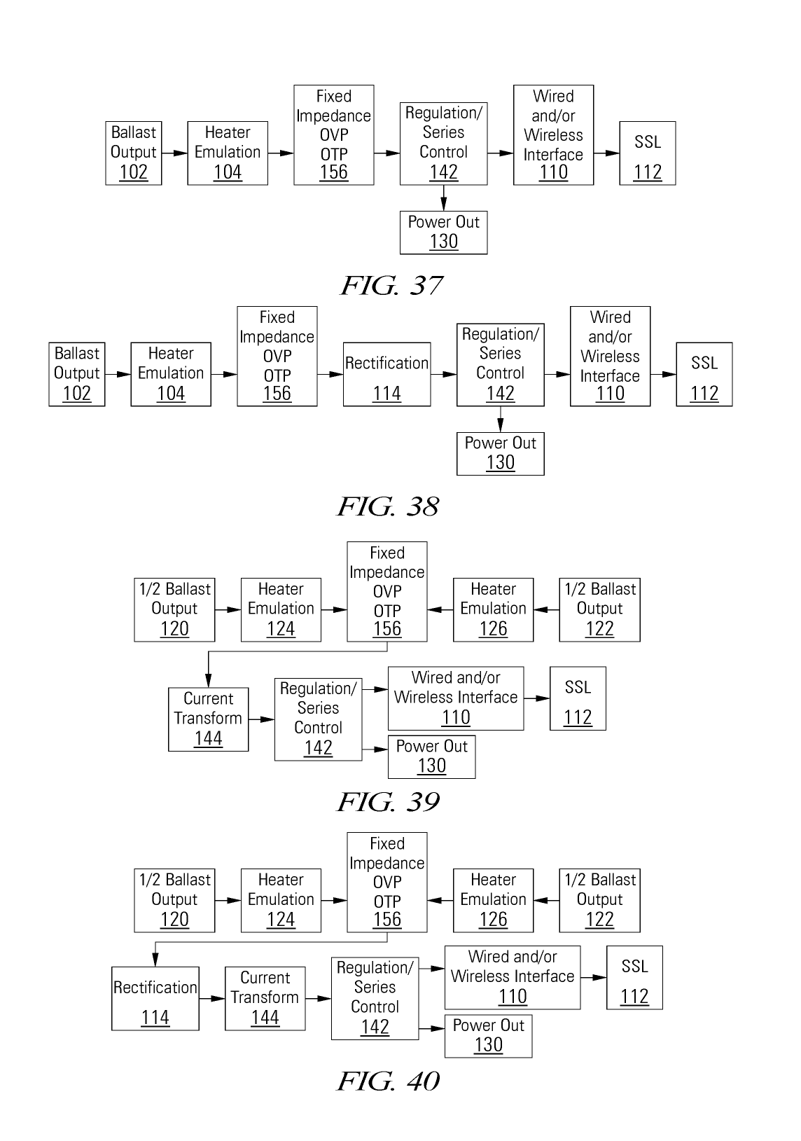

In some embodiments, a variable impedance 106 is connected across the ballast outputs to control load current by at least partially shorting the ballast outputs, thereby shunting ballast current away from the load. Notably, in this and/or other embodiments disclosed herein, the variable impedance can also be used to provide overvoltage protection (OVP), over-temperature protection (OTP), short circuit protection (SCP), open circuit protection (OCP), etc. As depicted in FIGS. 9-24, such an impedance 132 can be fixed or variable. As depicted in FIGS. 25-26 and 33-34, some embodiments include a fixed impedance current control 146. As depicted in FIGS. 27-28 and 35-36, some embodiments include a fixed impedance 150. As depicted in FIGS. 29-30 and 41-42, some embodiments include a variable impedance current control 152. As depicted in FIGS. 31-32 and 43-44, some embodiments include a variable impedance 154. As depicted in FIGS. 37-40, some embodiments include a fixed impedance circuit with overvoltage and/or over-temperature protection 156.

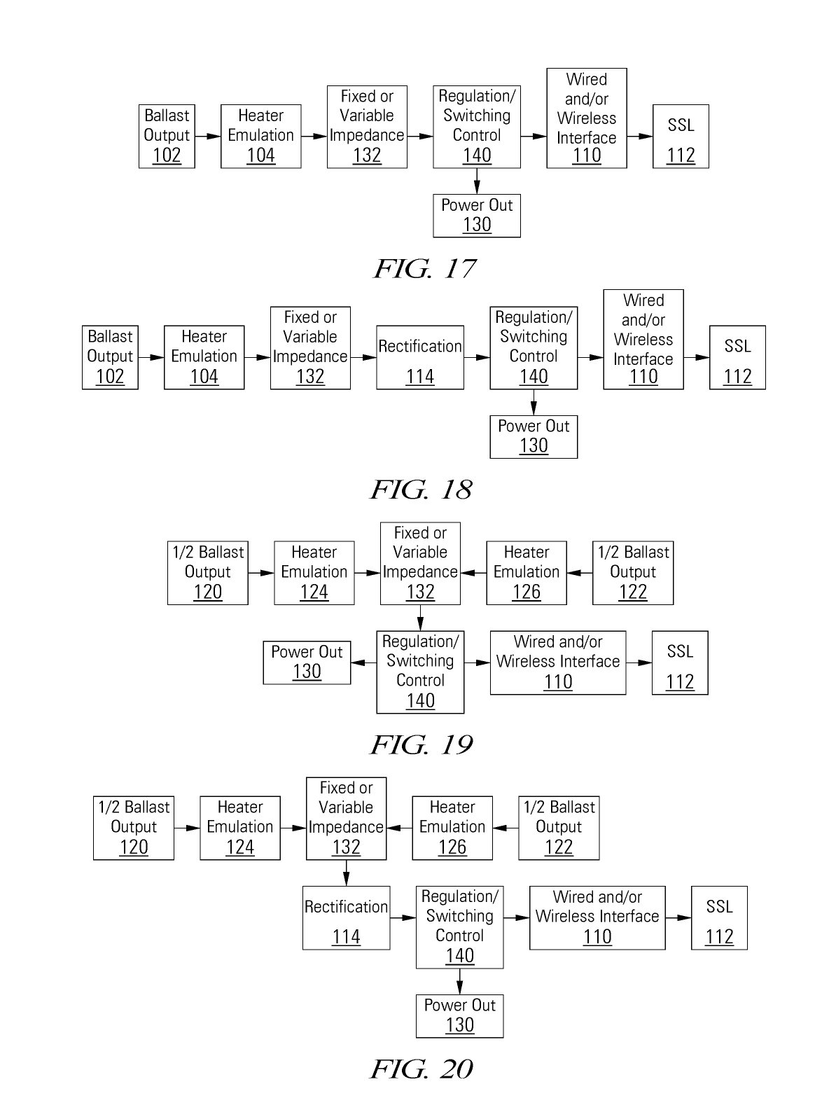

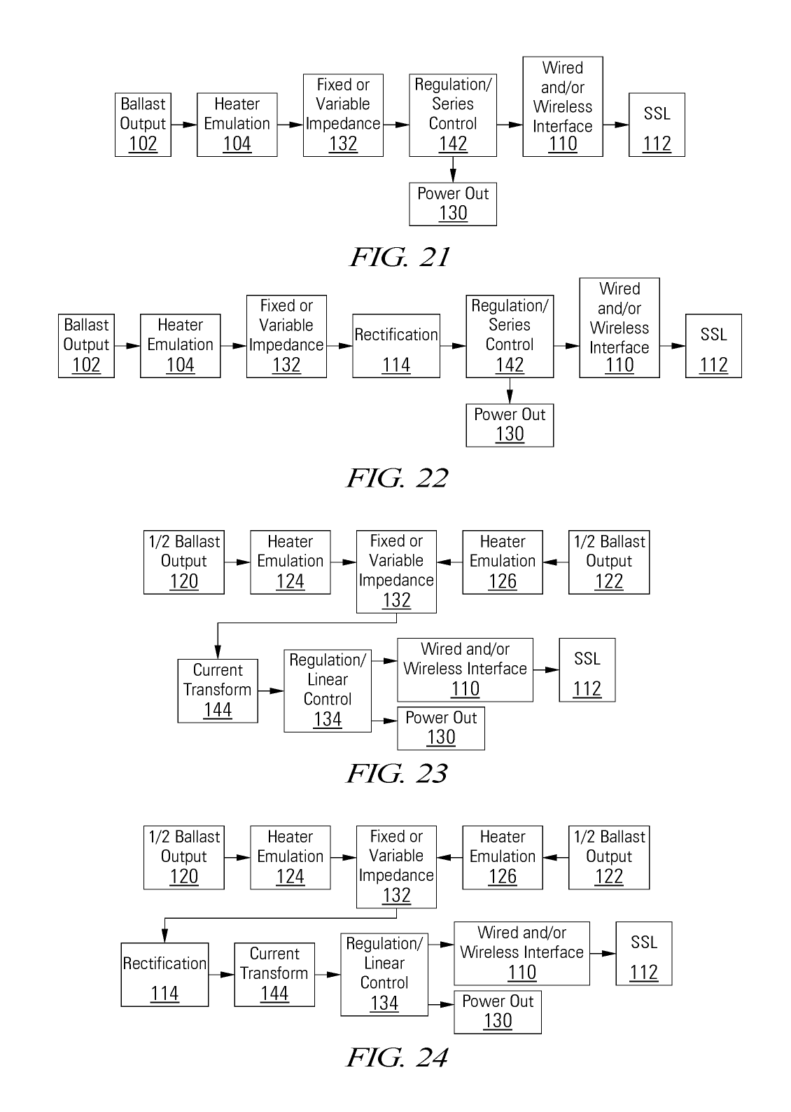

A regulation and control circuit 108 can be included to control load current and provide other functions such as, but not limited to, sensor integration, communications, remote control signal processing, etc. One or more wired and/or wireless interfaces 110 can be included, enabling the regulation and control circuit 108 to communicate with other devices. In some embodiments, regulation and control is provided by a regulation and switching control circuit 140 as depicted in FIGS. 17-20 and 33-36 and 41-44. In some embodiments, regulation and control is provided by a regulation and series control circuit 142 as depicted in FIGS. 21-22 and 25-32 and 37-40. In some embodiments, regulation and control is provided by a regulation and linear control circuit 134 as depicted in FIGS. 9-16 and 23-24. In some embodiments, a current transform circuit 144 is included as in FIGS. 23-24, 27-28, 31-32, 35-36, 39-40 and 43-44.

As depicted in FIGS. 2, 4, 6, 8, 10, 12, 14, 16, 18, 20, 22, 24, 26, 28, 30, 32, 34, 36, 38, 40, 42 and 44, a rectification circuit 114 can be included to provide either full or partial rectification of an AC input. In some embodiments, rectification can be performed by load LEDs. As a non-limiting example, two or more LEDs or arrays of LEDs can be configured in parallel in, for example but not limited to, a back to back configuration with the anode of the first LED or array(s) of LEDs connected to the cathode of the second LED or array(s) of LEDs and the cathode of the first LED or array(s) of LEDs connected to the anode of the second LED or array(s) of LEDs to perform a simple rectification function. Additional LEDs including arrays of LEDs can be connected, for example, but not limited to, to create a full wave rectifier or full wave rectification, etc.

As depicted in FIGS. 5-8 and 13-44, some embodiments provide an auxiliary power output 130 that provides power drawn from the AC input or ballast output to power internal circuits and/or external devices such as, but not limited to, sensors, speakers, signaling devices, fans, etc.

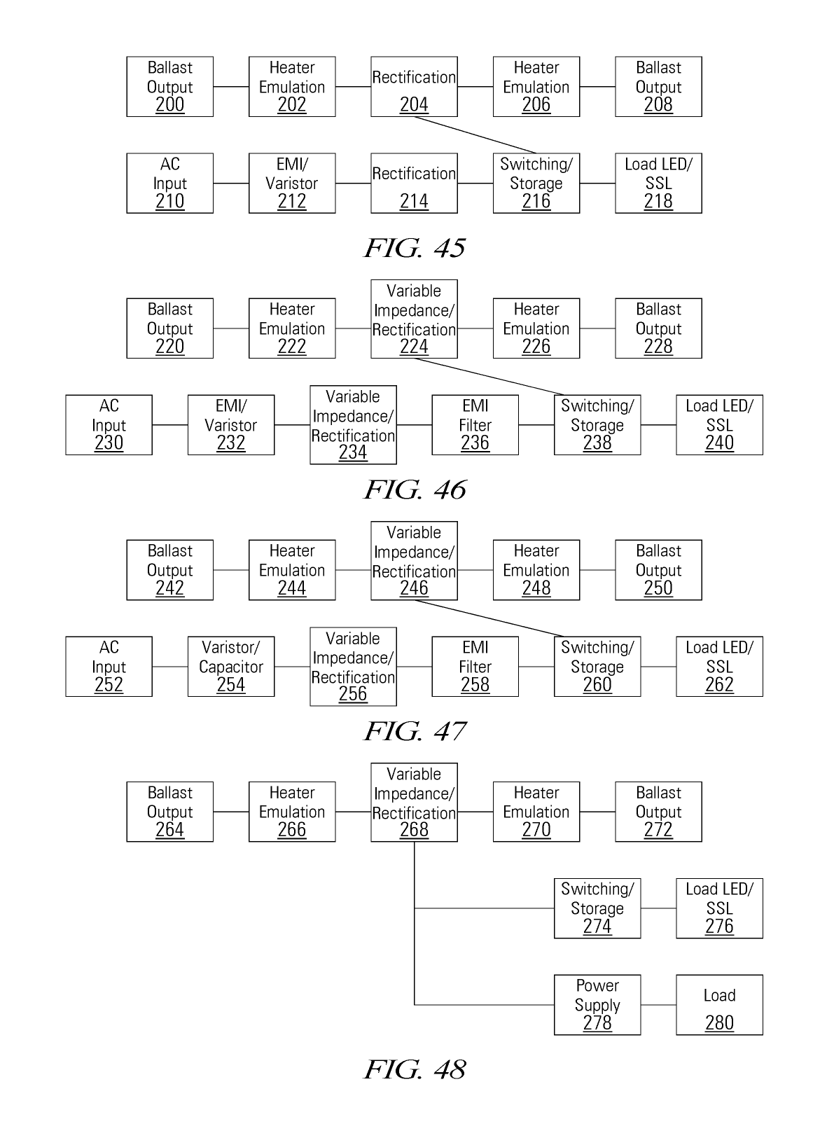

Turning to FIG. 45, an example embodiment of a solid state fluorescent replacement lighting system receiving power from both AC input and ballast output is depicted in accordance with some embodiments of the invention. The block diagrams do not show optional elements such as a snubber, the feedback, set point, control, sense, other components, UVP, OVP, OTP, OCP, SCP, remote interfaces including but not limited to 0 to 10 V, 0 to 3V, microcontrollers, digital signal processors, Bluetooth controllers, radio chips, other digital and analog systems and accessories, etc., other wired, wireless and/or powerline communications, other control, monitoring, measuring, storage, memory, FLASH, EEPROM, etc., combinations of these, etc. In the embodiment of FIG. 45, a solid state fluorescent replacement lighting system derives power from ballast outputs 200, 208 through optional heater emulation circuits 202, 206 and rectifier 204. Power can also or alternatively be derived from an AC input 210 through rectifier 214, with one or more optional EMI filters and varistor(s) 212. Power is converted in switch/storage circuit 216 to drive the solid state light(s) 218.

The EMI components are for illustrative purposes only and are not limited in any way or form to what is shown and depicted herein and may contain, but are not limited to, inductors, chokes, beads, capacitors, resistors, other types of passive and active components, etc., combinations of these, etc. In some embodiments, the EMI filter may be optional.

In some embodiments of the present invention, the rectification can be shared and common to both the ballast and AC line powered modes of operation, etc. In some embodiments of the present invention, power can also be by DC voltage including lower voltage DC such as 12 volts DC or even ˜3 volts DC.

Turning to FIG. 46, an embodiment of a solid state fluorescent replacement lighting system receiving power from both AC input and ballast output and with rectified EMI filtering is depicted in accordance with some embodiments of the invention. In this embodiment, a solid state fluorescent replacement lighting system derives power from ballast outputs 220, 228 through optional heater emulation circuits 222, 226 and variable impedance/rectifier 224. Power can also or alternatively be derived from an AC input 230 through rectifier/variable impedance 234, with one or more optional EMI filters and varistor(s) 232, 236. Power is converted in switch/storage circuit 238 to drive the solid state light(s) 240.

Turning to FIG. 47, an embodiment of a solid state fluorescent replacement lighting system receiving power from both AC input and ballast output and with rectified EMI filtering is depicted in accordance with some embodiments of the invention. In this embodiment, a solid state fluorescent replacement lighting system derives power from ballast outputs 242, 250 through optional heater emulation circuits 244, 248 and variable impedance/rectifier 246. Power can also or alternatively be derived from an AC input 252 through rectifier/variable impedance 256, with one or more optional EMI filters and varistor(s)/capacitors 254, 258. Power is converted in switch/storage circuit 260 to drive the solid state light(s) 262.

Turning to FIG. 48, an embodiment of a solid state fluorescent replacement lighting system receiving power from ballast outputs is depicted in accordance with some embodiments of the invention. In this embodiment, a solid state fluorescent replacement lighting system derives power from ballast outputs 264, 272 through optional heater emulation circuits 266, 270 and variable impedance/rectifier 268. Power is converted in switch/storage circuit 274 to drive the solid state light(s) 276. Power is also derived from the ballast outputs 264, 272 using power supply 278 to power loads 280 which can be, but which are not limited to, internal circuits in the solid state lighting system, sensors, etc.

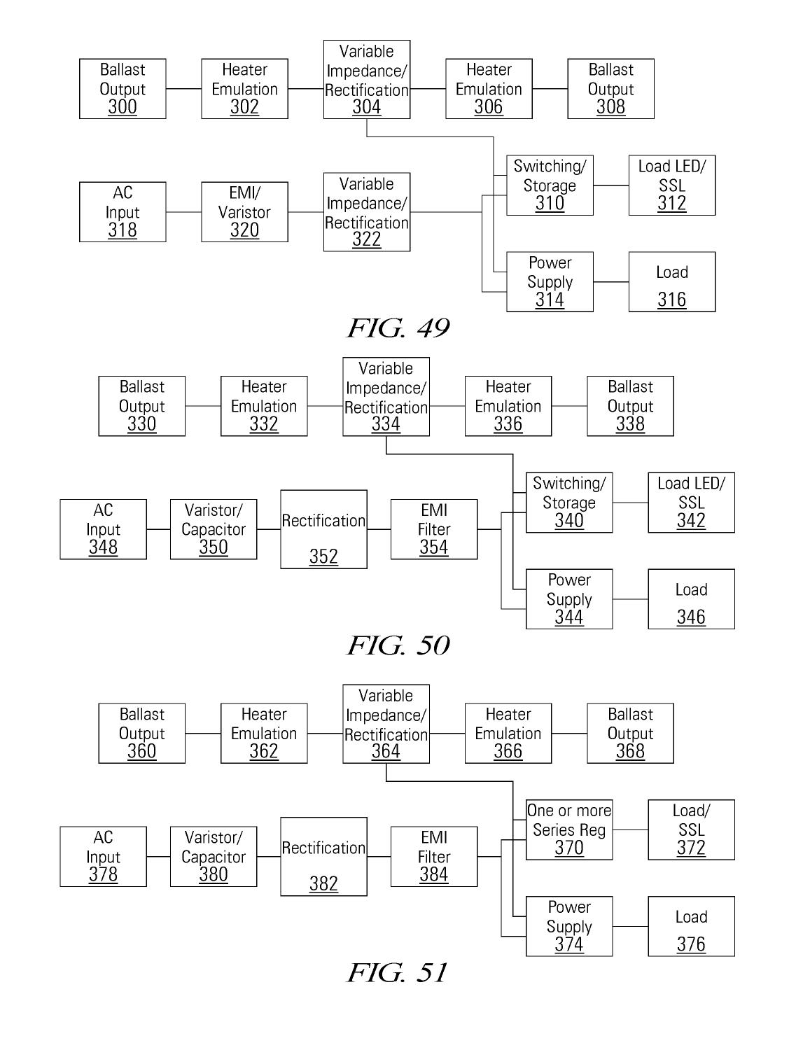

Turning to FIG. 49, an embodiment of a solid state fluorescent replacement lighting system receiving power from ballast outputs is depicted in accordance with some embodiments of the invention. In this embodiment, a solid state fluorescent replacement lighting system derives power from ballast outputs 300, 308 through optional heater emulation circuits 302, 306 and rectifier/variable impedance 304. Power can also or alternatively be derived from an AC input 318 through rectifier 322, with one or more optional EMI filters and varistor(s) 320. Power is converted in switch/storage circuit 310 to drive the solid state light(s) 312. Power is also generated in power supply 314 to power loads 316 which can be, but which are not limited to, internal circuits in the solid state lighting system, sensors, etc.

Turning to FIG. 50, an embodiment of a solid state fluorescent replacement lighting system receiving power from ballast outputs is depicted in accordance with some embodiments of the invention. In this embodiment, a solid state fluorescent replacement lighting system derives power from ballast outputs 330, 338 through optional heater emulation circuits 332, 336 and rectifier/variable impedance 334. Power can also or alternatively be derived from an AC input 348 through rectifier 352, with one or more optional EMI filters and varistor(s)/capacitors 350, 354. Power is converted in switch/storage circuit 340 to drive the solid state light(s) 342. Power is also generated by power supply 344 to power loads 346 which can be, but which are not limited to, internal circuits in the solid state lighting system, sensors, internet of things sensors, detectors, devices, etc. including but not limited to those discussed herein such as motion, sound, light, temperature, etc., sensors, detectors, controllers, as well as communications devices including but not limited to wireless, wired, powerline, combinations of these, etc.

Turning to FIG. 51, an embodiment of a solid state fluorescent replacement lighting system receiving power from ballast outputs is depicted in accordance with some embodiments of the invention. In this embodiment, a solid state fluorescent replacement lighting system derives power from ballast outputs 360, 368 through optional heater emulation circuits 362, 366 and rectifier/variable impedance 364. Power can also or alternatively be derived from an AC input 378 through rectifier/variable impedance 382, with one or more optional EMI filters and varistor(s)/capacitors 380, 384. Power is converted in one or more series regulators 370 to drive the solid state light(s) 372, or in other types or topologies of regulators or power converters. Power is also generated by power supply 374 to power loads 376 which can be, but which are not limited to, internal circuits in the solid state lighting system, sensors, internet of things sensors, detectors, devices, etc. including but not limited to those discussed herein such as motion, sound, light, temperature, etc., sensors, detectors, controllers, as well as communications devices including but not limited to wireless, wired, powerline, combinations of these, etc.

Turning to FIG. 52, a block diagram of a solid state lighting system is depicted that can be powered by both AC lines and ballast outputs, and that can be remotely controlled and dimmed in both modes. An emulation circuit 400 can be included to emulate a fluorescent or HID tube for instant/rapid/prestart ballasts to enable or assist the ballast to operate normally when the fluorescent or HID tube has been replaced, as well as to provide AC to DC rectification. A variable impedance 402 can be included, for example but not limited to, to provide current control, in some cases shunting input current to control the current level reaching the load. An EMI filter 404 can be included to reduce EMI. A buck or other type of converter 406 converts the input power to the power signal required for the LED, OLED, QD and/or combinations of these and/or other loads 408. Although a buck circuit can be used for power conversion, as an example, most any other type of switching circuit such as, but not limited to, a buck-boost, boost, boost-buck, Cuk, SEPIC, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit.

The buck converter can have OVP, OTP, OCP, shock hazard/pin safety protection, constant current, etc. Normally on (NO) and normally closed (NC) switches that are, for example single or double (or higher) and single (or higher) pole can be used.

The present invention can be used with AC line voltage including but not limited to 80 to 305 VAC 50/60 Hz, 347 VAC 50/60 Hz, 480 VAC 50/60 Hz other 50/60 Hz voltages, magnetic and electronic ballasts, low frequency and high frequency ballasts, instant start, rapid start, programmed start, program start, pre-start, warm, cold, hot types of ballasts, etc. In some embodiments a switch, including a mechanical, electromechanical, semiconductor, solid state, relay, etc., of any types and forms, etc., combinations, etc. can be used to connect and control power to the present invention.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc.

The power supplies/drivers for the present invention can include compatibility with essentially all or specific dimming protocols such as but not limited to triac/forward/reverse dimmers and all digital dimming protocols; and is compatible with ambient light sensors. The power supplies and drivers for SSL FLRs can convert relatively high frequency (typically 40 to 100 kHz) AC input to DC output power, and are able to support various types of remote control/dimming, provide over-current (OCP), over-voltage (OVP), over-temperature (OTP) and short circuit protection (SCP). Embodiments of the present invention can be ultra-efficient, highly flexible and allow SSL FLRs to support white light, white color tuning and, for example, optional features including color tunable red/green/blue (RGB), RGB and amber (RGBA), etc. modes of SSL operation.

Embodiments of the present invention, in addition to being ballast-compatible SSL direct replacement FLRs that work with electronic ballasts including but not limited to, instant-start, rapid-start, etc. ballasts, are also able to bypass the ballast and be plugged directly into the AC 50/60 Hz line voltage should, for example, the ballast fail. Therefore, in addition, to ballast AC input to DC output power, these embodiments also are able to directly work with 50/60 Hz and have a high power factor (PF) and low total harmonic distortion (THD), are also able to support various types of remote control/dimming, provide over-current (OCP), over-voltage (OVP), over-temperature (OTP) and short circuit protection (SCP).

Implementations of the present invention can be wirelessly dimmed and can support both manual and daylight harvesting controls, including optional standard 0 to 10 V, DALI, DMX, and other interoperable protocols and interfaces including, but not limited to, interfaces that support standards including Building Automation Control Network (BACnet) and can be designed to be interoperable with other building automation system (BAS) vendors, manufacturers, suppliers, etc. to enhance and further enable the adoption of LED luminaires and FLRs in building automation.

The controls allow multiple control systems manufactured by different vendors to work together, sharing information via a common Web, cloud, internet, local area network, or other-based interface, etc. combinations of these, etc.

Turning to FIG. 53, a block diagram of a solid state lighting system is depicted that can be powered by both AC lines and ballast outputs, and that can be remotely controlled and dimmed in both modes. An emulation circuit 408 can be included to emulate a fluorescent or HID tube for instant/rapid/prestart ballasts to enable or assist the ballast to operate normally when the fluorescent or HID tube has been replaced, as well as to provide AC to DC rectification. A variable impedance 410 can be included for current control. An EMI filter 412 can be included to reduce EMI. A buck or other type of converter 152 converts the input power to the power signal required for the LED, OLED, QD and/or combinations of these and/or other loads 416. Although a buck circuit can be used for power conversion, as an example, most any other type of switching circuit such as, but not limited to, a buck-boost, boost, boost-buck, Cuk, SEPIC, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 418 can be received and processed to control the current and/or voltage to the load 416, such as, but not limited to, optional wall (Triac), 0 to 3 VDC, 0 to 10 VDC, powerline (PLC), wireless, DMX, RS485, RS232, SPI, I2C, RS 422, UART, CAN bus, Ethernet, Profibus, Modbus, etc., other serial and parallel standards and interfaces and/or DALI dimming as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc., others discussed herein, combinations of these, etc.

Turning to FIG. 54, a block diagram of a solid state lighting system is depicted that can be powered by both AC lines and ballast outputs, and that can be remotely controlled and dimmed in both modes. In some embodiments of the present invention, the power input can automatically switch to AC line when the ballast is deactivated, turned off, removed, not functioning, not operating, fails, etc. An emulation circuit 420 can be included to emulate a fluorescent or HID tube for instant/rapid/prestart ballasts to enable or assist the ballast to operate normally when the fluorescent or HID tube has been replaced, as well as to provide AC to DC rectification. A variable impedance 422 can be included for current control. An EMI filter 424 can be included to reduce EMI. A buck converter 426 converts the input power to the power signal required for the LED, OLED, QD and/or combinations of these and/or other loads 428. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 430 can be received and processed to control the current and/or voltage to the load 428, such as, but not limited to, optional wall (Triac), 0 to 3 VDC, 0 to 10 VDC, powerline (PLC), wireless, DMX, DALI, RS485, RS232, SPI, I2C, RS 422, UART, CAN bus, Ethernet, Profibus, Modbus, etc., other serial and parallel standards and interfaces and/or DALI dimming as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc., others discussed herein, etc. The control signal 164 can also support remote and/or local monitoring, reporting, analytics, etc.

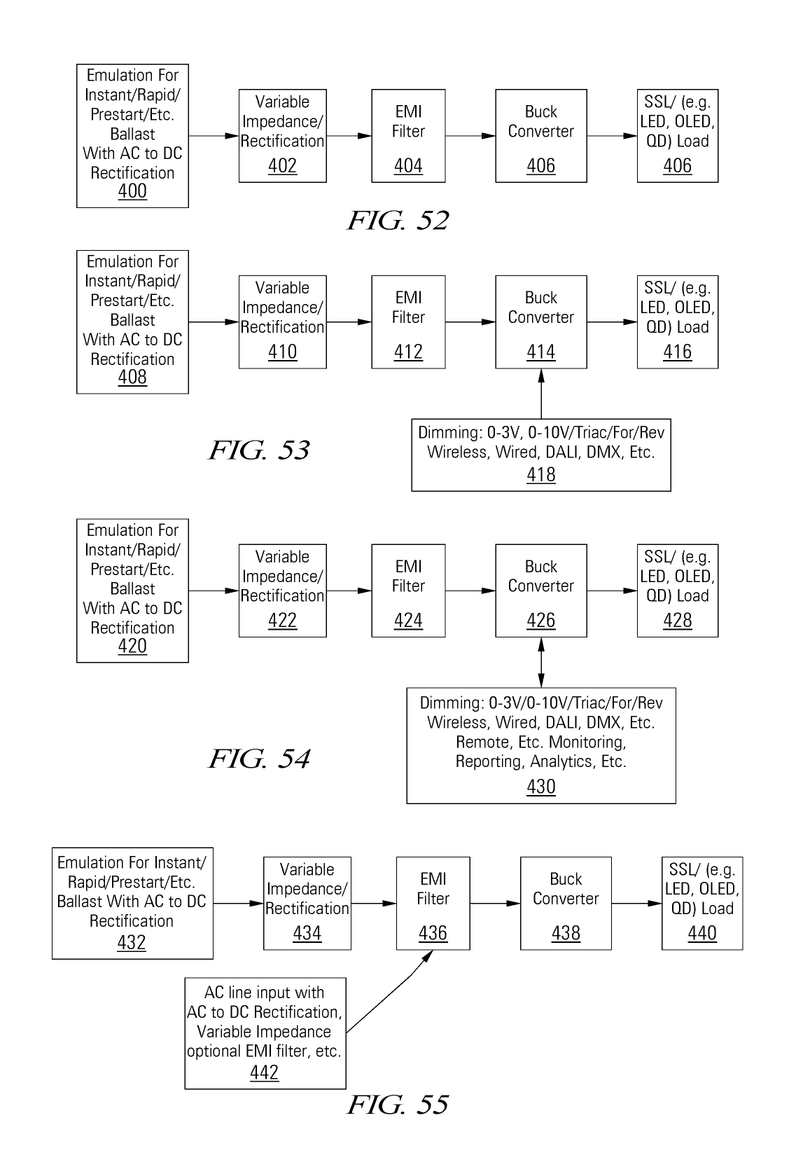

Turning to FIG. 55, a block diagram of a solid state lighting system is depicted that can be powered by both AC lines and ballast outputs, and that can be remotely controlled and dimmed in both modes. An emulation circuit 432 can be included to emulate a fluorescent or HID tube for instant/rapid/prestart ballasts to enable or assist the ballast to operate normally when the fluorescent or HID tube has been replaced, as well as to provide AC to DC rectification. A variable impedance 434 can be included for current or other control. An EMI filter 436 can be included to reduce EMI. A buck converter 438 converts the input power to the power signal required for the LED, OLED, QD and/or combinations of these and/or other loads 440. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. An AC line input 442 with AC to DC rectification and optional EMI filter, etc. provides power to the solid state lighting system in the absence of a ballast in the fluorescent lamp fixture.

Notably, all embodiments of the solid state lighting system can be adapted for use with multiple power sources including, but not limited to, the output of a ballast in a fluorescent lamp fixture and an AC line which may be accessed in some embodiments through a fluorescent lamp fixture. The omission of any inventive feature of the solid state lighting system from an example embodiment disclosed herein or depicted in the Figures should not be interpreted as an indication that the embodiment cannot include the feature, or that the invention is limited to the specific depictions in the Figures. For example, embodiments depicted without AC line inputs can be configured to accept power both from an output of a ballast and from an AC line input as disclosed elsewhere herein. Again, the embodiments disclosed and depicted in the Figures are non-limiting examples intended to depict example features which can be combined in any number of fashions depending on the application and requirements.

Furthermore, embodiments in which smart fluorescent lamp replacements provide an isolated power output to remote sensors, communications, control, IOT devices in general via a control system with peripheral interface, can include lighting power supplies such as, but not limited to, buck or other converters, and of course the inverse is also true. Thus, any particular embodiment can include the isolated power generation, the solid state lighting power generation, dimming control, and other features disclosed herein, or any subset of them, in any combination. Embodiments of the solid state lighting systems can include buck converters as shown in the Figures, or buck-boost, boost, boost-buck, Cuk, SEPIC, quasi-resonant, Flyback, forward converters, push-pull, current mode, voltage mode, etc. combinations of these, etc. In general, any type of switching/storage power supply can be adapted for use in the solid state lighting systems.

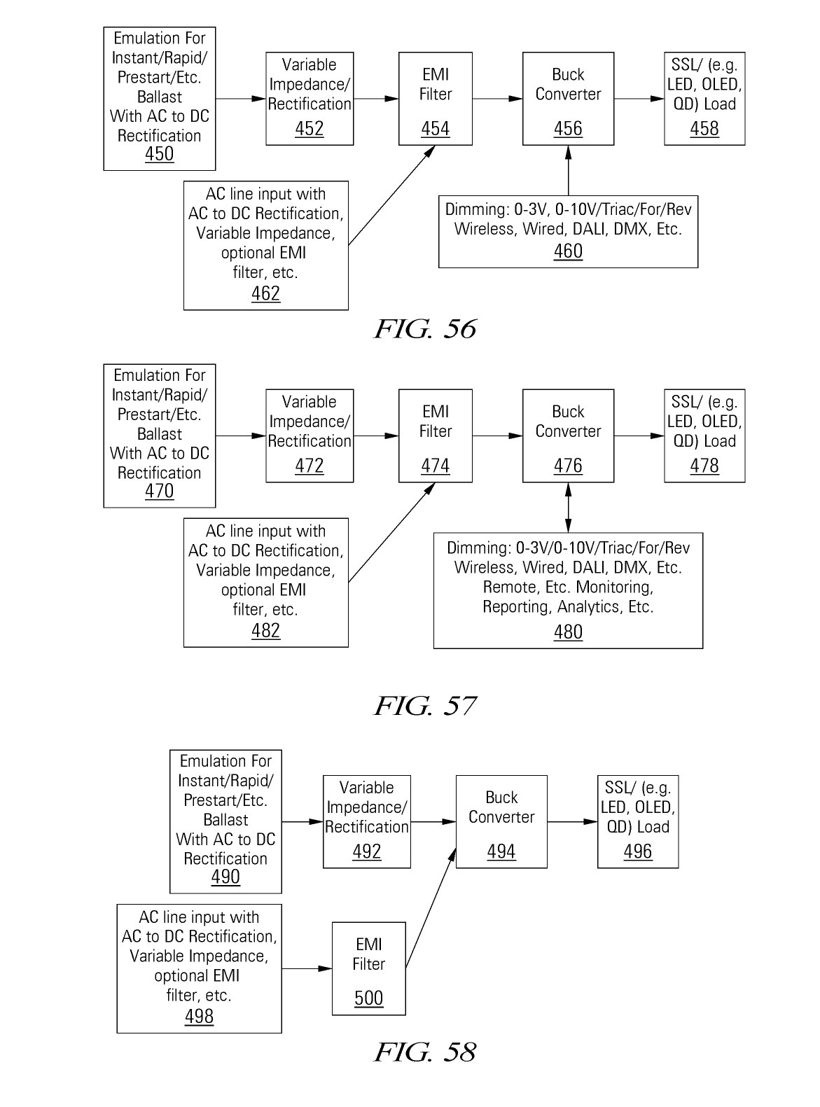

Turning to FIG. 56, a block diagram of a solid state lighting system is depicted that can be powered by both AC lines and ballast outputs, and that can be remotely controlled and dimmed and optionally color, spectrum or color temperature (white tuning) tuned in both modes. An emulation circuit 450 can be included to emulate a fluorescent or HID tube for instant/rapid/prestart ballasts to enable or assist the ballast to operate normally when the fluorescent or HID tube has been replaced, as well as to provide AC to DC rectification. A variable impedance 452 can be included for current control. An EMI filter 454 can be included to reduce EMI. A buck converter 456 converts the input power to the power signal required for the LED, OLED, QD and/or combinations of these and/or other loads 458. Although a buck circuit can be used for power conversion, as an example, most any other type of switching circuit such as, but not limited to, a buck-boost, boost, boost-buck, Cuk, SEPIC, quasi-resonant, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 460 can be received and processed to control the current and/or voltage to the load 458, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. An AC line input 462 with AC to DC rectification and optional EMI filter, etc. provides power to the solid state lighting system in the absence of a ballast in the fluorescent lamp fixture.

Turning to FIG. 57, a block diagram of a solid state lighting system is depicted that can be powered by both AC lines and ballast outputs, and that can be remotely controlled and dimmed in both modes. An emulation circuit 470 can be included to emulate a fluorescent or HID tube for instant/rapid/prestart ballasts to enable or assist the ballast to operate normally when the fluorescent or HID tube has been replaced, as well as to provide AC to DC rectification. A variable impedance 472 can be included for current control. An EMI filter 474 can be included to reduce EMI. A buck converter 476 converts the input power to the power signal required for the LED, OLED, QD and/or combinations of these and/or other loads 478. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 480 can be received and processed to control the current and/or voltage to the load 478, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 184 can also support remote and/or local monitoring, reporting, analytics, Big Data, etc. An AC line input 482 with AC to DC rectification and optional EMI filter, etc. provides power to the solid state lighting system in the absence of a ballast in the fluorescent lamp fixture.

Turning to FIG. 58, a block diagram of a solid state lighting system is depicted that can be powered by both AC lines and ballast outputs, and that can be remotely controlled and dimmed in both modes. An emulation circuit 490 can be included to emulate a fluorescent or HID tube for instant/rapid/prestart ballasts to enable or assist the ballast to operate normally when the fluorescent or HID tube has been replaced, as well as to provide AC to DC rectification. A variable impedance 492 can be included for current or other control. In some embodiments of the present invention the variable impedance for this figure and other figures can also be used to provide OVP, OTP, SCP, OCP, etc. A buck converter 494 converts the input power to the power signal required for the LED, OLED, QD and/or combinations of these and/or other loads 496. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. An AC line input 498 with AC to DC rectification and optional EMI filter, etc. provides power to the solid state lighting system in the absence of a ballast in the fluorescent lamp fixture. An EMI filter 500 can be included to reduce EMI. An optional wired or wireless control can be used in some implementations.

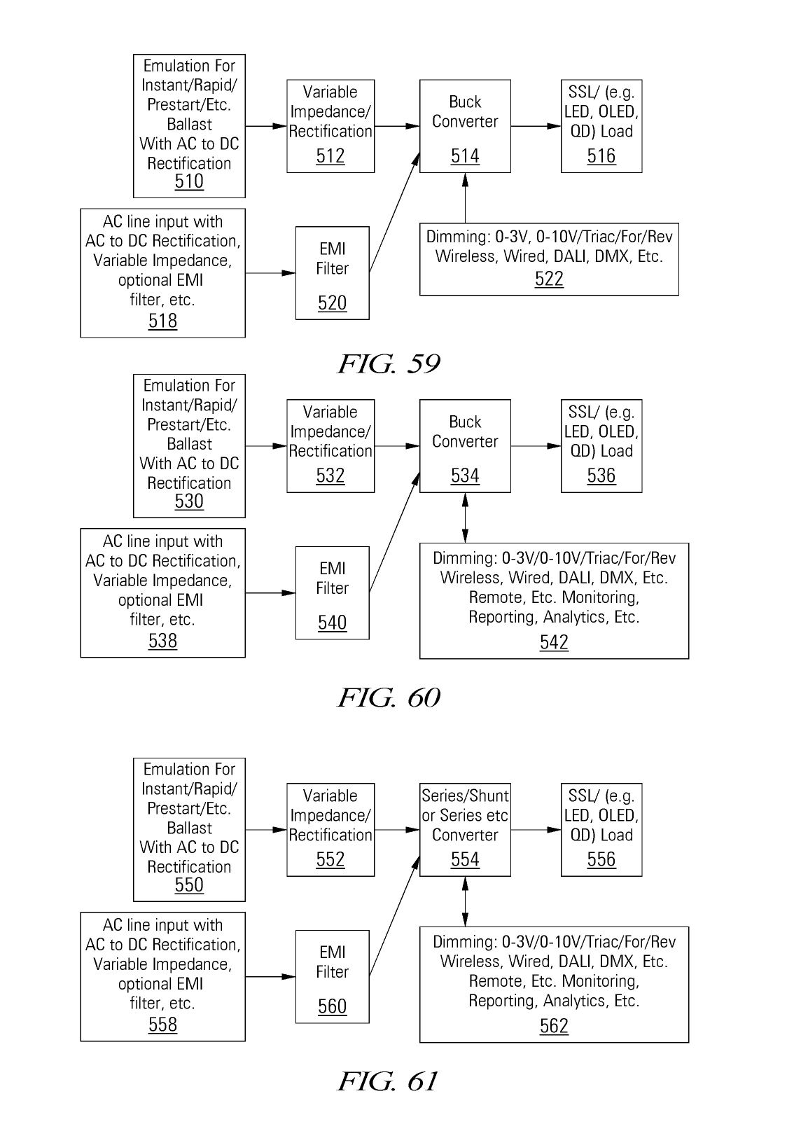

Turning to FIG. 59, a block diagram of a solid state lighting system is depicted that can be powered by both AC lines and ballast outputs, and that can be remotely controlled and dimmed in both modes. An emulation circuit 510 can be included to emulate a fluorescent or HID tube for instant/rapid/prestart ballasts to enable or assist the ballast to operate normally when the fluorescent or HID tube has been replaced, as well as to provide AC to DC rectification. A variable impedance 512 can be included for current control. A buck converter 514 converts the input power to the power signal required for the LED, OLED, QD and/or combinations of these and/or other loads 516. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 522 can be received and processed to control the current and/or voltage to the load 516, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. An AC line input 518 with AC to DC rectification and optional EMI filter, etc. provides power to the solid state lighting system in the absence of a ballast in the fluorescent lamp fixture. An EMI filter 520 can be included to reduce EMI.

Turning to FIG. 60, a block diagram of a solid state lighting system is depicted that can be powered by both AC lines and ballast outputs, and that can be remotely controlled and dimmed in both modes. An emulation circuit 530 can be included to emulate a fluorescent or HID tube for instant/rapid/prestart ballasts to enable or assist the ballast to operate normally when the fluorescent or HID tube has been replaced, as well as to provide AC to DC rectification. A variable impedance 532 can be included for current control. A buck converter 534 converts the input power to the power signal required for the LED, OLED, QD and/or combinations of these and/or other loads 536. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 542 can be received and processed to control the current and/or voltage to the load 536, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 542 can also support remote and/or local monitoring, reporting, analytics, etc. An AC line input 538 with AC to DC rectification and optional EMI filter, etc. provides power to the solid state lighting system in the absence of a ballast in the fluorescent lamp fixture. An EMI filter 540 can be included to reduce EMI.

Turning to FIG. 61, a block diagram of a solid state lighting system is depicted that can be powered by both AC lines and ballast outputs, and that can be remotely controlled and dimmed in both modes. An emulation circuit 550 can be included to emulate a fluorescent or HID tube for instant/rapid/prestart ballasts to enable or assist the ballast to operate normally when the fluorescent or HID tube has been replaced, as well as to provide AC to DC rectification. A variable impedance 552 can be included for current and other control including but not limited to as discussed herein. A shunt, series/shunt, or other converter 554 converts the input power to the power signal required for the LED, OLED, QD and/or combinations of these and/or other loads 556. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 562 can be received and processed to control the current and/or voltage to the load 556, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 562 can also support remote and/or local monitoring, reporting, analytics, etc. An AC line input 558 with AC to DC rectification and optional EMI filter, etc. provides power to the solid state lighting system in the absence of a ballast in the fluorescent lamp fixture. An EMI filter 560 can be included to reduce EMI.

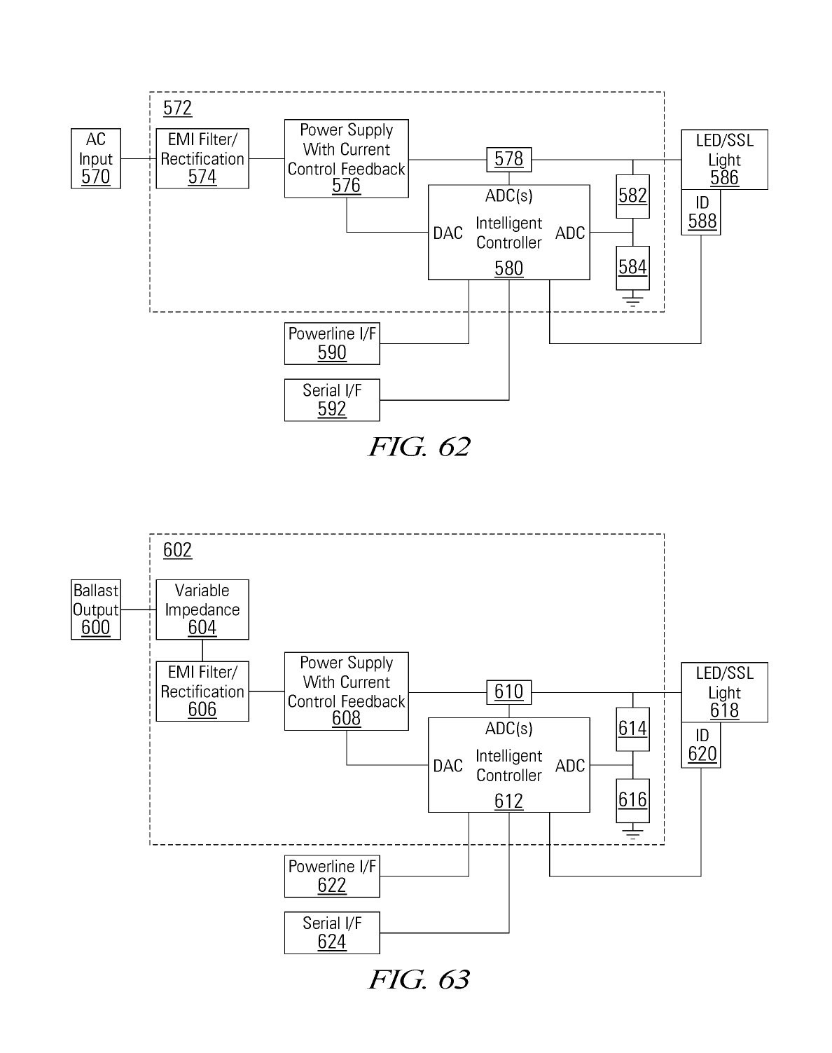

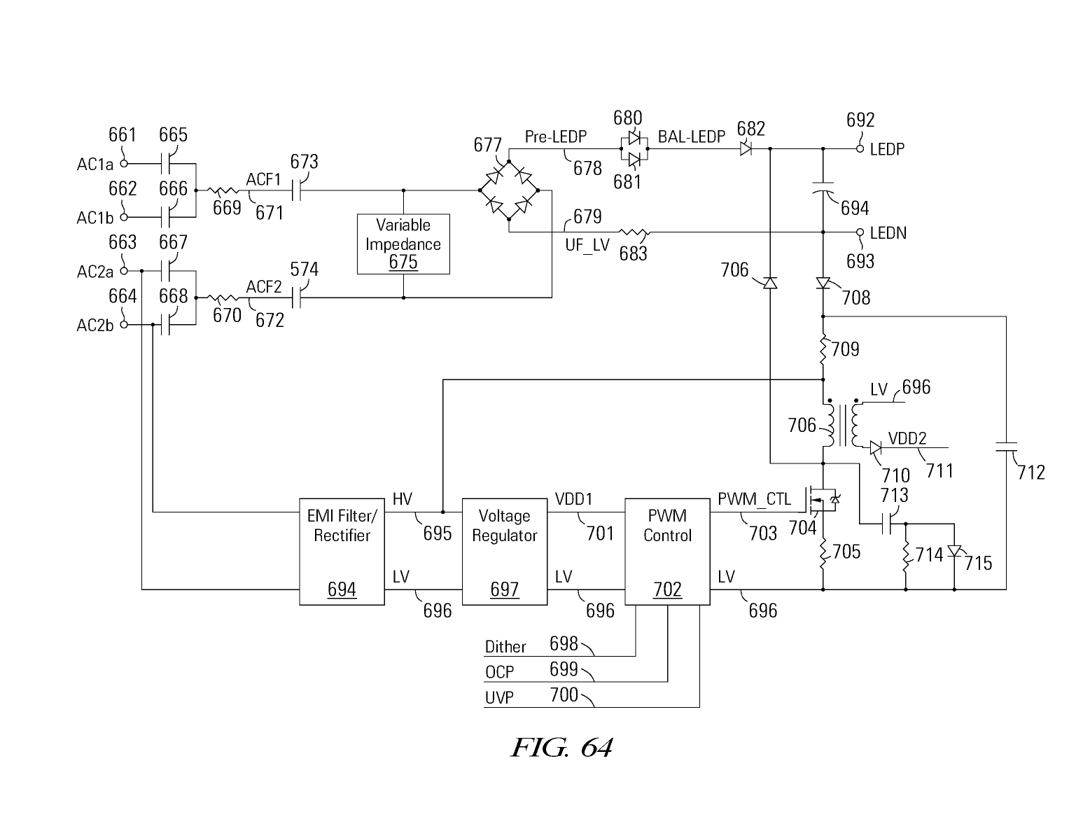

Turning to FIG. 62, a solid state lighting system with intelligent controller is depicted, providing current control feedback based on a variety of sources, such as, but not limited to, one or more of an output current sensor, output voltage sensor, powerline interface, serial interface and/or other interfaces in accordance with some embodiments of the invention. In this embodiment power, for example but not limited to, 120 VAC to 480 VAC, 50/60 Hz power from an AC input 570 is fed directly to a module 572 and rectified and filtered to yield DC current from EMI filter/rectifier 574. A power supply with current control feedback 576 (e.g., but not limited to a DC to DC buck converter) outputs a constant current power at the appropriate LED forward voltage to the SSL/LED load 586. An intelligent controller 580 can generate a feedback signal(s) for the power supply 576 from one or more sources, with optional and non-limiting examples shown in FIG. 62, including a current sensor 578 (e.g., a low impedance sense resistor and corresponding analog-to-digital converter or analog processing circuits), voltage sensor 582, 584 (e.g., a voltage divider and corresponding analog-to-digital converter), a powerline interface 590, serial interface 592 or other wired and/or wireless communications interface for receiving control commands and optionally transmitting status information. An ID circuit 588 or device associated with the SSL 586 enables the SSL 586 and associated module 572 to be uniquely controlled when grouped in a system with an array of SSLs and modules.

The intelligent controller 580 can contain a number of functional features and elements including but not limited to one or more digital to analog converters (DACs) with, for example but not limited to, at least one of the DACs providing a reference voltage for the buck converter 576 to use to set the output current to the SSL/LED light 586 or SSL/LED array light. Note that such a DAC current reference/set point can also be used to provide, for example, flashing or PWM digital dimming Analog to digital converters (ADCs) can be used to read a typically reduced (i.e., voltage divider) replica of LED forward voltage of the SSL/LED light which could be corrected for any wire/cable losses from the current output of the module. One or more optional photosensors (e.g., phototransistors) can be placed at an appropriate point(s) so as to not interfere with the SSL/LED lights and can effectively calibrated and used with the module to determine the real time efficacy (i.e., lumens/watt) of the SSL/LED light(s) and also flag any apparent degradation in the SSL/LED lighting.

As an example, two types of bidirectional communications between the module and central or distributed control include but are not limited to powerline communications (PLC) 590 to the AC lines (or optionally could be from a daisy-chained AC to AC or AC to DC and a serial connection 592 using low voltage and low current twisted pair wiring supporting one or more interfaces/protocols including but not limited to RS485, controller area network (CAN) bus, UARTs, SPI, I2C, etc. The ID circuit 588 is used to provide an ID type for the SSL/LED or SSL/LED array lamp. Such an ID can range from a simple analog identification such as a certain resistance value which corresponds to a particular LED lamp current and associated voltage to a simple integrated circuit (IC) or application specific IC (ASIC) that sends out an ID data byte or bytes when commanded to do so or a sophisticated code using discrete ICs and components or and ASIC. In other embodiments a low voltage, low current wire or wires can be used measure a resistor that is uniquely associated with a particular current and voltage LED light. In some embodiment of the present invention, a small IC or ASIC that contains an ID, calibration data, and could also measure and digitally transfer/transmit the current, voltage and power usage requirements of the SSL/LED or SSL/LED array light. Serial interfaces and UARTs as well as SPI, I2C, CAN Bus, Ethernet, etc. can be used. In some embodiments of the present invention, secure communications including cybersecure communications and related technologies, techniques, methods, methodologies, etc. can be used.

Turning to FIG. 63, a solid state lighting system with intelligent controller is depicted, providing current control feedback based on a variety of sources, such as, but not limited to, one or more of an output current sensor, output voltage sensor, powerline interface, serial interface and/or other interfaces in accordance with some embodiments of the invention. In this embodiment power, for example but not limited to, 120 VAC to 480 VAC, 50/60 Hz power from a ballast output 600 is fed directly to a module 602. Current from the ballast can be controlled by a variable impedance 604 that, for example but not limited to, can be connected in parallel with downstream circuitry to partially shunt or short current from the ballast output 600. The remaining current is rectified and filtered to yield DC current from EMI filter/rectifier 606. A power supply with current control feedback 608 (e.g., but not limited to a DC to DC buck converter) outputs a constant current power at the appropriate LED forward voltage to the SSL/LED load 618. An intelligent controller 612 can generate a feedback signal(s) for the power supply 608 from one or more sources, with optional and non-limiting examples shown in FIG. 63, including a current sensor 610 (e.g., a low impedance sense resistor and corresponding analog-to-digital converter or analog processing circuits), voltage sensor 614, 616 (e.g., a voltage divider and corresponding analog-to-digital converter), a powerline interface 622, serial interface 624 or other wired and/or wireless communications interface for receiving control commands and optionally transmitting status information. An ID circuit 620 or device associated with the SSL 618 enables the SSL 618 and associated module 602 to be uniquely controlled when grouped in a system with an array of SSLs and modules.

The intelligent controller 612 can contain a number of functional features and elements including but not limited to one or more digital to analog converters (DACs) with, for example but not limited to, at least one of the DACs providing a reference voltage for the buck converter 608 to use to set the output current to the SSL/LED light 618 or SSL/LED array light. Note that such a DAC current reference/set point can also be used to provide, for example, flashing or PWM digital dimming Analog to digital converters (ADCs) can be used to read a typically reduced (i.e., voltage divider) replica of LED forward voltage of the SSL/LED light which could be corrected for any wire/cable losses from the current output of the module. One or more optional photosensors (e.g., phototransistors) can be placed at an appropriate point(s) so as to not interfere with the SSL/LED lights and can effectively calibrated and used with the module to determine the real time efficacy (i.e., lumens/watt) of the SSL/LED light(s) and also flag any apparent degradation in the SSL/LED lighting.

As an example, two types of bidirectional communications between the module and central or distributed control include but are not limited to powerline communications (PLC) 622 to the AC lines (or optionally could be from a daisy-chained AC to AC or AC to DC and a serial connection 624 using low voltage and low current twisted pair wiring supporting one or more interfaces/protocols including but not limited to RS485, controller area network (CAN) bus, UARTs, SPI, I2C, etc. The ID circuit 620 is used to provide an ID type for the SSL/LED or SSL/LED array lamp. Such an ID can range from a simple analog identification such as a certain resistance value which corresponds to a particular LED lamp current and associated voltage to a simple integrated circuit (IC) or application specific IC (ASIC) that sends out an ID data byte or bytes when commanded to do so or a sophisticated code using discrete ICs and components or and ASIC. In other embodiments a low voltage, low current wire or wires can be used measure a resistor that is uniquely associated with a particular current and voltage LED light. In some embodiment of the present invention, a small IC or ASIC that contains an ID, calibration data, and could also measure and digitally transfer/transmit the current, voltage and power usage requirements of the SSL/LED or SSL/LED array light. Serial interfaces and UARTs as well as SPI, I2C, CAN Bus, Ethernet, etc. can be used. In some embodiments of the present invention, secure communications including cybersecure communications and related technologies, techniques, methods, methodologies, etc. can be used.

Turning to FIG. 64, a solid state lighting power supply is depicted that can draw power from a fluorescent lamp fixture in accordance with some embodiments of the invention, wherein ballasted power can be drawn from bi-pins 661, 662, 663, 664 at both ends of the lamp fixture when a fluorescent ballast is installed in the fixture, or AC power can be drawn from bi-pins 663, 664 just one end of the lamp fixture when the fluorescent ballast is not installed or has been removed from the fixture. The solid state lighting power supply can be used with all types of ballasts including electronic rapid start, instant start, programmed start, preheat, magnetic, etc. that can be remote controlled and monitored and also has remote control/dimming. In some embodiments of the present invention, some of the capacitors may be replaced, for example, but not limited to, with shorts and/or resistors.

When an electronic ballast is installed and functioning in the fluorescent lamp fixture, high frequency current flows between the bi-pins 661, 662 at one end of the lamp fixture and the bi-pins 663, 664 at the other end of the lamp fixture, and the solid state lighting power supply draws from this power to power a load connected to output nodes LEDP 692, LEDN 693. In ballast-powered operation, power is drawn through AC coupling capacitors 665, 666, 667, 668 and resistors 669, 670, which can be included along with, if desired, any other heater emulation or other input conditioning elements in any configuration to enable the ballast to function normally. Some or all of these capacitors may be optional in some embodiments of the present invention. For example, one or more resistors can each be connected in parallel with each of the input coupling capacitors 665, 666, 667, 668. One or more rectifiers 677 can be included, as well as signal conditioning components and/or EMI components which can be included as desired, such as, but not limited to, diodes 680, 681, 682, capacitors 684, as well as sensing components such as current sensing resistor(s) (e.g., 683) that can be used, for example, to sense the current through the output nodes LEDP 692, LEDN 693 which supply current to a solid state lighting load.

When the ballast is not installed in the fluorescent lamp fixture, AC line power is drawn from the pair of bi-pins 663, 664 at one end of the lamp fixture. An EMI filter/rectifier 694 filters and rectifies the input power to yield a rectified AC signal HV 695, which is at or near the line voltage and is therefore referred to herein as a high voltage signal in comparison with lower DC voltages (e.g., 15 VDC, 6 VDC, 3 VDC, etc.) that can be generated in the solid state lighting power supply to power circuits in the solid state lighting power supply or any other desired load including but not limited to sensors, IOT, controls, communications, etc. including but not limited to those discussed herein, combinations of these, etc.

A voltage regulator 697 regulates the rectified AC signal HV 695 to yield a lower voltage DC signal VDD1 701, used to power at least one pulse width modulation control circuit 702. The voltage regulator 697 can be a linear regulator or can comprise a buck converter circuit or, in other embodiments, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc.

In some embodiments, a dither signal 698, over-current protection 699, undervoltage protection 700, or any other control and protection signals and circuits can be used with the PWM control or other type of pulse control 702, including but not limited to over-temperature protection, over-voltage protection, etc.

The pulse width modulation control circuit 702 generates a pulse width modulated control signal PWM_CTL 703 to control the current drawn from the rectified AC signal HV 695 and supplied to the output nodes LEDP 692, LEDN 693 in AC power mode. The pulse width modulated control signal PWM_CTL 703 controls a switch 704 which passes or blocks current between the rectified AC signal HV 695 and return signal LV 696 through the switch 704, a current sensing resistor 705 and an inductor 706 or transformer. The AC supply side is coupled to the output nodes LEDP 692, LEDN 693 by diodes 706, 708 and capacitor 712. In AC power mode, when the switch 704 is closed, current flows from the rectified AC signal HV 695, through inductor 706, diode 706 to output node LEDP 692, returning from output node LEDN 693, through diode 708, and capacitor 712. When the switch 704 is opened to control the average load current, power stored in inductor 706 flows through diode 706 to output node LEDP 692, returning from output node LEDN 693, through diode 708 and current sense resistor 709. Such a switching or storage circuit depicted in FIG. 8 can be, for example but not limited to a buck, buck-boost, boost-buck, boost, flyback, forward converter, SEPIC, Cuk, etc.

In some embodiments, power can be obtained through a tagalong winding on inductor 706 for other purposes, yielding power signal VDD2 711 through diode 710 which can be used for any purpose.

Dimming control can be applied to the pulse width modulation control circuit 702 in any suitable manner to modify or control the pulse width of the pulse width modulated control signal PWM_CTL 703 from the pulse width modulation control circuit.

In some embodiments of the present invention, snubber and/or clamp circuits (e.g., including but not limited to capacitor 713, resistor 714 and diode 715) may be used with the rectification stages (which, for example, could be diodes or transistors operating in a synchronous mode) or elsewhere as shown; such snubbers could typically include capacitors, resistors and/or diodes or be of a lossless type of snubber where the energy is recycled or be made of capacitors only or resistors only, etc. Such snubbers can be of benefit in reducing radiated emissions and limiting the voltages seen by switching elements. Some embodiments of the present invention can use lossless snubbers.

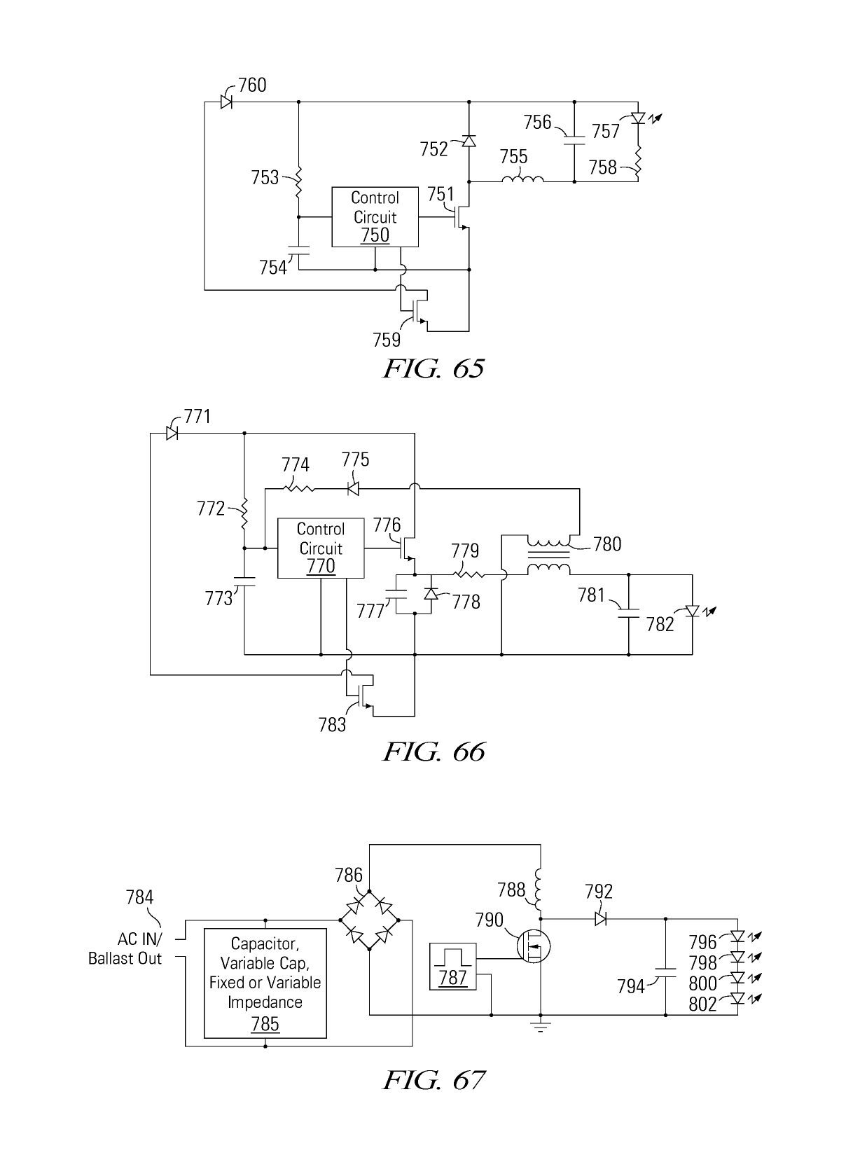

Turning now to FIG. 65, a dual power source circuit is depicted which can be used in various solid state lighting systems for any purpose in accordance with some embodiments of the invention, for example to draw power from a ballast output or an AC input. In one example embodiment, a control circuit 750 generates a PWM signal to control a transistor 751, with a diode 752 and inductor 755 forming a buck converter along with the transistor 751 to power a load 757 and output capacitor 756. Current limiting or sense resistors (e.g., 758) can also be included as desired. As a second source of power in the circuit, the drain of a transistor 759 can be connected to a connection to either an AC input or ballast output, if a ballast is installed. This enables the buck converter to be turned off to control the output using transistor 759. Although a buck converter is depicted and discussed with respect to FIG. 65, in general, any type of switching/storage circuit, including non-isolated and/or isolated circuits such as but not limited to boost, buck-boost, boost-buck, flyback, forward converters, Cuk, SEPIC, etc. can be used for the present invention.

Turning now to FIG. 66, a dual power source circuit with a tagalong inductor 780 to power internal circuits is depicted which can be used in various solid state lighting systems for any purpose in accordance with some embodiments of the invention, for example to draw power from a ballast output or an AC input. In one example embodiment, a control circuit 770 generates a PWM signal to control a transistor 776, with a diode 779, capacitor 777 and tagalong inductor 780 forming a buck converter along with the transistor 776 to power a load 782 and output capacitor 781. In this embodiment, the control circuit 770 is powered through diode 775 and resistor 774 from tagalong inductor 780. As a second source of power in the circuit, the drain of a transistor 783 can be connected to a connection to either an AC input or ballast output, if a ballast is installed.

Again, various embodiments of the solid state lighting systems disclosed herein can include/use/incorporate power converters of any type or topology. The schematics shown for, for example but not limited to, the buck, buck-boost, boost-buck, boost, Flyback, forward converters, etc. are intended to be representative only and in no way or form limiting and are merely intended as simple example references for some of the approaches, topologies, circuits, drivers, power supplies, etc. discussed herein and previously incorporated in patents and patent applications. For example, in some embodiments the switching/storage inductor or inductors in the buck circuit may be placed in a different position relative to other components. In some embodiments, isolation including galvanic isolation may be desirable and/or needed.

Turning now to FIG. 67, a boost power supply circuit that can be used in some embodiments of a solid state fluorescent replacement lighting system for either or both lighting or secondary power supply is depicted in accordance with some embodiments of the invention. The boost power supply circuit can provide a higher voltage to the load than received at the input. Power is received from an AC input 784 across a fixed or variable value capacitor or other impedance 785 and is rectified in diode bridge 786. The impedance 785 can be for example, one or more fixed or variable capacitors, and when receiving power from a ballast output, can be used to lower the output voltage of the ballast and can be used for dimming purposes. A PWM generator 787 drives a transistor 790 to allow current from the diode bridge 786 to flow through inductor 788 and storing energy in a magnetic field around inductor 788 (referred to herein as storing energy in the inductor) when transistor 790 is closed. When transistor 790 is open, the inductor 788 releases current (or resists the change to the current) through diode 792, charging capacitor 794 and powering LEDs 796, 798, 800, 802, with diode 792 preventing capacitor 794 from discharging through transistor 790 when it is closed.

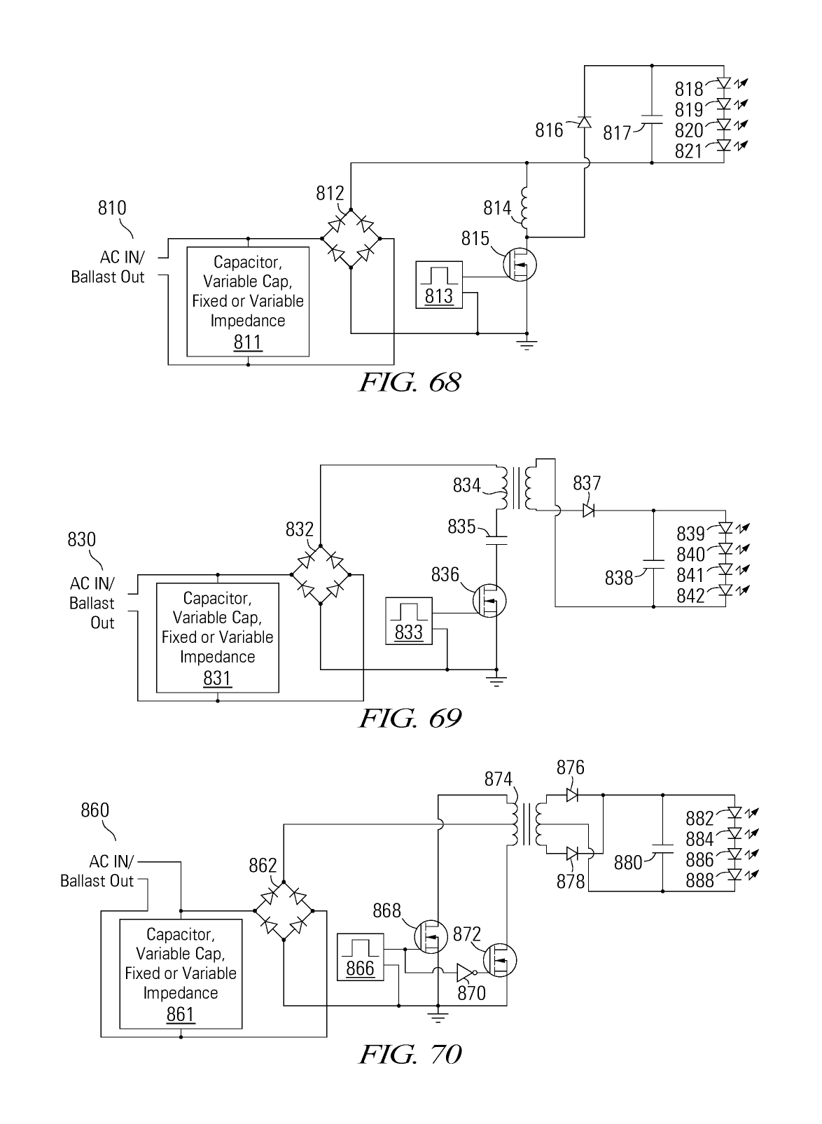

Turning now to FIG. 68, a buck-boost power supply circuit is depicted that can be used in some embodiments of a solid state fluorescent replacement lighting system for either or both lighting or secondary power supply in accordance with some embodiments of the invention. The buck-boost converter can be configured to increase or decrease the output voltage with respect to the input voltage. Power is received from an AC input 810 across a fixed or variable value capacitor or other impedance 811 and is rectified in diode bridge 812. A PWM generator 813 drives a transistor 815 to allow current from the diode bridge 812 to flow through inductor 814 as transistor 815 is closed. As transistor 815 is opened, the inductor 814 releases current through diode 816, charging capacitor 817 and powering LEDs 816, 818, 820, 822. (If the transistor 815 is left either closed or open, DC current is effectively blocked.)

Turning now to FIG. 69, a flyback converter power supply circuit is depicted that can be used in some embodiments of a solid state fluorescent replacement lighting system for either or both lighting or secondary power supply in accordance with some embodiments of the invention. Power is received from an AC input 830 across a fixed or variable value capacitor or other impedance 831 and is rectified in diode bridge 832. A PWM generator 833 drives a transistor 835 to allow current from the diode bridge 832 to flow through the primary winding of transformer 834 as transistor 815 is closed. As transistor 815 is opened, the transformer 834 releases current through diode 837, charging capacitor 838 and powering LEDs 839, 840, 841, 842.

Turning now to FIG. 70, a flyback converter power supply circuit with half bridge is depicted that can be used in some embodiments of a solid state fluorescent replacement lighting system for either or both lighting or secondary power supply in accordance with some embodiments of the invention. Power is received from an AC input 860 across a fixed or variable value capacitor or other impedance 861 and is rectified in diode bridge 862. A PWM generator 866 drives transistors 868, 872 to allow current from the diode bridge 864 to flow through one side or the other of the primary winding of center-tapped transformer 874 as the transistors are opened and closed. Although an inverter 870 is depicted to indicate that the transistors 868, 872 are not closed simultaneously, any suitable circuit or algorithm can be used to drive the transistors 868, 872. Based upon the disclosure herein, one of ordinary skill in the art will recognize a variety of ways in which transistors 868, 872 can be driven in a mutually exclusive fashion. As each transistor 868, 872 is opened, the transformer 874 releases current either through diode 876 or diode 878, charging capacitor 880 and powering LEDs 882, 884, 886, 888.

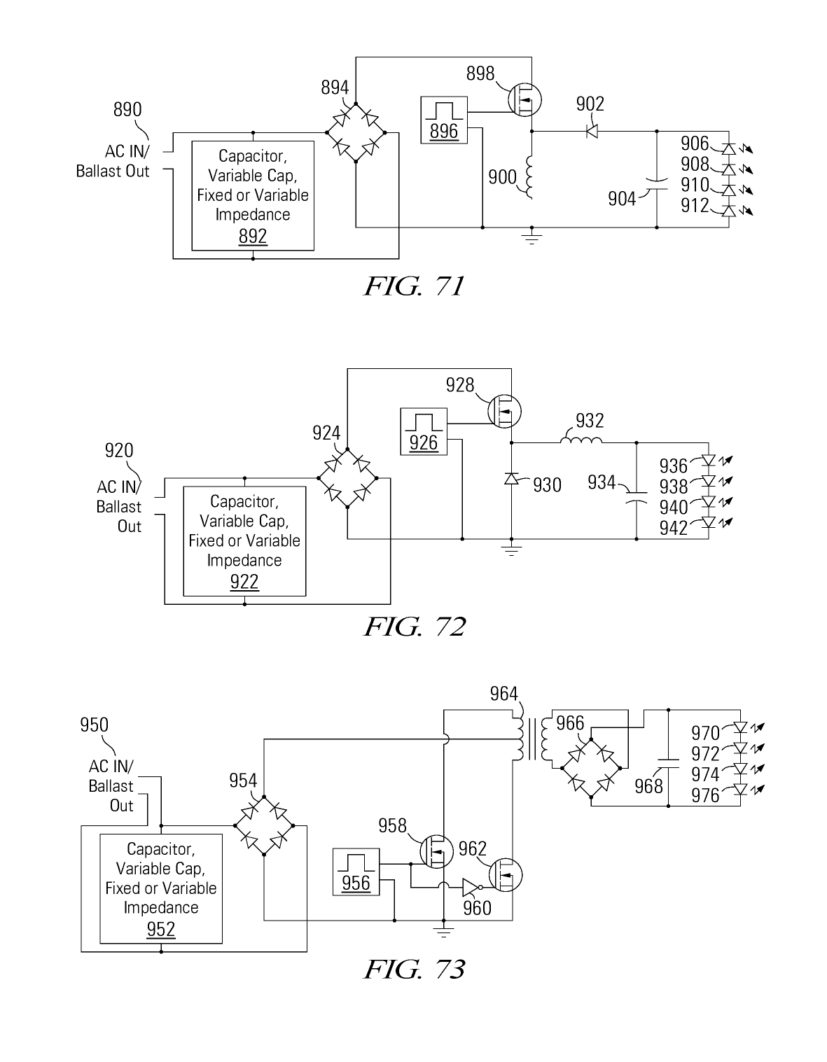

Turning now to FIG. 71, a buck-boost power supply circuit is depicted with inverted output that can be used in some embodiments of a solid state fluorescent replacement lighting system for either or both lighting or secondary power supply in accordance with some embodiments of the invention. The buck-boost converter can be configured to increase or decrease the output voltage with respect to the input voltage. Power is received from an AC input 890 across a fixed or variable value capacitor or other impedance 892 and is rectified in diode bridge 894. A PWM generator 896 drives a transistor 898 to allow current from the diode bridge 896 to flow through inductor 900 as transistor 898 is closed. As transistor 898 is opened, the inductor 900 releases current, charging capacitor 904 and powering LEDs 906, 908, 910, 912 through diode 902.

Turning now to FIG. 72, a buck power supply circuit is depicted that can be used in some embodiments of a solid state fluorescent replacement lighting system for either or both lighting or secondary power supply in accordance with some embodiments of the invention. Power is received from an AC input 920 across a fixed or variable value capacitor or other impedance 922 and is rectified in diode bridge 924. A PWM generator 926 drives a transistor 928 to allow current from the diode bridge 926 to flow through inductor 932 as transistor 928 is closed, charging capacitor 934 and powering LEDs 936, 938, 940, 942. As transistor 928 is opened, the inductor 932 releases current through diode 930.

Turning now to FIG. 73, a forward converter power supply circuit with full bridge is depicted that can be used in some embodiments of a solid state fluorescent replacement lighting system for either or both lighting or secondary power supply in accordance with some embodiments of the invention. Power is received from an AC input 950 across a fixed or variable value capacitor or other impedance 952 and is rectified in diode bridge 954. A PWM generator 956 drives transistors 958, 962 to allow current from the diode bridge 954 to flow through one side or the other of the primary winding of center-tapped transformer 964 as the transistors are opened and closed. Although an inverter 960 is depicted to indicate that the transistors 958, 962 are not closed simultaneously, any suitable circuit or algorithm can be used to drive the transistors 958, 962. Based upon the disclosure herein, one of ordinary skill in the art will recognize a variety of ways in which transistors 958, 962 can be driven in a mutually exclusive fashion. As each transistor 958, 962 is opened, the transformer 964 releases current through diode bridge 966, charging capacitor 968 and powering LEDs 970, 972, 974, 976. Although only four LEDs are depicted in, for example, FIGS. 67 through 75, in general any number of LEDs in parallel, series, etc., arrays of LEDs and/or other SSLs, combinations of these, etc. can be used in embodiments and implementations of the present invention.

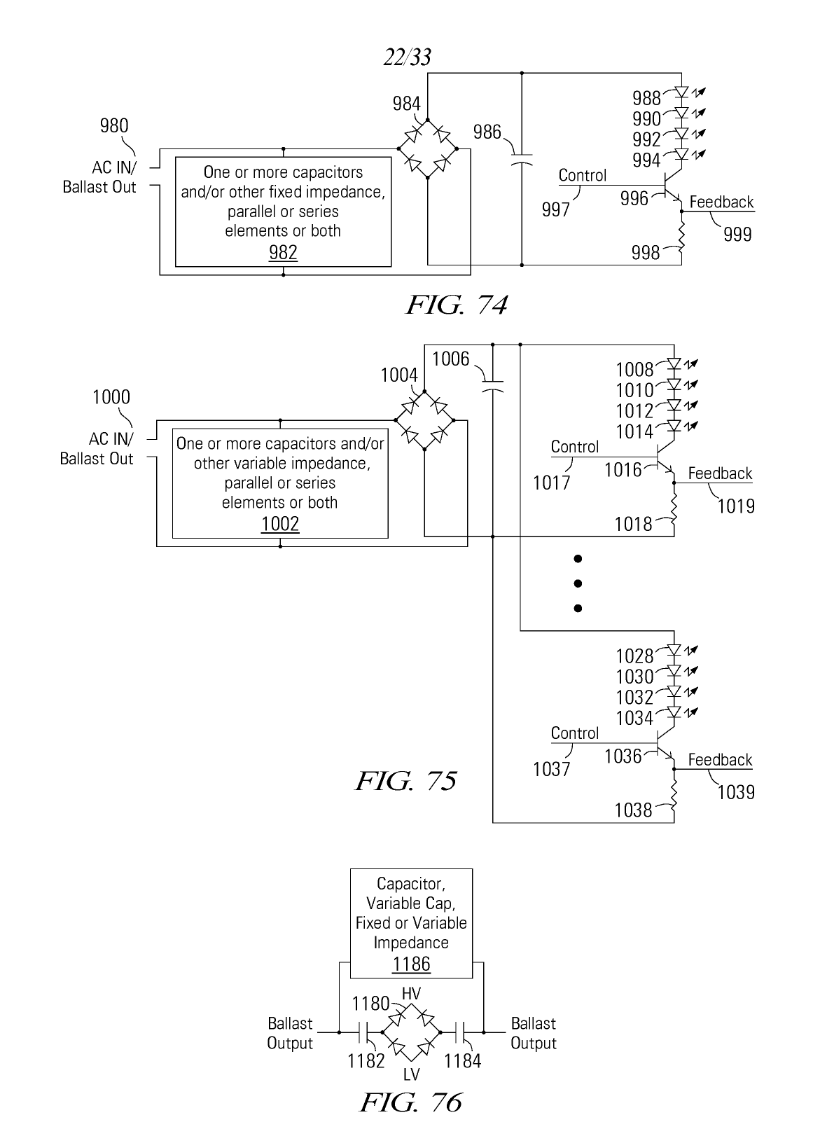

Turning now to FIG. 74, a power supply circuit with feedback control is depicted that can be used in some embodiments of a solid state fluorescent replacement lighting system in accordance with some embodiments of the invention. Power is received from an AC input 980 across one or more fixed value capacitors or other impedances 982, which can include various elements in parallel or series or both, and is rectified in diode bridge 984. An output capacitor 986 is connected across the output of the diode bridge 984. When a control switch 996 is closed, current from the diode bridge 984 can flow, powering LEDs 988, 990, 992, 994 and charging output capacitor 986. A feedback signal 999 can be used to measure the load current across sense resistor 998, and any suitable circuit such as, but not limited to, the feedback and control circuits disclosed herein can be used to generate the control signal 997 for switch 996 based on the feedback signal 999. In some embodiments, multiple output stages (e.g., multiple copies of elements 988-999) can be included, for example but not limited to, to drive multiple or different color strings.

Turning now to FIG. 75, a power supply circuit with feedback control and variable input capacitor is depicted that can be used in some embodiments of a solid state fluorescent replacement lighting system in accordance with some embodiments of the invention. Power is received from an AC input 980 across one or more variable value capacitors or other impedances 1002 and is rectified in diode bridge 1004. An output capacitor 1006 is connected across the output of the diode bridge 1004. When a control switch 1016 is closed, current from the diode bridge 1004 can flow, powering LEDs 1008, 1010, 1012, 1014 and charging output capacitor 1006. A feedback signal 1019 can be used to measure the load current across sense resistor 1018, and any suitable circuit such as, but not limited to, the feedback and control circuits disclosed herein can be used to generate the control signal 1017 for switch 1016 based on the feedback signal 1019. Furthermore, the capacitance of variable input capacitor 1002 based upon the feedback signal 1019 or any other measured signal or control signal, providing further control of the load current. In some embodiments, multiple output stages (e.g., multiple copies of elements 1008-1019) can be included, for example but not limited to, to drive multiple or different color strings, arrays, groups, etc. of SSL including but not limited to LEDs of any type and form, OLEDs, QDs, etc. The power supply circuit of FIG. 75 can be adapted to use PWM control, DC voltage based control signals, etc., switching, linear, series regulators, etc. As depicted in FIG. 75, such an example extra channel can include, but is not limited to, LEDs 1008, 1010, 1012, 1014, control signal 1037, control switch 1036, and feedback signal 1039. Although the output channels in FIG. 75 are depicted as duplicate copies, the various channels in a multi-channel system can each be customized or tailored to meet various requirements, such as being based on the current requirements or output intensity of each LED, color choices, selections, requirements, etc. including manually, automatically, by sensor, scene, schedule, event, etc. others as discussed herein, etc. combinations of these, etc.

Control switches (e.g., 1016, 1036) can be any type of switch (e.g. BJT, MOSFET, JFET, CMOS, etc.) in any type of operation (e.g., switching, PWM, linear, analog, etc.)

Some embodiments of the present invention use capacitors in series to limit AC line (50, 60, 400 Hz, etc.) input current and power and use capacitors in parallel to limit ballast (output) input (to the circuit) current and power which can also prevent mis-wiring which might cause damage. SCP can also be used in conjunction to also limit current and prevent damage.

Some embodiments of the present invention provide a USB port which can used to set addresses, ID, upload new versions, set priorities, set and program priority levels, etc.

Some embodiments of the present invention can be used to provide festive lighting including for holidays (Christmas, New Years, Halloween, Fourth of July, St Patrick's Day, etc.), favorite/local (high school, college, university, professional) team, company, state, personal, college, university, etc., colors, etc.

Some embodiments of the present invention provide the ability to disable current control (e.g., constant current/constant lumens) including remotely disable in ballast mode.

Some embodiments of the present invention include a fluorescent tube replacement such as a T4, T5, T8, T10, T12, etc. that can use a motor or similar device to raster or scan the SSL/LED lighting which could include but is not limited to one or more white color temperatures, one or more colors including but not limited to red, green, blue, amber, yellow, etc., combinations of these, etc. Some implementations of the present invention can include but are not limited to addressable arrays of LEDs including white color temperatures (W, WW, WWW, etc.) and colors such as RGB, RGBA, etc.

Some embodiments of the present invention can measure the input current, voltage, power, power factor, etc. of, for example, but not limited to, each unit (lamp), the group or groups of lamps controlled by a ‘wall dimmer’ of the present invention, etc. By measuring such input power used/consumed, implementations of the present invention can measure/calculate/determine/etc. the power/energy consumed and the both the energy (which essentially equals power×time) consumed and the energy saved for example, but not limited to, for the SSL/LED direct fluorescent replacement lamp that, for example, uses a ballast or a SSL/LED AC retrofit fluorescent replacement lamp that runs directly off the AC power and use such information to calculate the energy savings including but not limited to the energy savings based on the difference between the old/previous fluorescent lamp with ballast. Using such energy savings measurements/calculations/determinations/etc., the monetary savings value can be calculated/deduced/determined, etc. from the energy cost rate for example, but not limited to, by using the energy cost in, for example, but not limited to, multiplying the energy (equals power times time) in for example, but not limited to, kilowatthours (kWH) times the rate (in, for example, dollars per kWH=S/kWH) to determine the financial monetary savings. Such monetary savings can be used as the basis for determining the return on investment or, for example, to determine the value of a leasing agreement, etc. Such information, determinations, processing, etc. can be done, stored, compiled. performed, etc. by firmware, software, etc., stored anywhere in one or more locations, including but not limited and not necessarily in embodiments and implementations of the present invention, etc. (and more types of places, locations, facilities, etc.), the cloud, servers, internet, can use mobile carriers to communicate two-way information, controls, commands, monitoring, analytics, Big Data, data mining, events including but not limited to DR and DER and other events, alerts, security information, movements, heat maps, etc., combinations of these, etc.

Some embodiments of the present invention include dimming/control units that can also optionally measure and monitor and log data, information, performance, etc. Such embodiments can use 0 to 10 V, 0 to 3 V, other analog protocols, ranges, etc., powerline communications, wireless, wired other digital protocols, etc., forward or reverse phase dimming of any kind and type including ones that involve one or more of triacs, transistors, diodes, etc., combinations of these, etc. and can use light level motion, ultrasonic, noise, sound, voice, etc. Embodiments of the present invention that have one or more outputs including output channels can have one or more analog and/or digital interfaces including, but not limited to, as an example one or more (multiple) 0 to 10 V inputs to individually control the one or more (multiple) output channels. As another non-limiting example, DALI, DMX, DMX512, RS485, etc. can use, for example, but not limited to one digital input to address one or more output channels using the digital information contained in protocol and interface of the particular digital standard or other digital interface, etc. Of course more than one or more DALI, DMX, DMX512, RS485, etc., combinations of these, etc. can be used in the implementations of the present invention.

The present invention includes power supplies and drivers that are ballast replacements (ballast replacement power supplies and ballast replacement drivers (BRPS and BRD, respectively) designed specifically for SSL/LED FLRs).

Some embodiments of the present invention can be used to replace, for example, 96 W, 60 W, 32 W etc. with a lower wattage that can be increased manually or automatically by, for example, but not limited to, switches, software, hardware, firmware, manual and/or automatic controls, etc.

Some embodiments of the present invention can use a smart circuit breaker(s) and/or switch(es) that, in addition to performing normal circuit breaker functions, can be turned on and off by wired, wireless and/or powerline communications

Some embodiments and implementations of the present invention can work with virtually any type of ballast including all types of magnetic and electronic ballasts and, regardless of the ballast type and ability (i.e., a fixed power, non-dimmable, non-controllable, etc. ballast) make the ballast and fluorescent lamp replacement into a smart and intelligent system capable of virtually any control and monitoring including but not limited to daylight harvesting, dimming, motion, noise, audio, ultrasonic, sonar, radar, proximity, cell phone, RFID, light, solar, time of day, week, month, date, etc., web, environment, etc. sensing and responding, etc. one or two way communications, data logging, analytics, fault reporting, etc. and other functions, features, modes of operation, etc. discussed herein. Such embodiment and implementations can also be implemented to work directly with AC and/or DC power. Although primarily discussed in terms of fluorescent lamp replacements, all of the functions, abilities, capabilities, features, modes of operation, approaches, methods, techniques, technologies, designs, architectures, topology, etc. apply directly and equally to high intensity discharge (HID) lighting including but not limited to metal halide, and all types of sodium and other gaseous low pressure and high pressure lighting, etc., other types of lighting discussed herein including various types of fluorescent lighting including but not limited to compact fluorescent lamps, PL and PLC fluorescent lamps, cold cathode fluorescent lamps, T1 through T13 fluorescent lamps including but not limited to T4, T5, T6, T8, T10, T12, etc. fluorescent lamps of any length and shape including but not limited to linear, U-shaped, rectangular shape, one or more U-shaped, etc.

The heater emulation circuits may employ one more switches that can open or close as needed depending on for example, frequency of applied current, voltage, power, etc., temperature, operating conditions, etc., type of ballast, etc. Such one or more switches can be of any appropriate type or form including ones that are manually or automatically activated, mechanically or electrically activated, are semiconductor switches such as but not limited to field effect transistors (FETs) including but not limited to MOSFETs, JFETs, UFETs, etc., of both depletion and enhancement types, bipolar junction transistors including but not limited to PNP and NPN, heterojunction bipolar transistors (HBTs), unijunction transistors, triacs, silicon controlled rectifiers (SCRs), diacs, insulated gate bipolar transistors (IGBTs), GaN-based transistors including but not limited to GaNFETs, silicon carbide (SiC) based transistors including but not limited to SiCFETs, etc., solid state and mechanical relays, reed relays, electromechanical relays, latching relays, contactors, etc. photodiodes, phototransistors, optocouplers, etc. vacuum tubes, etc. thermistors, thermistor-based switches, etc. Temperature sensing can be accomplished using any technique including but not limited to thermistors, semiconductor junctions, thermocouple junctions, resistors, fuses, thermal methods, etc.

The present invention provides for convenient direct replacements for fluorescent, HID and other types of lighting using SSL including but not limited to LEDs, OLEDs, QDs, etc. that enables smart and intelligent operation where there was none before. Embodiments of the present invention provide for SSL FLRs that can perform smart and intelligent dimming and power reduction including autonomously, automatically, manually, with one-way or two-way (i.e., bidirectional) communications and reporting using smart local or remote sensors including but not limited to those discussed herein. Such sensors can be manually, automatically, programmed, modified, set, determined, changed, etc. including locally and remotely. For example, a motion sensor can be programmed/set by, for example, but not limited to, an app on a phone, tablet, laptop, other personal digital assistant, other device, etc. for sensitivity, time on, time off, trigger level, distance, reporting level and status, alarms, etc. either locally or remotely via, for example, but not limited to, an phone/tablet app. In addition, embodiments and implementations of the present invention can also be set to monitor and report back any fault conditions including but not limited to power interruptions, power loss, improper operation, too little power, too much power, too much voltage (over voltage), too little voltage (under voltage), too little current (under current), too much current (over current), too little light output, too much light output, too high of a temperature, too low of a temperature, etc., arcing, damage, combinations of these, etc. and alert/request maintenance/repair, etc.

In some embodiments, bathroom, closet, stairwell, garage, conference room, other locations which may or may not be used frequently, etc. can make use of the ballast-compatible direct fluorescent lamp replacement embodiments of the present invention including but not limited to the smart/intelligent ones discussed herein.

Embodiments of the present invention can also monitor and report power, current, voltage usage to, for example, but not limited to, measure, determine and calculate energy and cost savings and to also, but not limited to, determine SSL/LED usage in terms of hours on and current through the SSL/LEDs to determine, estimate, extrapolate, calculate, etc. lifetime remaining, SSL/LED degradation, depreciation, etc. Optional temperature and/or light sensors may also be used to keep track, track, log, perform additional analytics including but not limited on the lifetime, performance, degradation, decrease in lumens, lumens depreciation, etc. of the SSL/LEDs, etc.

Various embodiments of the present invention can be used to replace any and all types of gaseous lighting including but not limited to fluorescent, HID, metal halide, sodium, low and/or high pressure lamps, etc. for parking lights, street lights, outdoor lights, indoor lights, sports lights, gymnasium lights, office lights, stair well lighting, virtually any type of indoor or outdoor lighting, stair case lights, bathrooms, closets, bedrooms, living rooms, family rooms, hospitals, hospital rooms, surgery rooms, urgent care, emergency care, classrooms, auditoriums, offices, lobbies, gyms, sports centers, community centers, recreational centers, libraries including but not limited to libraries for schools, colleges, universities, public and private libraries, study areas, individual cubicle lighting including, for example, but not limited to individual lighting in a library where the lighting preference including, for example, but not limited to light intensity, color temperature, color rendering index (CRI), light pattern and location, etc., color lighting, etc. could be selected for/by, etc. each individual or user, etc. and also includes additional facilities, rooms, homes, residences, apartments, etc. Implementations of the present invention can also be used for cleanroom applications including but not limited to photolithography applications and locations where the wavelength and associated energy, color, etc. must be restricted to typically a yellow color or below (i.e., to the red wavelengths as opposed to the blue wavelengths). For such implementations yellow SSL including but not limited to yellow phosphor coated (PC) SSLs including LEDs, OLEDs, QDs, etc. can be used to provide the appropriate and needed color of light while still being highly efficient and with long life.

Some embodiments of the present invention can also use, employ, interact with, be controlled, respond to, etc., combinations of these, etc. emotion sensors and mood sensors.

Systems of SSL FLR, direct AC replacement kits, panels including panels of any size from inches (or less) on a side to feet on a size and larger including but not limited to 1×2 foot, 2×2 foot, 1×3 foot, 2×3 foot, 2×4 foot, 3×4 foot, 4×4 foot, 6 foot, 8 foot, and larger (and also smaller), PLC lamps, PAR lamps, A lamps, R lamps, BR lamps, etc., any other type of lamp, light, light fixture, combinations of these, etc.

Embodiments of the present invention can control, monitor, color change, color temperature change, etc. all types of lighting which can all be controlled by the same interface and control or, for example, as discussed elsewhere herein, multiple controls and/or interfaces, etc.

In some embodiments of the present invention, the lighting can be set/programmed including but not limited to active and/or dynamic processing, programming, synchronizing, sequencing the lighting so that, for example but not limited to, the lighting being on, turned on/off, dimmed, etc. in certain ways, paths, etc. from less than one second to more than one hour. Such embodiments allow for special effects including the appearance that the light is following, leading, shadowing, tracking, anticipating, etc., combinations of these, etc. the movement, direction, destination, or location, etc. that one or more people, living creatures, persons with permission, persons without permission, etc. may be heading to, going toward, etc. Such embodiments may use but are not limited to one or more motion sensing, radar, movement, vibration, sonar, ultrasonic, ultrasound, camera(s), vision recognition, pattern recognition, photocells, photo detector(s), electric eye(s), RFID, cell phone signals, smart phone signals, tablet signals, RF signal strength/detection including but not limited to Bluetooth, other 2.4 GHz, ISM, WiFi, ZigBee, Zwave, 5LoWPAN, LoRa, PLC, other types, protocols, frequencies, etc. discussed herein, etc., combinations of these, as well as other information including methods of identification, badge/sign-in entry, time of day, database information, web based information, signals, data, etc., day, date, weather, temperature, humidity, light level, solar/Sunlight level, gesturing, facial expressions, movements, ambient conditions, environment, track speed including but not limited to of a person or persons, etc., animal(s), other living creatures, animate or inanimate objects, etc. Such embodiments can make the speed of on/off and or dimming to whatever is desired, needed, required including from extremely fast to extremely slow. Such embodiments may be used for any application or use including but not limited to indoor and/or outdoor applications including but not limited to hallways, rooms, meeting locations, conference rooms, conference centers, convention centers, sports events centers, to and from locations such as bathrooms, open or closed/covered parking lots and locations, street lighting, including but not limited to for pedestrians and vehicles, freeway and highway road and other lighting, signage lighting including but not limited to roadside and billboard lighting.

Embodiments of the present invention can have a wireless or wired device provide one or more and especially more than one 0 to 3 V and/or 0 to 10 V or other analog and/or digital signals including but not limited to simple and/or complex pulsing including simple to complex and sophisticated PWM as well as, in many cases, DC or, in some cases, AC. Such embodiments can control/monitor/log/store/analyze/perform analytics, etc. on more than just the lighting and can also be used to do different things including but not limited to heat, cool, light, protect, detect, etc. Such implementations can be used for more than lighting and include but are not limited to heating, cooling, HVAC, temperature, humidity, window coverings, entertainment, etc. as well as lighting including specialized lighting and general lighting.

Some embodiments of the present invention include implementations that can replace the ballast power with power supplies that effectively and essentially perform the same function as the ballast but are specifically designed to work with fluorescent lamp replacements (FLRs) and provide a constant AC or DC current to the FLRs. Such embodiments of the present invention can, for example, but not limited to, provide numerous additional functions, features, etc., including remote control, monitoring, logging, tracking, analytics, dimming, scheduling, etc. using, for example, but not limited to, wired, wireless, powerline control (PLC), etc. Such embodiments of the present invention can also have a maximum current level set and also a maximum voltage level set.

Some embodiments use a DC buss—for example, 24 V to supply all of the ballast (re-wire from AC line voltage (e.g., 120 VAC, 240 VAC, 277 VAC, 347 VAC) to DC) using, for example, a AC to DC power supply, an off-grid source such as, but not limited, to solar, geothermal, hydro, fuel cell, battery, etc., combinations of these, etc.

In some embodiments of the present invention, a wireless or wired or powerline interface may be added to a dimmable/controlled enabled FLR which can be hung, clipped, attached, etc. to the fixture, to the hanger (“hangar”). If higher than 24 V is needed, then a buck-boost, boost, boost-buck, flyback, forward converter, push-pull, SEPIC, Cuk, two-stage converter, inverter, etc. can be used. Such a system can use virtually any type of light source including solid state lighting to be powered off of fluorescent lamp fixtures using any type of power source including but not limited to ballasts and AC line voltage. Some embodiments of a hanger-based lighting system use a relatively low voltage out (e.g., 24 volts or less or so). Such a hanger-based lighting system allows modular, plug-in approach for lighting, supporting different plug in LEDs, lamps, etc. In some embodiments, the user can replace, mix and match, change, etc. light or power supply/driver or any type of accessories including but not limited to fans, microphones, speakers, sensors, sirens, horns, buzzers, strobes, detectors, cameras, IOT, etc.

Some embodiments of the invention make measurements of the external voltage and current to determine output power.

Some embodiments of the invention use daisy chain power drops. Some embodiments of the invention can detect shorts and are short circuited protected (SCP). Embodiments of the present invention can ensure that maximum power is not exceeded by measuring and determining the power being drawn.

The present invention supports/can use the low voltage hangar approach as well as AC to low voltage DC.

Some embodiments of the present invention can use powerline communications including but not limited to either AC or DC or both AC and DC power communications.

Some embodiments of the present invention can use the isolated dimming function with isolated voltage/power to safely power, for example, but not limited to, sensors including, but not limited to, motion, sound, voice, voice recognition, noise, proximity, sonar, radar, ultrasonic, daylight harvesting, solar, light, signal strength including wireless signal strength, etc., combinations of these, etc., in addition to others, etc.

Some embodiments of the invention can use one or more lighting fixtures of any type or form including ceiling, wall, desk, etc. to communicate, for example, but not limited to communicate sensor information regarding light intensity, sound, solar, photo, color, spectrum, motion, sound, voice, voice recognition, noise, proximity, sonar, radar, ultrasonic, daylight harvesting, solar, light, etc., combinations of these, etc., as well as other, etc. As an example, a desk lamp or other object, piece of equipment, computer, computer monitor, television, desk, wall, shelf, cabinet, etc.

In some embodiments of the invention, a desk lamp can be used to support, house, power, etc. one or more smart/intelligent sensors including, but not limited to, light intensity, sound, solar, photo, color, spectrum, motion, sound, voice, voice recognition, noise, proximity, sonar, radar, ultrasonic, daylight harvesting, solar, light, etc., combinations of these, etc., etc., etc. as well as others, etc., etc. that are incorporated into the desk lamp. For example, a desk lamp can have one or more photosensors that sense the light level and report, adjust, etc. the overhead lighting, including but not limited to the smart, dimmable FLRs. In some embodiments of the present invention, the photosensors and/or other types, methods, techniques, etc. of measuring light including ultraviolet, visible, infrared, etc. can use spectral sensitive sensors, filters, detectors, etc. to adjust control the present invention including sensing the outdoor lighting including natural (e.g. Sun-based) and artificial lighting as well as the indoor lighting using one or more sensors including, but not limited to, one or more of the same and/or one or more of different sensors that sense different regions of the spectrum including but not limited to different wavelengths, frequencies, intensities, narrow and/or broadband, etc., combinations of these, etc. and adjusting the present invention including but not limited to the lighting component to adjust one or more of the output channels accordingly including to desired spectral response of the present invention, based on spectral responses at other geographical locations, other time zones, for health considerations, circadian rhythm, etc. Light sensors ranging from a single wavelength to multiple wavelengths to narrow band to broadband can be used with or as part of the present invention including as ambient light sensors with spectral response designed to emulate the human (eye and other) response(s).

Some embodiments of the invention use one or more hangars to hang/support lighting, such as, but not limited to, those disclosed in PCT Patent Application PCT/US15/32763 filed May 27, 2015 for “Lighting Systems” and in U.S. patent application Ser. No. 15/586,216 filed May 3, 2017 for “Safety Lighting and Monitoring” which are incorporated herein by reference for all purposes. Some embodiments of the invention use bar codes (and bar code readers) or the squares that cell phones/tablets read, etc. to read in the ID/Address/Name/etc. of each smart/intelligent lamp, dimmer, light, etc. so as to assign each to its proper place.

Turning now to FIG. 76, a solid state fluorescent lamp replacement input stage is depicted which can receive power from a ballast output in accordance with some embodiments of the invention. Power from ballast outputs is AC coupled through optional capacitors 1182, 1184 to a rectifier 1180 to yield rectified power across nodes HV, LV. One or more capacitors 1186 can be connected across the ballast outputs which provide the input power to the input stage. The one or more capacitors 1186 (which can be a variable capacitor or capacitors or other impedances, etc. including but not limited to ones that use inductors, resistors, other passive and active components, etc.) or other elements can be used to lower the output voltage of the ballast and can be used for dimming purposes. In some embodiments, the input capacitor 1186 can comprise a variable capacitor such as that depicted in FIG. 55 or one or more of fixed/static capacitors and one or more variable capacitors which can be realized/achieved by any method, approach, topology, etc. Other elements can be included as desired, such as, but not limited to, inductors, fuses, EMI filters, etc., combinations of these, etc. The one or more variable capacitors or variable impedance can be used to set the output level.

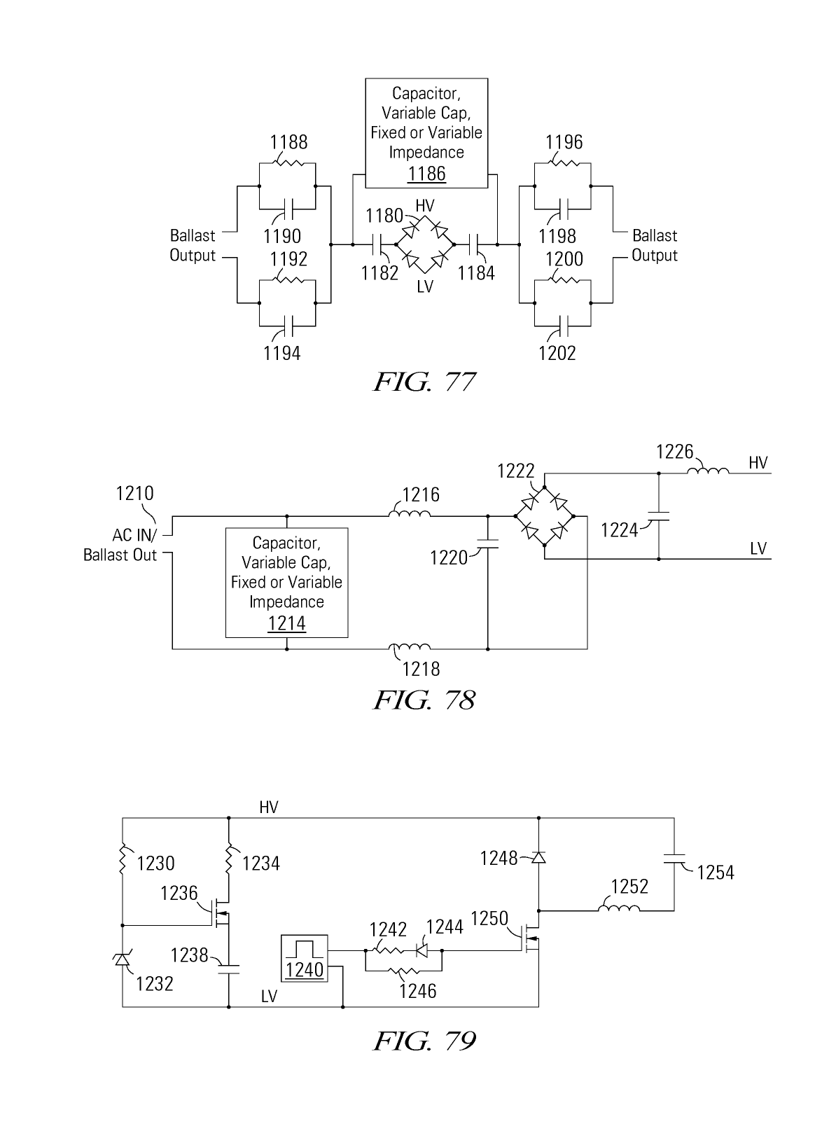

Turning now to FIG. 77. a solid state fluorescent lamp replacement input stage with heater emulation circuits is depicted which can receive power from a ballast output in accordance with some embodiments of the invention. Power is received from a ballast output, for example through bi-pins at each end of a linear FLR connected to tombstones in a fluorescent lamp fixture. Heater emulation circuits such as the parallel combinations of resistors 1188, 1192, 1196, 1200 and capacitors 1190, 1194, 1198, 1202 or other configurations and combinations of elements are included in various embodiments to enable the ballast to operate properly. Power from ballast outputs through the heater emulation circuits is AC coupled through optional capacitors 1182, 1184 to a rectifier 1180 to yield rectified power across nodes HV, LV. An input capacitor or capacitors, fixed or variable, or other impedances or combinations, etc. 1186 can be connected across the ballast outputs which provide the input power to the input stage. In some embodiments, the input capacitor 1186 can comprise a variable capacitor such as that depicted in FIG. 55 and discussed above which could comprise any number of fixed/constant and variable capacitors. Other elements can be included as desired, such as, but not limited to, inductors, fuses, EMI filters, etc.

Turning now to FIG. 78, a solid state fluorescent lamp replacement input stage with EMI filtering is depicted which can receive power from a ballast output or AC input 1210 in accordance with some embodiments of the invention. EMI filtering and output power control can be provided by capacitors 1214, 1220 (which can be fixed or variable value, and which can each comprise one or more capacitors and/or other impedances connected in parallel and/or series, etc.) and inductors 1216, 1218. Although the inductors are shown as being in series, the inductors including in the form of a choke can be also put in parallel depending on the implementation and especially so if the case where the AC input is from an electronic ballast output. The AC signal is rectified in diode bridge 1222, with output filtering provided by capacitor 1224 and inductor 1226.

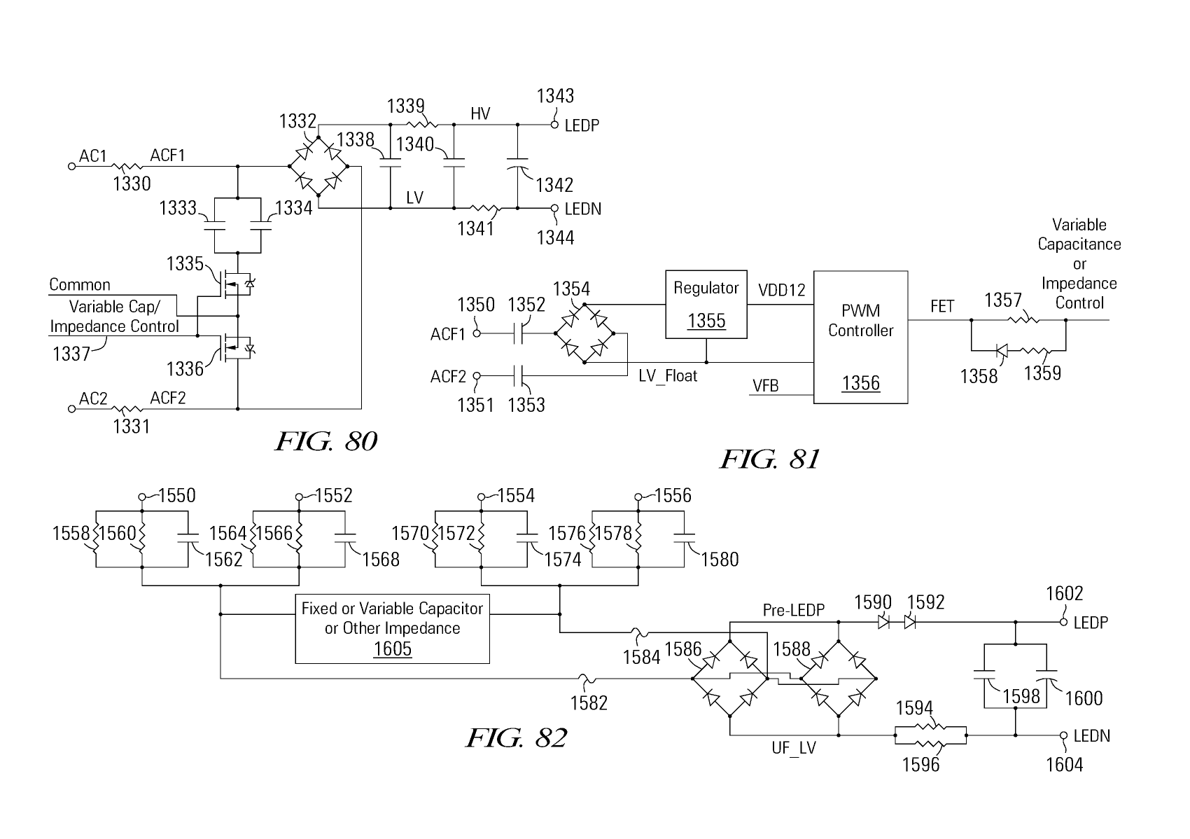

Turning now to FIG. 79, a power supply circuit with output control is depicted that can be used in some embodiments of a solid state fluorescent replacement lighting system in accordance with some embodiments of the invention. A reference voltage as well as a voltage supply is generated by Zener diode 1232 and resistor 1230 from a rectified power signal HV, controlling switch 1236 to apply power to, for example, power the pulse generator 1240. In some embodiments, the output of pulse generator 1240 is conditioned by an optional gate EMI circuit including, for example, resistors 1242, 1246 and diode 1244. In some embodiments, resistor 1234 may consist or more than one resistor in series, parallel, combinations of series and parallel, etc. In some embodiments, resistor 1230 may consist or more than one resistor in series, parallel, combinations of series and parallel, etc. In some embodiments, resistor 1234 and transistor 1236 may be optional; in such embodiments, Zener diode 1232 may be connected to capacitor 1236. The switch 1236 can be operated to control a power converter such as, but not limited to, a buck converter comprising diode 1248, inductor 1252 and output capacitor 1254 to power a load in parallel with output capacitor 1254.

Note that in FIGS. 76-79, the AC lines can be tied to one set (side) of bi-pins for a linear fluorescent tube replacement (i.e., a FLR for T8s or T12s, etc.) which would be in parallel with, for example, one side for an instant start ballast and one set of heater emulation for a rapid start, programmed start, dimmable, and or prestart or, for example, magnetic ballast, respectively. Such implementations may be preferred for certain applications and agency approvals and listings. In other embodiments, the AC line can be connected so that one leg of the AC line is across each side of the linear tube replacement.

Turning to FIG. 80, a solid state fluorescent lamp replacement input stage with variable capacitance circuit is depicted in accordance with some embodiments of the invention. Such a variable capacitance circuit can connect capacitors (e.g., 1333, 1334) with, for example but not limited to, varying on time duty cycles to control and dim using conventional electronic ballasts. In the illustrative example embodiment of FIG. 55, an AC switch (e.g., transistors 1335, 1336) is/are used to adjust the on and off times of capacitors 1333, 1334. Note although two capacitors are shown, any number of capacitors from 1 to a practically large number can be used. In addition, one or more non-switched (i.e., static/fixed) capacitors in either series or parallel or combinations of these, etc. can be used with the variable capacitor or capacitors in some embodiments of the present invention. In other embodiments other components such as inductors and resistors can be used including in any configuration including but not limited to series, parallel, and/or other configurations, etc. can be used. In some embodiments one or more inductors maybe used in place of the one or more capacitors or both capacitors and inductors may be used. Power is received at AC input from a ballast output, AC mains or line, or any other suitable power source. A diode bridge 1332 or other rectifier can be used to rectify the input power, and can include any type or number of diodes, including multiple diodes in each leg of the bridge to provide the desired power handling capacity. Floating transistors 1335, 1336 surround a floating ground or common that can be used as a reference at various points of the system. Example signal conditioning components and/or EMI components can be included as desired, such as, but not limited to, capacitors 1338, 1340, 1342 and resistor 1339, as well as sensing components such as current sensing resistor(s) (e.g., 1341) that can be used, for example, to sense the current through output nodes 1343, 1344. Fuses (e.g., 1330, 1331) can also be included as desired. Signals other than pulse, PWM, on/off may also be used in some embodiments of the present invention.

Notably, capacitors or impedances 1333, 1334 can be a single capacitor, one or more capacitors, a single inductor, one or more inductors, other passive and/or active elements, etc., combinations of these, etc.

Implementations of the present invention can also use combinations of example embodiments of the present invention—for example, a buck (or buck-boost, boost-buck, boost, fly back, forward converter, push-pull, etc.) can be combined with a the ballast current control and other example embodiments shown herein to achieve implementations that can be used with universal AC line voltage up from below 80 VAC to greater than 305 VAC and even 347 VAC and 480 VAC 50/60 Hz (and also 400 Hz) as well as magnetic ballasts and electronic ballasts, including but not limited to, instant start, rapid start, programmed start, programmable start, dimming ballasts, pre-start, etc. FIG. 55 shows an example of such a combined circuit that, in certain implementations, can also be locally or remotely controlled and dimmable. In FIG. 80, a buck circuit is used for low frequency operation (i.e., 50/60 or 400 Hz) and magnetic ballasts and the current control is used for electronic ballasts. The buck (or related switching circuit) can be used to control the current and/or voltage to the LED, OLED or QD load and by adjusting, for example, but not limited to the duty cycle of the buck or related switching circuit/topology (i.e., for example, the switching element, the output to the load could be dimmed or increased. The example embodiment shown in FIG. 80 consisting of a switching element and associated sense and measure circuitry to shunt current as needed or desired including for dimming while switching element could be either fully turned on or, depending on the implementation, fully turned off. The drain of the transistor or transistors can be attached to a point in front of a diode that can be used to block the shunting from directly affecting and shorting/shunting the output capacitor and load as discussed elsewhere in this document. Of course in some embodiments and implementations of the present invention, a buck (or buck-boost, boost-buck, boost, fly back, forward converter, push-pull, etc.) can be used for all types of magnetic and electronic ballasts as well as AC line voltage ranging from less than 80 VAC to greater than 480 VAC if desired. As discussed herein, other elements including but not limited to, EMI filters (consisting of, for example but not limited to, chokes, inductors, toroid inductors and chokes, two and four legged inductors, transformers, capacitors, diodes, resistors, other elements, etc.), OVP, OTP, SCP, OCP, shock hazard/pin safety, dimming, remote control and monitoring, color changing, color switching, etc. can be included into these and other implementations of the present invention. Embodiments of present invention are not restricted to the buck and can also be buck-boost, boost-buck, boost, fly back, forward converter, push-pull, etc. and include a shunt combination. Items such as snubbers and clamps, rectification bridges, gate networks (e.g., resistors and diodes, etc.), other components and connections, etc. have been left off as well as some of the details and connections for the control circuit labeled IC. The control circuit can use information, for example, including but not limited to about frequency and voltages to determine whether a low frequency ballast or AC line voltage or a high frequency ballast to determine the appropriate signals to apply to switches. In some embodiments and implementations of the combined buck (etc.) and shunt approach, a microcontroller or microcontrollers and/or DSP(s), FPGA(s), microprocessors, etc. can be used in place of or to, for example, augment and support the microcontroller(s), etc. A tagalong inductor (for which there could be one or more) such as those disclosed in U.S. patent application Ser. No. 13/674,072, filed Nov. 11, 2012 by Sadwick et al. for a “Dimmable LED Driver with Multiple Power Sources” can be used with embodiments of the present invention. It should be understood that one or more tagalong inductors could be incorporated into the example embodiment discussed and shown herein can contain tagalong inductors. It should be also understood that there many numerous variations of the example embodiments shown and discussed herein and nothing should not be construed or taken as limiting in any way or form.

Turning to FIG. 81, a PWM or one-shot controller is depicted that can be used to control the AC switch 1335, 1336 of FIG. 80 to regulate or turn off the output current and/or power. Optional capacitors 1352, 1353 can be used to couple to the AC input 1350, 1351, for example for use with instant start and also rapid start ballasts. Optional capacitors 1352, 1353 can be augmented or replaced with other passive, active, etc. components, combinations of these, etc. In some embodiments, capacitors 1352, 1353 can be omitted or shorted out, for example, with instant start/rapid start/programmed start/etc. electronic ballasts and magnetic ballasts. In other embodiments, for example, but not limited to, resistors and/or inductors can be put in series or parallel or both or combinations of series and parallel, etc. with the capacitors or one or more of the capacitors can be removed, etc. A rectifier 1354 and regulator 1355 provide regulated power to PWM controller 1356, which provides a pulse or ramp signal based on or controlled in part by a feedback voltage VFB. The rectifier 1354, as with other rectifiers disclosed herein, can include one or more diodes per leg in series or parallel or both, etc. The regulator 1355 can comprise a linear regulator, switching or combo regulator, etc. In some embodiments, resistor capacitor (RC), one or more resistor inductor (RL), resistor inductor capacitor (RLC), inductor capacitor (LC), etc. networks can be attached in series, parallel, combinations, etc. to each bi-pin output of the ballast to provide for heater/cathode simulation/emulation/etc. circuits. The PWM controller output is used to control transistors 1333, 1336 to vary the duty cycle of the input power, connected through buffer diode 1358 and resistors 1357, 1359. Resistors 1357, 1359 and diode 1358 are optional in some embodiments. The Variable Cap Control signal can also be generated by variable impedance, various combinations of inductors, capacitors, resistors, other passive and/or active components, etc.

Turning to FIG. 82, a circuit schematic of an example embodiment of a solid state fluorescent lamp replacement is depicted where, among other things, shunting is used to set the solid state light output that can be remote controlled and monitored in accordance with some embodiments of the invention. Inputs 1550, 1552, 1554, 1556 represent the two (one on each side for a linear FL and both on the same side for, for example, a four pin PLC lamp) sets of bi-pins for, for example, a ballast and tombstone fluorescent lamp connection system/network. Input coupling components such as resistors 1558, 1560, 1564, 1566, 1570, 1572, 1576, 1578 and capacitors 1562, 1568, 1574, 1580 can be included as desired or needed to ensure proper operation of ballasts, for example to provide heater emulation. Fuses (e.g., 1582, 1584) can be included. One or more rectifiers 1586, 1588 can be included, as well as signal conditioning components and/or EMI components can be included as desired, such as, but not limited to, diodes 1590, 1592, capacitors 1598, 1600, as well as sensing components such as current sensing resistor(s) (e.g., 1594, 1596) that can be used, for example, to sense the current through output nodes 1602, 1604. Other components discussed herein may also be incorporated into FIG. 58 as appropriate.

A fixed or variable capacitance and/or fixed or variable impedance, etc., 1605 can be included to control input current, for example but not limited to by shunting or shorting across the ballast output to control the amount of current provided to the load.

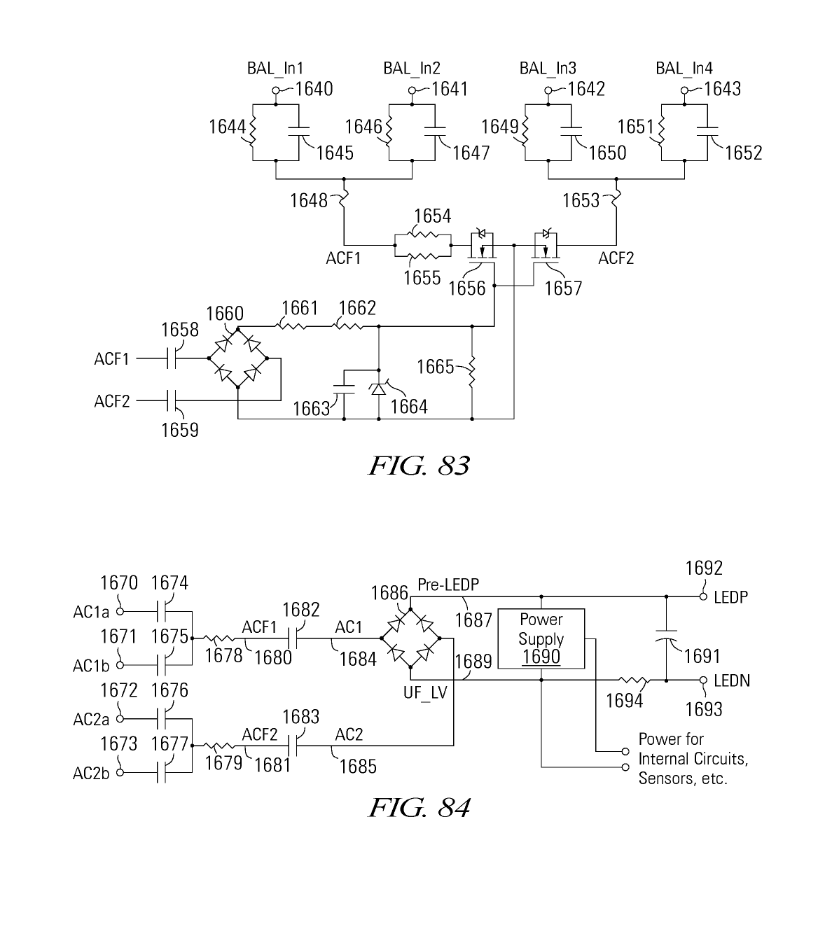

Turning to FIG. 83, a ballast sequencing circuit with variable impedance circuit is depicted in accordance with some embodiments of the invention. Power is received from, for example, ballast outputs 1640, 1641, 1642, 1643, for example through bi-pins at each end of a linear FLR connected to tombstones in a fluorescent lamp fixture. Heater emulation circuits such as the parallel combinations of resistors 1644, 1646, 1649, 1651 and capacitors 1645, 1647, 1650, 1652 or other configurations and combinations of elements are included in various embodiments to enable the ballast to operate properly. Optional fuses 1648, 1653 can be included to provide protection. Power from ballast outputs through the heater emulation circuits is AC coupled through capacitors 1182, 1184 to a rectifier 1180 to yield rectified power across nodes HV, LV. AC switch 1656, 1657 can be momentarily closed, connecting resistors and/or variable impedances 1654, 1655 to the ballast, in some cases providing a DC path between the ballast legs and enabling certain ballasts to operate properly. Power can be drawn from the fused AC nodes ACF1, ACF2 through AC coupling capacitors 1658, 1659 through diode bridge 1660. The rectified voltage can be further conditioned by resistors 1661, 1662, capacitor 1663, Zener diode 1664 and resistor 1665 to control the AC switch 1656, 1657 to momentarily close it at startup or at other times. Other elements can be included as desired, such as, but not limited to, inductors, fuses, EMI filters, etc., combinations of these, etc.

Resistors and/or variable impedances 1654 and 1655 can be replaced or augmented with capacitors, inductors, other passive and/or active components, etc., combinations of these, etc. Capacitors 1658 and 1659 are optional and can be shorted out or replaced with other passive and/or active components. One or more fixed and/or variable capacitors can be connected across AC nodes ACF1, ACF2 or across the nodes between capacitors 1658 and 1659 and diode bridge 1660 or their equivalents.

Turning to FIG. 84, a solid state lighting power supply is depicted that can draw power from a fluorescent lamp fixture to power a lighting system and to provide power for internal circuits, sensors or other applications in accordance with some embodiments of the invention. The power supply includes inputs 1670, 1671, 1672, 1673 for, for example, two pairs of bi-pin connections to a ballast via tombstones in a fluorescent lamp fixture. The power supply can include, for example, but not limited to one or more linear circuits, zero linear circuits, one or more switching circuits of virtually any topology including but not limited to non-isolated or isolated, combinations of these, etc. For example, but not limited to a non-isolated switching/storage circuit/power supply would be a buck (or boost, or boost-buck or buck-boost or others discussed herein) switching circuit that can be used with both a ballast or AC line which can also be optionally remote controlled and have features including OTP, OVP, SCP, dither, etc. and can be used with all types of ballasts including electronic rapid start, instant start, programmed start, preheat, magnetic, etc. that can be remote controlled and monitored and also has remote control/dimming Examples of isolated circuits include but are not limited to one or more of galvanic isolated circuits, flyback isolated circuits, forward converter isolated circuits, push-pull circuits, etc., combinations of these, etc. Input coupling capacitors 1674, 1675, 1676, 1677 and resistors/fuses 1678, 1679 as well as any other heating emulation approaches can be included along with, if desired, any other heater emulation or other input conditioning elements in any configuration. For example, one or more resistors can be connected in parallel with each of the input coupling capacitors 1674, 1675, 1676, 1677. One or more rectifiers 1686 can be included, as well as signal conditioning components and/or EMI components which can be included as desired, such as, but not limited to, output capacitor 1691, as well as sensing components such as current sensing resistor(s) (e.g., 1694) which can be used, for example, to sense the current through the output nodes LEDP 1692, LEDN 1693 which supply current to a solid state lighting load. An internal power supply 1690 of any topology can be used to draw power either from the ballast (if installed) or AC line to power internal circuits, sensors, etc. In some embodiments, the internal power supply 1690 can be used to generate power for internal circuits, sensors, etc. as well as external circuits, sensors, IOT, controls, communications, detectors, sirens, cameras, arrays, pattern, voice, sound, facial, etc. sensors, detectors, etc., combinations of these including but not limited to those discussed herein without impacting the constant current to the lighting output nodes LEDP 1692, LEDN 1693. In other embodiments of the present invention the current/power to the lamp may not be controlled and will depend on the ballast and the applications and uses of the present invention. In some embodiments of the present invention, the light output may not be directly controlled or regulated however the one or power supply 1690 with one or more isolated or non-isolated outputs may be used to provide internal and/or external power to sensors, IOT, controls, communications, etc., combinations of these, etc. including but not limited to those discussed herein using/with one or more of a fluorescent lamp ballast, a HID ballast of any type or lamp type, etc. including but not limited to electronic and magnetic ballasts for use with any type of gas discharge device including but not limited to any type of fluorescent, HID, Neon, etc. lamp ballast.

Some of the components including 1670 through 1683 can be replaced, for example, with a short if in series or an open if in parallel or other components, augmented with other passive and/or active components including thermal, voltage protective elements, components, etc. One or more fixed or variable capacitors, inductors, resistors, other passive and/or active components, etc. can be inserted/placed across nodes ACF1 and ACF2 or on the other side of, for example, but not limited to, fixed or variable capacitors or impedances 1682 and 1683 or AC1 (1684) and AC2 (1685) or equivalent locations, placements, etc.

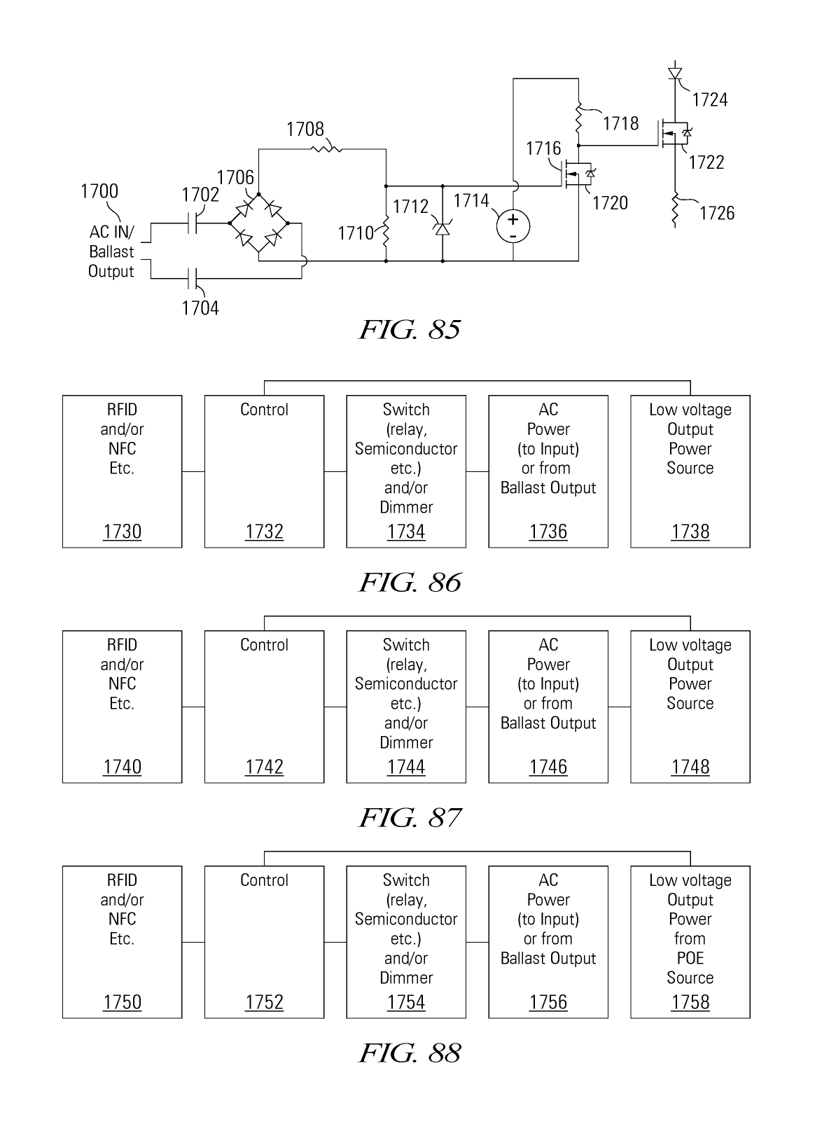

Turning to FIG. 85, a ballast detection circuit is depicted that can be used, for example, to gate other circuits such as to gate diode 1434 and/or diode 1444 in the feedback control circuit of FIG. 57 to detect and/or enable or disable power from a ballast output in accordance with some embodiments of the invention. A diode bridge 1706 rectifies power from an AC input or ballast output 1700, optionally connected through fixed or variable AC coupling capacitors or impedances 1702, 1704, and a reference voltage is generated from the rectified power by Zener diode 1712 and voltage divider resistors 1708, 1710. The reference voltage controls a transistor 1716, which generates a control signal from any suitable source, such as a pullup resistor 1718 and any voltage supply (e.g., 1714) or reference voltage. The resulting control signal can be used to control a switch 1722, shunting current to gate off control signals or any other control points. For example, in some embodiments, the diode 1724 corresponds with either diode 1434 or 1444 of FIG. 57, shunting the output of either of those diodes 1434 or 1444 to a ground through resistor 1726 to disable power from a ballast output.

The diode bridge 1706 can be replaced in some embodiments with a half wave bridge or other such circuits including circuits that perform/provide rectification or circuits that pass AC and use the AC, including but not limited to the frequency of the AC, to determine whether a ballast is present or not, etc., and which provide a DC voltage which may be limited by Zener diode 1712 to the gate of transistor 1720 which in turns off transistor 1722 and thus, for example, but not limited to turning off and blocking the electrical path through diode 1724 as shown in FIG. 63. The gate signal at transistor 1720 can be used and fed to other devices and circuits to turn on enable when a ballast such as, but not limited to, a high frequency ballast is used to power embodiments and implementations of the present invention.

Capacitors 1702 and/or 1704 can be bypassed, augmented, replaced etc. with other passive and/or active components, etc. One or more fixed or variable capacitors, inductors, resistors, other passive and/or active components, etc. can be inserted/placed across the input 1700.

In some embodiments of the present invention, one or more time constants may be used to provide feedback and control. In some implementations of the present invention it may be useful to turnoff or turn on one or more time constants or other feedback or control circuits when in the ballast powered mode of operation compared to the AC mode of operation. For such cases, a circuit such as that depicted in FIG. 85 may be used. The circuit depicted in FIG. 85 should not be taken to be limiting in any way or form.

Turning to FIGS. 86-88, block diagrams of identification circuits are depicted that can be used to identify solid state fluorescent lamp replacements in a solid state lighting system, powered by one or more of multiple sources in accordance with some embodiments of the invention. Some embodiments of the invention include Identification Switches 1730, 1740, 1750 with, for example but not limited to, RFID and/or NFC. Could have mechanical to electrical switch and/or gesturing, etc. that could, for example, but not limited to ZigBee to RFID, BTLE to RFID, etc. Control circuits 1732, 1742, 1752 interface with the FLRs, powered by any source, including but not limited to, power from the AC line or ballast output 1736, 1746, 1756, power from one or more batteries, one or more solar cells of any type or form including to, but not limited to, inorganic, semiconductor, organic, quantum dot, etc., battery charger, vibration energy converter, RF converter, energy harvester of any type and source, etc., power of Ethernet, DC power sources, AC to DC conversion, etc., combinations of these, etc. The switch or actuator can be of any type including toggle, momentary, mechanical to electrical switch and/or gesturing, touch, capacitive sensing, etc. that could, for example, but not limited to also use ZigBee to RFID, BTLE to RFID, etc. WiFi to RFID, any other wireless and/or wired standards, protocols, etc. including but not limited to those mentioned herein, vice-versa, etc., two-way communications, etc. Embodiments of the present invention can also be powered by low voltage output power sources (e.g., 1738, 1748) including with power over Ethernet (POE) (e.g., 1758). Power switching and/or dimming 1734, 1744, 1754 can be of any known type including but not limited to electromechanical, reed, latching, other electrical and/or mechanical, solid state, etc., relay(s), triac, silicon controlled rectifier (SCR), transistor, etc., more than one of one, more than one of each, combinations of one, combinations of each, other combinations, etc.

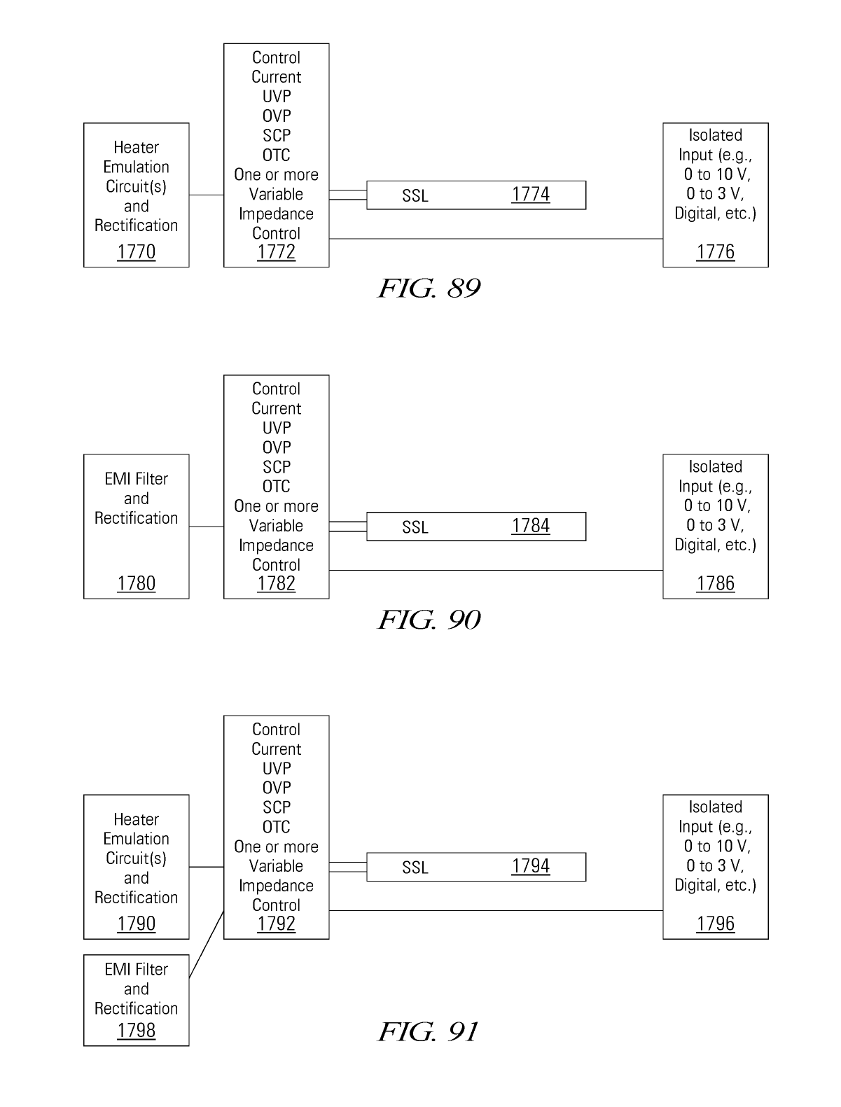

Turning to FIGS. 89-91, block diagrams of example embodiments of solid state lighting systems with isolated control inputs are depicted in accordance with some embodiments of the invention. The SSL systems can be powered by any suitable source(s), such as, but not limited to, a ballast output via heater emulation and rectification circuits(s) 1770, 1790 and/or AC inputs via EMI filter and rectification circuits(s) 1780, 1798. Power supply circuits 1772, 1782, 1792 can pass power through to solid state lights 1774, 1784, 1794 and can provide one or more of the functions disclosed herein, such as, but not limited to, current control, undervoltage protection (UVP), overvoltage protection (OVP), short circuit protection (SCP), over-temperature protection (OTP), variable impedance control, etc. Dimming control signals, either or both wired and wireless, can be used to control the power supply circuits, including, for example, using isolated dimming inputs (e.g., 0 to 10 V, 0 to 3 V, digital, including wired and wireless including but not limited to those mentioned, discussed, listed, etc. herein, combinations of these, etc.) Other embodiments of the present invention can also monitor, log, store, access the web, the cloud, communicate with the Ethernet, mobile cellular carriers, etc., combinations of these, etc.

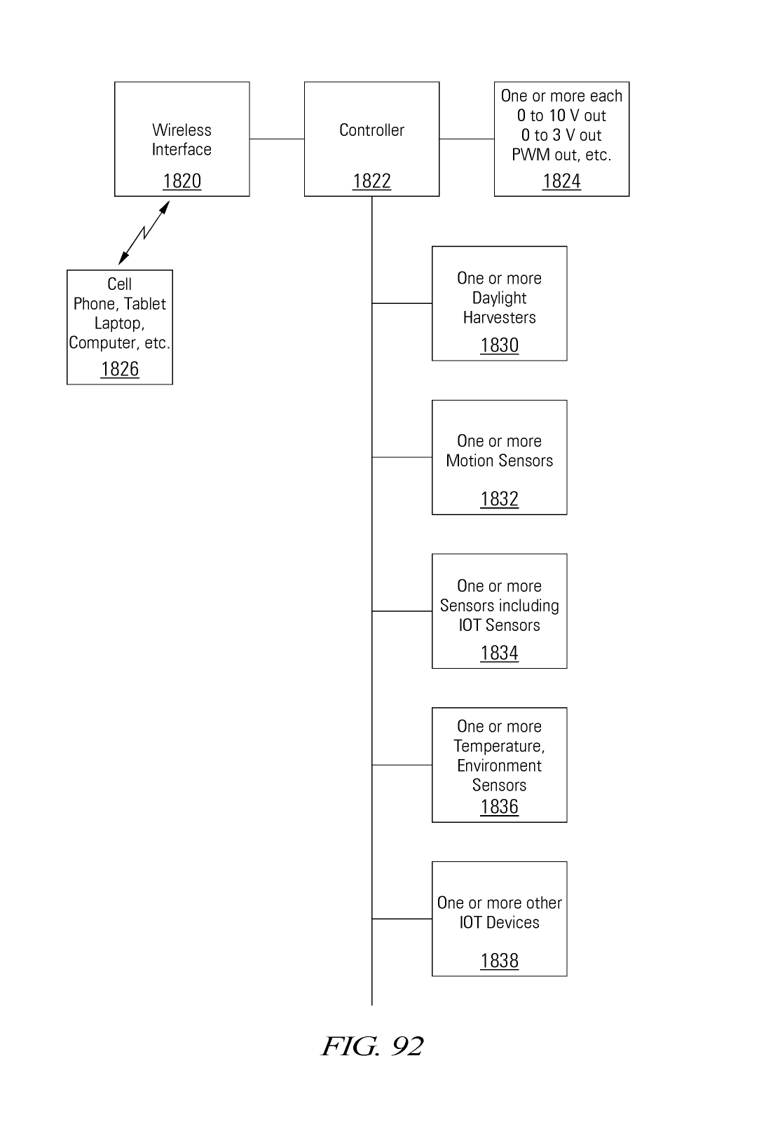

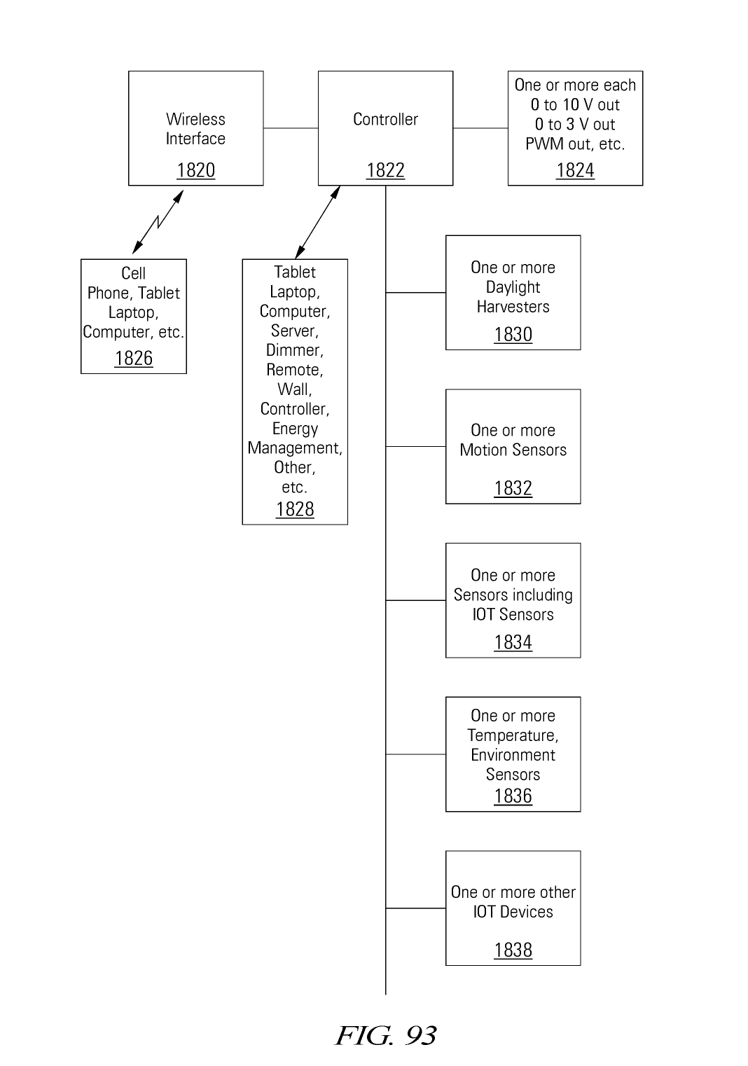

Turning to FIGS. 92-93, a lighting control system with wired and/or wireless communications is depicted in accordance with some embodiments of the invention. A controller 1822 communicates with a remote device such as, but not limited to, a cell phone, tablet, laptop, computer, etc. 1826 through a wireless interface 1820. The controller 1822 can also communicate with a tablet, laptop, computer, server, dimmer, remote, wall, controller, energy management, other, etc. 1828 through a wired and/or wireless interface. The controller 1822 can generate one or more control signals to control one or more channels, colors, etc. in a lighting system, for example but not limited to using a DC signal (e.g., 0 to 10V DC, 0 to 3V DC), PWM out, or any other signal type. The controller 1822 can receive one or more inputs used to generate the control signals, such as, but not limited to, one or more daylight harvesters 1830, one or more motion sensors 1832, one or more sensors including IOT sensors, one or more temperature, environment sensors 1836, one or more other IOT devices 1838, etc.

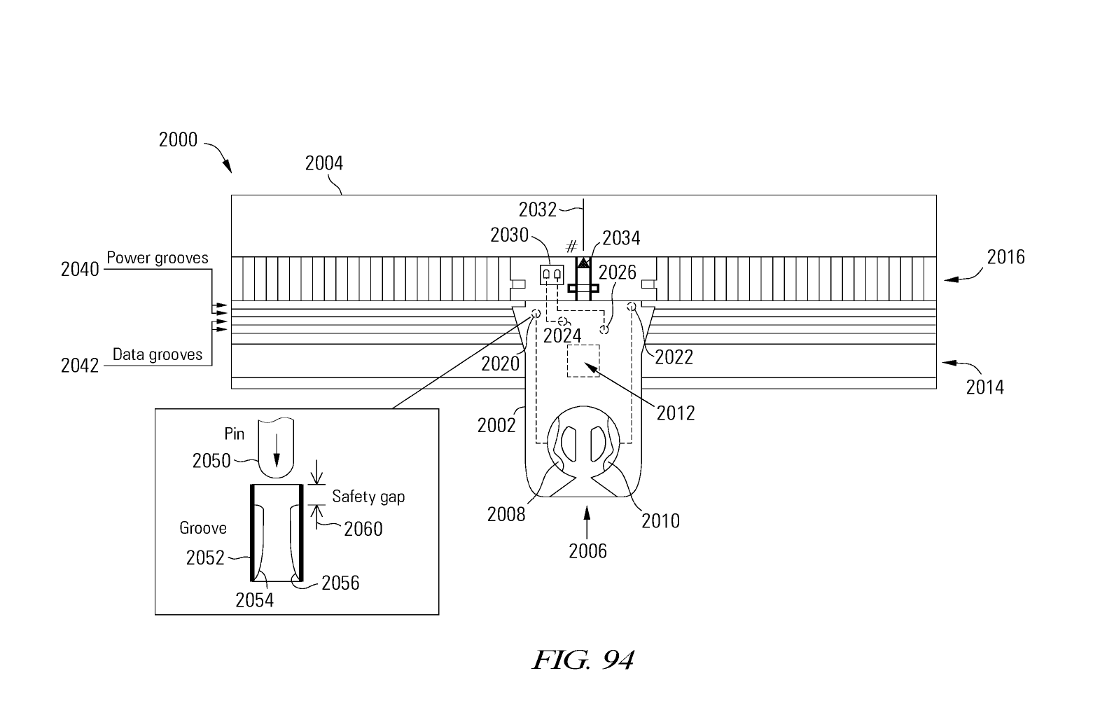

Turning to FIG. 94, an in-socket solid state lighting-compatible flexible fixture 2000 is depicted that allows for analog and/or digital control/interface pins/connections that allows for safe electrical, mechanical and other connections and installation in accordance with some embodiments of the invention. The fixture 2000 includes a backplane 2004 in which one or more fluorescent lamp style tombstone connectors (e.g., 2002) or other connectors can be mounted. Solid state fluorescent lamp replacements (SSFLRs) can then be mounted in each pair of tombstone connectors (e.g., 2002) to be powered, and, in some cases, receive commands such as dimming commands, to transmit sensor information, transmit status messages, etc. In some embodiments, the backplane 2004 supports both power and data connections to each tombstone connector (e.g., 2002), and each tombstone connector (e.g., 2002) is independently addressable.

The tombstone connector (e.g., 2002) can have a conventional or other method of accepting a pin or pins from a solid state FLR (SSFLR), such as the bi-pins of a conventional fluorescent tube. For example, the tombstone connector (e.g., 2002) can include a channel 2006 through which bi-pins on a SSFLR can be inserted, after which the SSFLR can be rotated about 90 degrees to bring each of the bi-pins on an end of the SSFLR into contact with one of the two electrical contacts 2008, 2010. However, the in-socket solid state lighting-compatible flexible fixture 2000 is not limited to this particular arrangement.

The tombstone connector (e.g., 2002) can also be mounted to the backplane 2004 in any suitable manner, for example, with a clip 2012 that is engaged in a groove 2014, so that the clip 2012 holds the tombstone connector (e.g., 2002) against the backplane 2004. In some cases, the tombstone connector (e.g., 2002) snaps into particular locations. In some other cases, the tombstone connector (e.g., 2002) can be slid along the groove 2014. The backplane 2004 can include a grooved backing 2016 that helps hold the tombstone connector (e.g., 2002) in a desired position along the groove 2014.

In some cases, the tombstone connector (e.g., 2002) includes both power pins 2020, 2022 and data pins 2024, 2026 that engage with power grooves 2040 and data grooves 2042, respectively, each of which contain electrically conductive traces for connecting the tombstone connector (e.g., 2002) with power and control circuits via the backplane 2004. An exploded view illustrates a pin 2050, which can correspond with any of the power pins 2020, 2022 or data pins 2024, 2026, and which can be inserted in a groove 2052 to be electrically connected with contacts 2054, 2056. In some cases, the contacts 2054, 2056 are commonly connected to conduct a particular power or data signal. A safety gap 2060 can be included so that power is not applied to the pin 2050 until it is inserted far enough into the groove 2052 that the pin 2050 cannot be touched by a finger, thereby preventing electrical shock.

Power and, optionally, data signals, can be connected to the SSFLR from the tombstone connector (e.g., 2002) in any suitable manner, such as, but not limited to, by contacts 2008, 2010 and, optionally, auxiliary connectors (e.g., 2030) which can accept wires to be connected between the tombstone connector (e.g., 2002) and the SSFLR, or by wireless connections, etc. For example, power and data signals can be combined in a powerline interface over contacts 2008, 2010 in some embodiments. Based upon the disclosure presented herein, one of skill in the art will recognize a number of connection systems that can be provided between the SSFLR and the tombstone connector (e.g., 2002), and the in-socket solid state lighting-compatible flexible fixture 2000 is not limited to any particular embodiment.

In some cases, the lateral placement of the tombstone connector (e.g., 2002) along the groove 2014 controls the address of the tombstone connector (e.g., 2002). In these cases, position markers or indicators 2032, 2034 can be provided on the tombstone connector (e.g., 2002) and backplane 2004 to facilitate positioning the tombstone connector (e.g., 2002) to select the desired address.

In some other cases, the data grooves 2042 can carry any suitable bus protocol that enables independent addressing and communication with multiple tombstone connectors/SSFLRs, such as, but not limited to, serial busses, PLC, RS232, RS422, RS485, SPI, I2C, universal serial bus (USB), Firewire 1394, DALI, DMX, etc. In some cases, tombstone connectors/SSFLRs are not independently addressable.

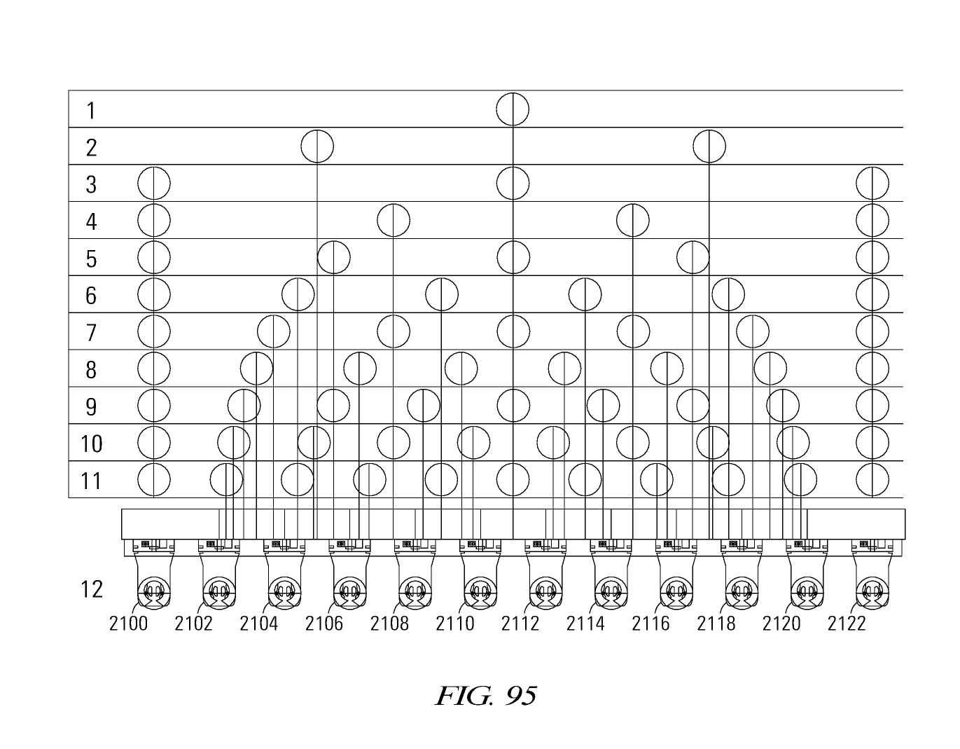

Turning to FIG. 95, a lighting fixture is depicted that allows a flexible number of lamps (e.g., 2100, 2102, 2104, 2106, 2108, 2110, 2112, 2114, 2116, 2118, 2120, 2122) from 1 to N (N=12 in FIG. 94). Such a complete system could include typically a controller and monitor and one or more (i.e., multiple) solid state lighting drivers and sensors including Internet of Things (IOT) sensors and other devices in accordance with some embodiments of the invention. FIG. 95 illustrates and depicts a non-limiting example of a flexible fixture that allows between one to 12 linear lamps of any type or form including reasonable diameter and length to be easily installed both at the factory and in the field. Embodiments of FIG. 95 can be implemented which allow even, symmetrical spacing between the 1 to 12 lamps no matter how many of the one or more (up to 12) lamps are installed. Even spacing of the 1 to 12 lamps provides even lighting and is also cosmetically attractive and acceptable.

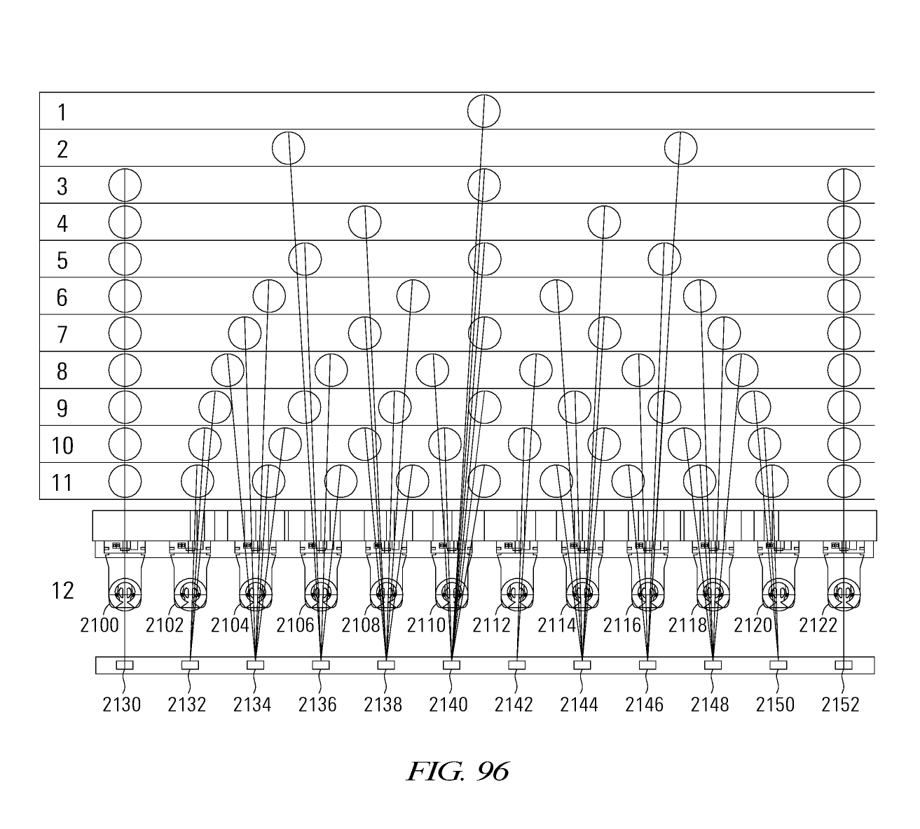

Turning to FIG. 96, another example solid state lighting-compatible flexible fixture is depicted including the arrangements of the lamps (e.g., 2100, 2102, 2104, 2106, 2108, 2110, 2112, 2114, 2116, 2118, 2120, 2122) and example connections in accordance with some embodiments of the invention. FIG. 96 illustrates and depicts a non-limiting example of a flexible fixture that allows between one to 12 linear lamps of any type or form including reasonable diameter and length to be easily installed both at the factory and in the field. Embodiments of FIG. 96 can be implemented which allow even, symmetrical spacing between the 1 to 12 lamps no matter how many of the one or more (up to 12) lamps are installed. Even spacing of the 1 to 12 lamps provides even lighting and is also cosmetically attractive and acceptable.

The numbers on the left side of FIG. 96 ranging from 1 to 12 correspond to the number of lights/lamps installed in the fixture of the present invention. The associated circles in the same row as the number from 1 to 12 (the number of circles add up to the same number as the ‘row’ number on the left) show the horizontal/lateral placement of the lamps from one lamp to 12 lamps. Note, for example, when there is only one lamp (the very top row), that one lamp is in the middle. If there are three lamps then there is a lamp at each end with one in the middle. If there are four lamps then there is a lamp at each end (left and right end, respectively) and two lamps in the middle equally spaced so that all four lamps are equally spaced from one another. Once there are 3 or more lamps, the lamps on the left most and right most positions, respectively are always present in that position. In some embodiments of the present invention, the lights can be configured to be non-symmetric an unevenly spaced if so desired.

The dimensions are shown for an assumed T8 linear tube. The dimensions would increase for example for a T10 or a T12 tube and would shrink, proportionally for, for example, a T5 tube.

The connector on the bottom is designed for making easy connections to the 12 lamps in the 12 different (row) configurations shown in FIGS. 95 and 96, providing connections 2130, 2102, 2134, 2136, 2138, 2140, 2142, 2144, 2146, 2148, 2150, 2152 for the lamps in evenly spaced locations.

Turning to FIG. 97, a solid state light mounted in an in-socket solid state lighting-compatible controller/dimmer is depicted with a holding bar 2200 in an open position, enabling tombstones to be attached and moved in accordance with some embodiments of the invention. The holding bar 2200 can be implemented in any suitable manner, such as, but not limited to, using hinges 2202, 2204.

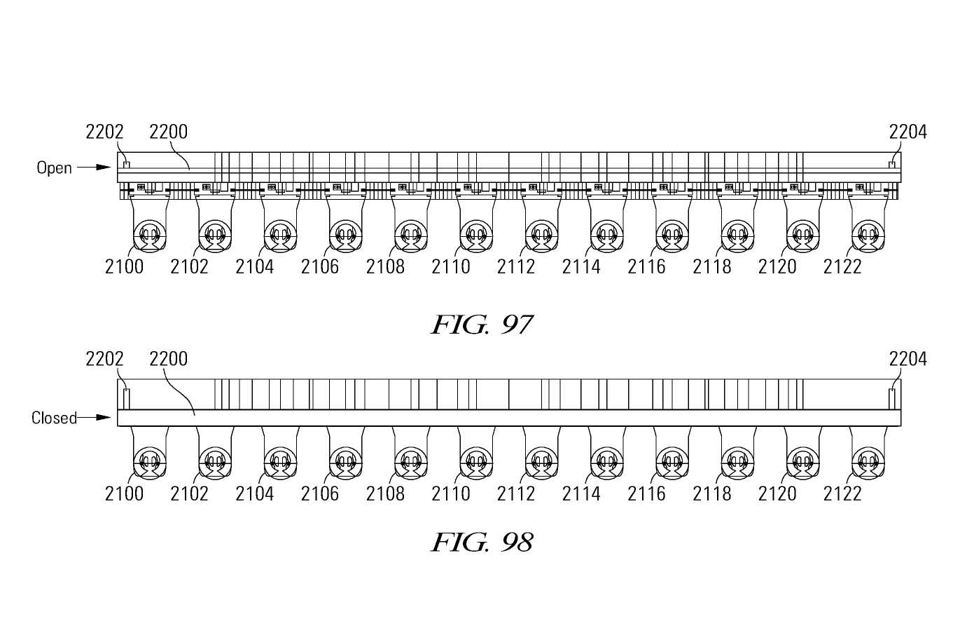

Turning to FIG. 98, a solid state light mounted in an in-socket solid state lighting-compatible controller/dimmer is depicted with a holding bar 2200 in a closed position, holding tombstones in place in accordance with some embodiments of the invention. The holding bar 2200 can be implemented in any suitable manner, such as, but not limited to, using hinges 2202, 2204.

Aspects of the present invention can be made to be transparent or nearly transparent and mounted on, embedded in, attached to, etc. windows to control, monitor and permit appropriate wavelength light transmission.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a fluorescent light replacement (FLR) where one side contains a solid state light (SSL) that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc. Some embodiments of the present invention can use multi-SSL packages, for example, multi-LED packages that have more than one LED on a package; as an example, a multi-LED package that contains one or more white color temperatures having different kelvin ratings, an amber LED and a blue LED. Such a package can provide different white combinations along with enhanced blue wavelength content to support wake up for circadian rhythm support as well as amber color to support falling asleep and sleep and also for short wake-up periods to get up to, for example, go to the bathroom and then go back to sleep. In addition to the multi-white color with blue and amber, other colors can be included or substituted including, but not limited to yellow, green, red, orange, other whites, additional whites, purple, yellow-orange, etc., combinations of these, more than one of these, etc.

The present invention can work with all types of communications devices including portable communications devices worn by individuals, walkie-talkie, handie-talkie types of devices, etc.

The present device can use combinations of wireless and wired interfaces to control and monitor; for example for a linear or other fluorescent replacement for, for example, but not limited to, T4, T5, T6, T8, T9, T10, T12, PL 4 pin and 2 pin etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters may transfer, transmit, or receive, etc. information, data, commands from other wireless equipped fluorescent lamp replacements, etc. of combinations of these. Wireless options include but are not limited to RF, microwave, optical including infrared transmission and receiving using modulated/demodulated signals including but not limited to approximately 30 to 42 kHz signals, etc. for the master/slaves.

The present invention can also have one or more thermometers, thermostats, temperature controllers, temperature monitors, thermal imagers, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc. as well as web-based, WiFi-based, Bluetooth, ZigBee, ZWave, etc. of any type, form, implementation, protocol, etc.

In some embodiments of the present invention, the thermometer(s) and/or thermostats may be remotely located. In other embodiments of the present invention, such a temperature sensor or sensors or thermostat or thermostats, thermal imagers, pyrometers, etc. can use wireless or wired units, interfaces, protocols, devices, circuits, systems, etc.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, gyrometers, goniometers, etc., including by reflecting an optical signal from a surface for example, but not limited to, using a mirror to reflect an optical signal when the door is vertical and such that the optical signal does not reflect back from the door in a vertical state/position, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included or used in the present invention to track the location and, for example, to also make decisions as to where and when the present invention should do certain things including but not limited to turning on or off, dimming, etc. Such GPS systems can also make use of cellular phone capabilities as well as other wireless devices using for example signal strength and/or triangulation, etc.

Some embodiments of the system can include thermal imagers including but not limited to IR imagers, IR imaging arrays, non-contact temperature measurements including point temperature and array temperature measurements. These and other sensors are powered in some embodiments by power supplies/drivers/controllers in the lighting system. For example, these and other sensors can be powered and controlled by circuits in a fluorescent replacement lighting system, deriving power through the ballast in a fluorescent fixture or directly from an AC line through the fluorescent fixture if the ballast has been removed. Such sensors can be used to identify normal ambient conditions as well as emergency conditions, and can be used to control lighting and other systems as well as to initiate reports via web, Internet, email, text, telephone, etc., or to trigger alarms such as sirens, flashing lights of one or more colors, etc. For example, an IR imaging array in a lighting system can detect cold spots in a room such as an open window or door that should be closed to save energy when outside temperature falls, or to detect hot spots such as a fire or overheating or faulty electrical outlet.

Embodiments of the present invention allow for dimming with both ballasts and AC line voltage, as will be discussed in more detail below. Embodiments of the present invention can use parameters such as current or light intensity to set level of the present invention. For example, internal or external sensors including but not limited to one or more of embedded sensors, arrays of sensors, etc. including but not limited to ambient light sensors, optical sensors, broadband optical sensors, photocells, photo sensors, spectral sensors, visible wavelength sensors, ultraviolet sensors, infrared sensors, narrow band sensors, color sensors, color temperature sensors can be used, for example but not limited to, to set the upper limit (max output and/or high end trimmed value output) of the output of the present invention in terms of light from the SSL including but not limited to LEDs, OLEDs, QDs, etc., combinations of these, arrays of these, one or more of these, one or more arrays of these, arrays of one or more of these, etc. The current, for example, but not limited to the SSL including but not limited to LEDs, OLEDs, QDs, etc., combinations of these, etc. can be used to set the lumen value as, similar, nearly identical or identical LEDs, for example, should have the same lumen output at the same current all other parameters held relatively constant. By measuring other parameters including temperatures as part of embodiments of the present invention, as well as periodic lumen or lux (or foot candles) or other types of optical, spectral, photometric data, etc., the lamps of the present inventions can essentially be periodically calibrated or even self-calibrated to produce even and constant lumens from lamp to lamp over time in end-use applications, locations, etc. which can be stored and programed so as to give/provide even and consistent light output from, for example but not limited to, lamp to lamp, fixture to fixture, luminaire to luminaire, etc. Embodiments of the present invention can use one or more variable capacitors or variable impedance to set, for example, but not limited to the output level, the output current, the output intensity, the output lumens, etc. In some embodiments of the present invention this may be applied to one or more outputs, one or more output channels, for OVP, OTP, OCP, SCP, as well as other protections discussed herein, etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. All types of ballasts may be used with various embodiments of the present invention including but not limited to instant start, rapid start, program start, programmed start, preheat, and other types and forms of both electronic and magnetic as well as hybrid ballasts. In various embodiments of the present invention, different wavelengths, combinations of colors and phosphors, etc. can be used to obtain desired performance. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T6, T8, T9, T10, T12, PL 4 pin and 2 pin, etc. Such embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, purple, etc. color detectors could be included as part of the spectral/spectrum sensor or sensors. In some embodiments of the present invention, quantum dots can be used as part of and to implement the spectral/spectrum sensors.

The present invention can used as a switch to open or close, for example, garage doors and other types of residential, commercial or industrial doors by, for example, sending a signal such as a contact closure to open/raise or close/lower the door or doors or, for example, gates at a parking garage or other types of facilities. Such a signal can be activated using wired, wireless, or powerline approaches including serial, parallel, analog, digital, combinations of these including but not limited to those discussed herein including but not limited to Bluetooth of any type or flavor including Bluetooth, Bluetooth low energy, WiFi, IEEE 801, IEEE 802, ZigBee, Zwave, other 2.4 GHz and related/associated standards, protocols, interfaces, RFID, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc. In addition, voice commands, voice recognition, voice detection, fingerprint, retinal, face, speed, velocity, proximity, direction, time of day, location, whether conditions, weight, height, other features, motion, other characteristics, other forms of detection, etc., other combinations can be used in combination to command the door to open or shut. Optionally, horizontal and vertical detection can be used for example on garage doors, residential, commercial, industrial, etc. doors of any type and form including recreational vehicle (RV) and boat doors, storage facilities, etc. to command, detect, report, alert, alarm, monitor, control, etc. An example embodiment could use for example a Bluetooth controlled switch that can be activated from a cellular phone or tablet which could take in gesture commands, typed commands, voice commands, and other forms of commands to open or close the respective door by activated the switch. This example could also be coupled with detecting the distance of approach or a vehicle, bicycle, car, automobile, person, animal, other types of moving inanimate or animate (or both) objects, etc. combinations of these, etc. For example, as a car approaches a driveway or gate (including but not limited to home gates, parking lot gates, etc.) or both the signal strength of the Bluetooth device (i.e., cell phone, smart phone, tablet, custom remote, generic remote with Bluetooth) can be detected to achieve an appropriate signal strength level to open the gate or garage door or both. As another example, GPS can be used to detect the car or other inanimate or animate moving toward or away from the garage and the present invention can take appropriate action, for example, opening the garage or closing the garage as the car or other inanimate or animate moves toward or away from the garage. In still other example embodiments, voice commands can be used as part of the present invention with either dedicated to this purpose or general usage as part of the overall present invention with specific or distributed microphones, etc. to open or close the door or gate either with or without devices using, depending on the desired level of, for example, security, specific commands or secure commands or voice identification commands.

Such implementations of the present invention can be battery powered, solar powered including with both sunlight and ‘artificial’ light from light sources, battery powered with solar charging including with both sunlight and ‘artificial’ light from light sources, vibration and/or mechanically powered, battery powered with vibration or mechanical charging of the batteries, etc., being powered by the garage door opener, the gate opener, lighting for opener, AC wall power, other sources of power, etc., combinations of these including with both sunlight and ‘artificial’ light from light sources, etc. The switch or switches can take a diverse variety of forms including, but not limited to, electrical, mechanical, electromechanical, semiconductor, transistors of any type, vacuum tubes of any type, relays of any type including coil, reed, solenoid, static, latching, etc. Implementations of the present invention can be put at virtually any location and consist of a black box with no auxiliary user inputs, an on/off switch that is in parallel with the remotely controlled switch or switches, a toggle switch that is in parallel with the remotely controlled switch or switches, a momentary switch that is in parallel with the remotely controlled switch or switches, a keypad switch that is in parallel with the remotely controlled switch or switches, a touch pad switch that is in parallel with the remotely controlled switch or switches, a screen including but not limited to a touchscreen with a switch that is in parallel with the remotely controlled switch or switches, a slider switch(es) that is in parallel with the remotely controlled switch or switches, a capacitive coupled switch or switches switch that is in parallel with the remotely controlled switch or switches, etc., combinations of these, etc. Implementations of the present invention can also include sliding doors, patio doors, French doors, etc., for example controlling lighting based on door usage, door position, light through the door, and for example controlling doors, locking/unlocking doors, reporting position and locked state of doors, etc. Temporary permission for access may also be granted both locally and globally. In addition to opening the door and turning on any lights directly associated with opening the door, implementations of the present invention can also turn on other lights including to a prescribed, sequenced, scheduled, etc. or other level, etc., as well as turn on or off other devices including but not limited to air conditioners, heaters, furnaces, appliances, fans, etc.

Embodiments of the present invention can be used as a smart and secure pet door with the Bluetooth, RFID, WiFi, ISM, and/or other wireless only allowing the pet door to open when the animal wearing such a device is near.

The present invention can also form a Community where such a community can consist of neighbors, friends, family, others, located nearby or in other parts of a state, country, continent, world, etc. who remain in relative contact and collectively remain in contact in general such that using telephone lines, cellular/mobile communications, internet, radio communication, fiber communications, etc., the various embodiments of the present invention can be linked to others in terms of the control, monitoring, sensing, logging, etc. As an example, the SSL or other lighting can be set to flash in a single white color, multiple white colors, multiple colors, red color, or other colors when some potentially dangerous or life-threatening situation happens such as a fire, smoke, an unauthorized entry, intruder, motion detection, movement detection, etc. including both random and systematic, water leakage, natural gas leakage, electricity usage both in general and at specific locations, circuit breakers, junction boxes, outlets, etc., water flow, water usage, the lack of water usage, power outage, excessive power usage, too little power usage, lack of telephone, internet, etc., lack of response from inhabitants of house, a fall or injury, failure to contact one or more individuals or entities, screams, key words, certain words, code words, excessive vibrations, voice commands, over-heated areas, under-heated areas, too low of a temperature, too high of a temperature, thermal detection, thermal scans, abnormalities in the thermal scans or detections, video capture, detection, imaging, or recognition, etc., an appliance or appliances left on too long, an appliance or appliances left on too short of a time or not turned on, combinations of these, etc. —these events may also trigger optional alerts including speaker, siren, voice generation, etc. to be sent out locally as well as via cellular phone networks, internet, web, e-mail, texts, pictures, video, etc., combinations of these, etc. to all or a subset of the Community.

Some embodiments of the present invention include various means to detect sleep, heart rate, pulse rate, blood pressure, sleep state, sleep tracker, activity tracker, oximeter, etc. to control the SSL and other lighting. For example, many of the wearable technologies for sleep tracking, monitoring, adjustment, feedback, etc. as well as heart rate, pulse rate, blood pressure, oximetry, activity, wake or sleep state, general or specific health state, etc., combinations of these, use Bluetooth to communicate and interface to smart phones and tablets, etc. This also applies to many of the non-contact and/or proximity systems. As an example, the present invention can interface, connect, intercept, obtain, etc. the information being transmitted directly or indirectly for example but not limited to using the wearable device, using a phone or tablet app, using a laptop or desktop computer, using a server, using a dedicated interface, etc.

The present invention can also have interfaces which are either built-in or standalone/separate that accept and translate various control signals, information, etc. that are either one way (i.e., control) or two-way (control and monitor) to various standards and protocol including BACNET, LONNET, and similar HVAC/lighting standards and protocols, etc. In addition, other interfaces such as WiFi to Bluetooth or Bluetooth to WiFi, Wink, WeMo, etc. may also be used in certain embodiments of the present invention.

Embodiments of the present invention can also have isolated outputs that can supply power for other uses including USB uses (i.e., 5 volt), other voltage and current values, switches, relays, etc. to power, drive, signal, etc. Embodiments of the present invention can include batteries as part of the implementation or be powered by back-up batteries, emergency batteries, solar power directly or indirectly (using batteries, fuel cells, etc.), vibration or mechanical energy sources, uninterruptible power supplies (UPSs), emergency power sources, emergency ballasts, etc., combinations of these, etc. and can provide emergency (or other power) to charge or power cell phone(s), tablet(s), radio(s), laptops, computers, other personal device assistants, etc. during an emergency or at other times.

The present invention can be used to aid in circadian rhythm regulation and cycle synchronization as well as Seasonal Affective Disorder (SAD). The present invention can aid in correcting sleep disorders and provide light therapy including for SAD. The present invention can use input, feedback, etc. including human physiological and biological input and feedback and environmental (including, but not limited to, temperature, time of day or night, ambient light, light spectrum, etc.) to control and monitor the light including the colors/wavelengths and/or the intensity of the light, etc.

The present invention can be used for personal or professional use and applications. The present invention can be used, for example, in hospitals, rest homes, senior care homes, rehabilitation facilities, short term and long term care facilities, homes, residences, commercial and industrial buildings and locations, schools including K12, universities, colleges, etc., in cleanrooms, in confined spaces, in spaces devoid of natural light, on ships, buses, boats, planes, aircraft, submarines, vessels, all times of marine, ground, air and space vehicles including transport and working environments, spaces, vehicles, etc.

The present invention can use actimetry, sleep actigraphs which can be of any form including watch-shaped and worn on the wrist of the non-dominant arm, temperature, EEG, wrist, body movements, polysomnography (PSG) and other such techniques, etc.

The present invention can also be used to provide relatively dim illumination at night of appropriate wavelengths and can be integrated into a single light source and sensor unit to provide lighting sufficient for sleeptime/nighttime use and egress for, for example, children and adults including more aged and senior adults and parental or other (including, but not limited to nursing, nurse assistant, care giver, hospital, rest home, hospice, trauma, emergency room and similar environments, recovery, rehabilitation, assisted living, elderly living, senior care, etc. centers/facilities, etc.), dementia of all types and forms, etc., and to provide various types of light therapy including but not limited to individual, customized, programmable, adjustable, adaptable, etc. The present invention lighting can be used for, for example but not limited to, seniors, families, businesses, residences, homes, houses, elderly, physically impaired people and persons, etc. to signal, alarm and/or alert others of an emergency, an intrusion, a fire, a fall, an injury, toxic or explosive gases, loss of heating, water leakage, etc., by for example flashing lights, on-off lights at certain periods of repetition, different colors flashing, different patterns of colors, different intensities and dimming, etc., combinations of these, etc. In some cases, the interior/indoor lights can be set to full on/full brightness while the exterior/outdoor lights can be set to flashing or other modes including but not limited to those discussed herein. In some embodiments audio alarms including but not limited to sirens, recorded or synthesized voice messages, actual sounds from microphones within the house, synthesized ring tones, alarms, alerts, etc., other types of patterns of sound, music, etc., combinations of these, etc. can be used.

The present device can be made into light sources, including but not limited to sheet light sources, which can incorporate solar cells either on the front or the back, and optional energy storage such as batteries to create a light source that can be powered when there is no sunlight or can also act as a privacy screen and/or temperature reducer over windows by absorbing and blocking the sunlight (and potentially associated heat and UV rays) from entering the space on the interior side of the window while still powering and providing energy to the light sources to illuminate the interior space(s).

The present invention can use projectors, television sets, computer monitors and other displays, etc. including as light sources and to provide light of various and different colors including different white light colors including for use in light therapy including but not limited to circadian rhythm, SAD, dementia, other maladies, illnesses, diseases, etc., combinations of these, etc. Implementations of the present invention can include using televisions including older televisions that can be switched on and set to appropriate wavelengths for waking up and appropriate wavelengths for resting/going to sleep, etc. Embodiments of the present invention can use an interface/conversion/communication device/box/unit/etc. that can, for example, use the duplication of the remote control signals to turn on the television and set the channel such that the signals applied to the specifically set channel produce the desired wavelength spectrum. Embodiments of the present invention can also use a remotely controlled switch to turn on the television, projector, etc. Audio signals may also be used and applied to assist in waking or sleeping, such as, but not limited to, synthesized, simulated, emulated, and/or recorded voices, sounds, environments, tones, natural or man-made sounds, live streaming, personal communications, television, radio, other broadcasting whether wireless, web-based, cable, wired, etc., combinations of these, alarm clocks, either alone or in combination with changing light levels and/or wavelengths, in order to provide predetermined, or programmable, randomized, live, etc., audible and/or light-based alarms, whether gradual, gentle, insistent, etc. Such alarms can be adapted for slow or fast waking of individuals with a range of light sleeper to deep sleeper characteristics. Changing light patterns in alarms can simulate sunrise or other conditions, etc. or in certain cases, sunset or other times of the day or night, etc. which can be customized and personalized for a person, persons, groups of people, etc.

The present invention can be used to gently or urgently or anything in between wake a person or people by providing light with high/significant or total blue wavelength content. Such implementations of the present invention can be used in one or more locations that are collocated/local or located miles or continents apart. The present invention can control and monitor one or multiple light sources in one or more locations. For example parents can set one or more wake up sequences where the light can, for example, but not limited to, dim up slowly or go to full brightness instantly, provide vocals including, but not limited to, music, horns, buzzer, alarm, synthesized sounds, noise, nature, ocean and other sounds, combinations of sounds, voices, familiar voices, voice generated or previous voice recorded, etc. In a similar fashion, the present invention can include night-time or sleep time to control and monitor one or more light sources and optionally electrical outlets such as, for example, but not limited to, to control the turn off, dimming including gradual or abrupt or anything in between the light sources in one or more locations including the same or different rooms which could be set to simultaneously, separately, staggered, or other scheduling or sequencing of the light and related control. In some embodiments of the present invention, the amplitude of a sound, noise, acoustic, thud, vibration, mechanical, sounds associated with movement can be detected and optionally amplified including remotely amplified using commands, automatic signals, remote control and signals, etc.

Embodiments of the present invention can also use an infrared to RF wireless universal interpreter/converter as described in PCT Patent Application PCT/US15/12965 filed Jan. 26, 2015 for “Solid State Lighting Systems” which is incorporated herein by reference for all purposes. Such a universal interpreter/converter allows control of portable devices such as portable air conditioners, window air conditioners, portable heaters and furnaces, portable space heaters, portable space coolers, etc., entertainment devices, units, systems, etc., humidifiers, etc. In some embodiments of the present invention the infrared to RF wireless universal interpreter/universal converter/adapter may be installed in and included as part of a lamp, bulb, light fixture, etc., may be battery operated with a solar charger, a mechanical energy charger, other types of energy harvesting, etc. Such implementations of the present invention can use one or more mobile, portable wireless devices including, but not limited to, remote temperature sensors, smart phone temperature sensors and measurement devices, integrated circuits, etc., Bluetooth temperature sensors and measurement devices, tablet temperature sensors, etc., humidity sensors and measurement devices, etc. One or more of these sensors in one or more nearby locations may be used, for example, as temperature control points/locations for which certain embodiments of the present invention can be commanded to modify the temperature until one or more of the temperature setpoints are reached and maintained. Some embodiments of the present invention can also monitor the power (i.e., voltage, current, apparent power, real power, power factor, etc.) to monitor, store, calculate, make decisions, provide analytics, etc. of the heating and cooling energy use, etc.

In example embodiments of the present invention a power supply can be included in which the frequency can be detected using a microprocessor, microcontroller, FPGA, DSP, analog circuit, other digital circuits, combinations of these, etc. A switch including, for example, a transistor such as a field effect transistor (FET) such as a MOSFET or JFET can be used in the power supply to, for example, either turn on or turn off a circuit that operates in either ballast mode or AC line mode depending on the amplitude of the signal or with the inclusion of a time constant, the average, RMS, etc. voltage level. The present invention removes the requirement that a reference level and a comparison to the reference level being required to detect the amplitude of the waveform.

Some embodiments of the present invention include a solid state lighting (SSL) replacement which could include but is not limited to a light emitting diode (LED), a organic light emitting diode (OLED), quantum dot (QD), etc. combinations of these, etc., replacement lamp that can be directly put into, for example, but not limited to, 2 ft and 4 ft linear fluorescent tube sockets, tombstones, or other fixtures, other types of fluorescent fixtures and sockets, including but not limited to, PL 2 and 4 pin sockets, fixtures, etc. and receive power directly from electronic ballasts (i.e., instant start, rapid start, programmed start) and also magnetic ballasts or in lieu of the ballast, AC line voltage including being able to accept universal AC line voltage. The LED fluorescent tube replacements (FLRs) have a unique and innovative aspect in that the LED FLRs can be wirelessly dimmed and support both manual and daylight harvesting controls including standard 0 to 10 V, DALI, DMX, and other interoperable protocols and interfaces including, but not limited to, interfaces that support standards including Building Automation Control Network (BACnet) which is an open, standard communication protocol by the American Society of Heating, Refrigerating, and Air-Conditioning Engineers (ASHRAE) and LON (LonTalk), a protocol developed by the Echelon Corporation later named as standard EIA-709.1 by the Electronics Industries Alliance (EIA) that have been established for building automation system (BAS) vendors, manufacturers, suppliers, etc. to enhance and further enable the adoption of LED luminaires and FLRs in building automation.

The present invention uses wireless signals to both control (i.e., dim) the LED FLR and monitor the LED current, voltage and power and can provide analytics, fault reporting, power usage, activation alerts, monitor traffic including the motion and sound and also video from for example a camera powered through the present invention including receiving power from a ballast. Power from a ballast/AC line can be used to power any devices in the lighting system, such as, but not limited to, security cameras, web cameras, remote monitoring, cameras, surveillance cameras, etc., combinations of these, etc. used to trigger actions rather than generating images, Bluetooth traffic monitors, motion sensing or sound sensors that are ballast powered, light sensors, etc. Optional sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth including all variants such as, but not limited to, Bluetooth low energy, Bluetooth Mesh, ZigBee, ZWave, IEEE 802, or WiFi. In addition to these types of occupancy/motion sensors, photo sensors and daylight harvesting controls, simple and low cost interfaces that allow existing or other brands, makes, and models of daylight harvesting controls, photo sensors, occupancy/motion/proximity sensors, voice recognition, voice commands, gesturing, face recognition, magnetic sensors, infrared sensors, magnetic key cards, other types of sensors, RFID, cellular phones, smart phones, tablets, laptops, desktops, servers, etc., combinations of these, subsets of these, etc. to be connected to and control/dim and/or change color(s)/wavelength(s), etc. the wireless SSL including but not limited to LED, OLED, and/or QD FLRs in various embodiments of the present invention can be used. In addition, wired and powerline (PLC) interfaces may be used with the present inventions as well as multiple types and forms of local and remote sensors, detectors, transmitters, receivers, responders, etc.

These SSL FLRs are highly efficient especially with energy harvesting. The present invention is applicable to office, retail, food service, hospitality, healthcare, school, military, government buildings, etc. and can include cybersecure communications.

The present invention provides modular solutions and kits some of which can be selected at time of manufacturing, some of which can be added and are field-installable without the need for experience of knowledge of advanced electronics or the details of SSL systems—and all of which are low-cost and can provide additional energy savings. An optional but not necessary component of the control firmware, hardware and software is additional processor capability that can also be easily integrated into SSL systems.

The present invention employs low-cost, adaptive sensors and controls that can often communicate at low data rates with low data content to achieve energy usage reduction for a wide range of lighting products including both SSL and non-SSL products (that can later be replaced with SSL products); in addition this allows for existing dimmable and non-dimmable SSL products to be made more energy efficient. The merits include reduced energy consumption and cost as well as providing enhanced performance and functionality. Enhanced high speed, high data content (including video, video streaming, data mining, data gathering, etc.) versions of the present invention can also be implemented.

The present invention can be highly energy efficient, low-cost to manufacture and price enabling as well as designed to work with numerous platforms, including smart phones (i.e., iPhones, Androids), tablets (i.e., iPods, Androids), computers, Arduinos, Raspberry Pi(s), do-it-yourself (DIY) and novices, both smart and dumb (with a wireless interface) TVs including HDTVs, 4D TVs, TVs that are only NTSC-compatible (and not HDTV-compatible). Implementations of the present invention can be, for example, in both kit forms and fully assembled, tested and ready-to-plug-and-play modules and units. The system, once setup, can be self-maintained or controlled, monitored and data logged (including analytics) using, for example, the industrial, scientific and medical (ISM) radio frequency (RF) bands and/or powerline control (PLC) and/or wired interfaces and connections using low-cost components and electronics or virtually any other method including optional (and not required) interfaces ranging from low-tech to very high-tech. The present invention does not require the internet or internet protocol (IP) addresses to operate; however optional choices and accessories allow internet-connectivity if so desired. The present invention, in some embodiments, can also respond to voice commands and gesturing. Smart phones and tablets can be connected in a number of ways to the present invention innovative SSL energy savings sensor system including, but not limited to, Bluetooth (including Bluetooth Low Energy) and other ways without or with the internet or IPs.

The present invention includes a family of SSL lighting products including innovative, ultra-efficient, highly flexible power supplies and drivers for LEDs, QDs and OLEDs.

The present invention provides power supplies and associated control and monitoring electronics that enable and support rapid introduction of both SSL replacement and innovative general lighting and luminaires for residential, commercial, educational and industrial applications and markets.

In particular these power supplies and drivers for SSL can convert AC input to DC output power, have a high power factor (PF) and low total harmonic distortion (THD), support various types of dimming, meet FCC EMI limits, provide over-current (OCP), over-voltage (OVP), over-temperature (OTP) and short circuit protection (SCP). Of great importance, these power supplies are high to ultrahigh efficient and in some embodiments are amenable to form fit applications for LEDs and OLEDs including edge-emitting LEDs and edge lit LED lighting. Implementations of the present invention include ultra-efficient, highly flexible family of isolated and non-isolated power supplies for SSLs that support both white light and color tunable red/green/blue (RGB) as well as other color combinations including red/green/blue/amber (RGBA) and red/green/blue/amber (RGBA) coupled with one or more white colors (i.e., one or more white color temperatures) modes of SSL operation.

The present invention includes smart, feature-full SSL drivers and photo/light, noise, and/or motion sensors that are very low power and capable of sending information wirelessly (or wired) to one or more controller/monitor units or directly to the SSL power supplies and drivers or combinations of these. The smart drivers, in addition to the performance specified for the simple drivers support, among others, optional wall (Triac), 0 to 10 V, powerline (PLC), wired and wireless dimming. In addition to versions that support white light dimming via ISM RF signals and, optionally (via, for example Bluetooth, Bluetooth Low Energy, Zwave, ZigBee or WiFi), smart phones, tablets, iPods, iPads, iPhones, Android devices, Kindles, computers, etc., RGB or RGBA or other combinations of more or less color/mood changing SSL panels can also be supported via the same interfaces and mobile/computer devices. Unlike simple infrared controlled RGB lightstrips, ropes and the likes with limited color choices and dimming levels, the present invention RGB lighting allows for high resolution 8-bit to 12-bit (256 to 1024) or higher resolution color levels per RGB channel and with innovative ways to interactively and dynamically user-select the resolution and dimming level. The present invention can be self learning and can support artificial intelligence including but not limited to in terms of lighting, light therapy, light growth, light interactions, etc., combinations of these, for, but not limited to, humans, animals, plants, insects, etc.

Solid state lighting, including light emitting diodes (LEDs) and organic light emitting diodes (OLEDs) and quantum dots QDs, has the capabilities to provide significant energy reduction resulting in, among other things, less dependence on foreign sources of energy and less wasted energy including wasted heat energy. SSL provides quality benefits for general lighting in both residential and commercial applications that are not possible using fluorescent lighting or most other types of lighting. Improved visual quality is a result of several intrinsic characteristics of SSL systems. For example, newer types of SSLs have brightness levels that are actually visually pleasing to view directly. Given their unique form coupled with power supplies and drivers specifically optimized to enable and exploit the unique form factors and inherent flexibility and digital nature of SSLs, tremendous design flexibility is an inevitable result, thereby creating the possibility of new and innovative luminaires, lighting design approaches, and architectural integration. SSLs also enable luminaires with superior color attributes. These superior color attributes include user-adjustable and selectable RGB and, for example, but not limited to RGBA color and high ‘white light’ CRI, and even color temperature tunability. SSL luminaires not only eliminate hazardous material but also embed less energy in the manufacturing and transportation processes. The thinness and minimal weight of the SSLs facilitate the use of lighter and innovative materials in the luminaire construction. Integrating energy efficient solid-state lighting with advanced sensors, controls and connectivity provides for a family of comprehensive lighting products including control and monitoring products that further reduce energy usage while enhancing the user-experience.

The present invention includes implementations that are compact, low-cost multipoint addressable RF control and monitoring system that includes SSLs, photo/light sensors, motion sensors, control, dimmers (which can also function and be set to on/off mode) that SSL and other light source types can be plugged or screwed into. The light and motion sensors can, for example, be battery and/or solar powered and only send/transmit information/signals when there is change (i.e., the ambient light changes appreciably compared to a reference set-point, motion is detected or not detected, etc.). Implementations of the present invention can include integrated circuits (ICs) to be used in, for example, but not limited to, SSL drivers, dimmers, and sensors. Such sensors and other circuits in a lighting system can be powered by a ballast in a lighting fixture, or, if the ballast has been removed or otherwise bypassed, directly from the AC line through the lighting fixture. In some embodiments, sensors in the system can recognize occupants based on, for example, but not limited to the Bluetooth fingerprint of their electronic devices as they enter a room, and configure lighting levels, colors wavelengths etc. based on their stored preferences automatically, or based on time of day or week, holidays, financial reports, cost of energy at a given time or day, weather reports, temperature indoors or outdoors, emergency conditions, smoke detectors, etc. The ballast or AC line in the lighting system can be used as a power source for any connected device, such as, but not limited to, including a thermostat in the light fixture, with Bluetooth control, WiFi, or any other interface. The system can include IR temperature sensor or thermal imaging camera(s) to measure ambient temperature or point temperatures in the room or other environment around the light fixture. Such sensors or thermal imaging cameras could measure temperature differentials throughout the room to trigger an alarm if temperature differentials are detected that are greater than a threshold. Such sensors can be moved in some embodiments, for example by mounting on a motorized gimbal. In some embodiments lenses or filters, such as a fisheye lens, can be used in connection with sensors to increase the monitored area. Such sensors can be used to monitor for abnormal temperature differentials, identifying fires, faulty and overheating electrical outlets or wiring, windows or doors needing to be closed, motion or movement, forced entry, etc. The system can include adaptive control such as, but not limited to, artificial intelligence systems to determine normal operating conditions and to identify and signal abnormal conditions. In some embodiments,

The lighting system can be used with and also replace high intensity discharge (HID) lights in schools, gyms, hospitals, nursing homes, shopping centers, etc., to provide tunable light colors/wavelengths and illumination levels, both for normal operating conditions and emergency conditions of any types. For example, lighting in a school gym can be controlled during a dance to vary the color and intensity to enhance the atmosphere of the dance, in some cases based on the music. In the event of a fire or other emergency, the light can, for example but not limited to, be switched to flashing red light or a combination of solid white and flashing red light to facilitate exit from the building.

Some embodiments of the present invention include relatively low-cost ISM and/or Bluetooth transceivers and further reduce cost and power consumption so as to make long-term and longlife operation possible using, for example, small batteries or solar power/charging or both. In some embodiments of the present invention solar or other types of charging including those discussed herein can be used to recharge the battery or batteries using for example but not limited to buck boost, buck, boost, boost buck, flyback, forward converters, half bridges, full bridge, push-pull, Cuk, SEPIC, etc. topologies.

Some embodiments of the present invention support low power operation including deep-sleep ultra-low power mode such that the power consumption is extremely low when not transmitting or receiving, and also optimizing transmit and receive power. In some embodiments, the intent is to send only as much data as needed and not to go ‘overboard’ in terms of information sent and received.

Addressing protocol and firmware/hardware setting and programming can be used to control and monitor the present invention including individually addressing the drivers, dimmers and sensors. One simple approach would be to use physical DIP switches to set the address of each unit. Another approach is to have a low-cost programming station that the user purchases as a one-time-only expense that allows easy user programming of the drivers, dimmers and sensors, (and other modular components to be added/included) etc. as well as having other wired or wireless programming or joining/connecting/connection/advertising protocols, approaches, methods, techniques, technology, etc. that include cyber secure methods, approaches, techniques, etc. that could optionally permit programming changes or reprogramming, uploads of updates to the firmware and software, etc.

Embodiments of the present invention can incorporate the low-cost wireless control and monitoring into the drivers and sensors. This provides a wide-open way to interface with the energy efficient SSL with advanced sensors, controls and connectivity systems including without the need for internet protocol (IP) addresses (and typically, if so desired, using at most only one IP address) using most any type of entertainment device including old NTSC TVs, monitors and more modern do-it-yourself (DIY) gadgets including Arduino, Raspberry Pi, etc.

The present invention allows the ability to switch from remote (control) mode to manual mode simply by touching, in the case of a dimmer, a knob. Embodiments of the present invention can detect/sense motion and light and make informed, automatic decisions based on algorithms; however such algorithmic auto-tuning, automatic decisions can be easily overridden by the user. Additional developers can create additional hardware and software for these systems and expand the functionality and user-interface/experience/abilities/etc.

A graphical user interface is provided in some embodiments of the present invention, for example accessible as a web page or set of web pages that can be accessed using any web browser on any device. Such a graphical user interface can display all of the data sources, all of the controllable devices, and can provide remote control of any of the controllable devices in the system. Some embodiments provide for power monitoring and logging, for example measuring/monitoring input voltage and current, power consumption including both real and apparent power consumption and power factor of a single light source in the system or other device in the system, or for groups of devices in the system. These and other such GUIs can be imported to other formats such as, but not limited to, a converter box designed to work with NTSC TVs, HDTVs including smart HDTVs, computers, dedicated control/monitor blocks that can either have a built-in display or use a TV or monitor display, Arduinos, Raspberry Pis, smart phones, tablets (in Bluetooth or WiFi mode as well as wireless internet mode), and a vast host of other interfaces.

Some embodiments of the present invention can use low-cost smart/intelligent SSL drivers based on existing powerline, wired and wireless interfaces including AC powerline, 433 MHz, 868 MHz and 2.4 GHz wireless remote monitoring and control systems in addition to wireless solutions/options that use more expensive Bluetooth, ZigBee, IEEE 802-based, WiFi etc. as well as complete 0 to 10 V dimming control for LED dimmable drivers and CCFL and FL dimmable ballasts and other dimmers. The wireless systems can be easily modified to other frequencies if needed including, for example, in the International Science and Medical (ISM) mid to high MHz frequency range as permitted by the FCC. The monitoring and control systems can monitor all key parameters including, but not limited to, input current, input voltage, inrush current, voltage spikes, power factor, true input power, Volt-Amp (VA) input power, output current, output voltage, output power, output voltage, etc. The powerline communications can support, for example, X-10, Insteon, and HomePlug protocols, etc. In addition, open source protocols can be implemented.

Manual/Remote Mode feature with status indicators can also be provided in some of the embodiments with flexible manual override capabilities and user selectable setup features. Voice recognition and gesturing can also be implemented into versions of the present invention along with the wireless, wired and powerline choices.

Interfaces that support standards including Building Automation Control Network (BACnet) developed as an open, standard communication protocol by the American Society of Heating, Refrigerating, and Air-Conditioning Engineers (ASHRAE) and LON (LonTalk), a protocol developed by the Echelon Corporation later named as standard EIA-709.1 by the Electronics Industries Alliance (EIA) that have been established for building automation system (BAS) vendors, manufacturers, suppliers, etc. can also be implemented in the interfaces to the SSL drivers and power supplies to enhance and further enable the adoption of SSL luminaires in residential and commercial building automation. A purported primary feature of BACnet and LON is interoperability enabling multiple control systems and lighting systems manufactured by different vendors to work together, sharing information via a common interface. Some embodiments of the present invention allow for higher output powers than would normally be allowed by, for example, taking advantage of the additional power supplying capabilities of the ballast to supply full wattage as opposed to a reduced wattage that are typically needed for SSL to have the same output lumens. For example, during an emergency including, but not limited to a smoky environment or a need for more intense light, embodiments of the present invention could switch to a high energy/high power mode where more power/current was being used by the SSL and thus, in general, increasing the output lumens even if doing so may, depending on the situation, degrade (or not degrade) the ultimate lifetime of the SSL including but not limited to LEDs and/or OLEDs.

Turning now to FIGS. 2-4, some embodiments of the present invention include an in-socket solid state lighting-compatible controller/dimmer Although any socket and any light source mounting technology can be used, the example embodiment of FIGS. 2-4 includes a male and female Edison E26 or medium screw base. The socket 200 includes a male Edison screw base 202 to connect to a light fixture, and a female Edison screw socket 204 to receive a solid state light 206. The socket 200 includes power supply/driver circuits, wireless control circuits, on/off/dimming circuits, monitoring/control circuits, etc. as desired. In some cases, power supply/driver circuits, wireless control circuits, on/off/dimming circuits, monitoring/control circuits are also or alternatively located in the solid state light 206. The solid state light 206 includes a male Edison screw base 210, a housing 212 that can emulate the familiar shape of an incandescent bulb if desired that can house circuits, heat sinks, sensors, etc. The solid state light 206 includes a circuit board housing 214 in which one or more circuit boards can be mounted supporting one or more solid state lights of one or more colors, covered by a lens 216 that can include diffusers, filters, lenses, phosphor coatings, etc. as desired.

The present invention uses wireless signals to both control (i.e., dim) SSL (e.g., LED, OLED, QD) fluorescent lamp replacements (FLRs) and monitor the LED current, voltage and power. This LED fluorescent lamp replacement is designed to work directly with existing electronic ballasts and requires no re-wiring and can be installed in the same amount of time or less than changing a regular fluorescent lamp tube. This smart/intelligent LED FLR is also designed to be compatible with most daylight harvesting controls and protocols. Included, incorporated or optional sensors allow for relative light output to be measured and wirelessly reported, monitored, and logged permitting analytics to be performed. The FLRs can be of any size and length including both two foot and four foot T4, T5, T6, T8 standard/nominal linear lengths as well as any other lengths (T12 sizes can also be used if deemed useful for FLR usage) as well as other form factors including but not limited to PL 2 pin and 4 pin, U shaped tubes, etc. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth or any type and flavor, ZigBee, ZWave, IEEE 802, WiFi, WeMo, Bluetooth Low Energy, LoRa, Thread, 6LoWPan, WiFi, gateways, hubs, bridges, etc., more than one of these, combinations of these, etc. In addition to occupancy/motion sensors, photo sensors and daylight harvesting controls, various embodiments support simple and low cost interfaces that allow existing other brands, makes, and models of daylight harvesting controls, photo sensors, occupancy/motion sensors to be connected to and control/dim the wireless SSL LED) FLRs. The LED FLRs can be switched on and off millions of times without damage as well as be dimmed up and down without damage. The wireless communications can be encrypted and secure. This LED FLR technology does not require or need a dimmable ballast (although the present invention will also work with dimmable ballasts, dimming ballasts, etc.) and works with virtually any electronic ballast including instant start, rapid start, programmed start, programmable start, pre-heat, dimmable, dimming, non-dimmable, 1, 2, 3, 4, 5, 6 and higher count lamp ballasts, etc. and can also work with magnetic ballasts.

The control code interoperability allows multiple control systems manufactured by different vendors to work together, sharing information via a common Web-based interface.

The present invention can use wireless signals to both control (i.e., dim) the SSL FLR and monitor the SSL current, voltage and power. Optional sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or Bluetooth, ZigBee, ZWave, IEEE 802, WiFi, WeMo, Wink, cell phone signals, WiMax, 6LoWPAN. THREAD, LoRa, IrAD, other infrared, optical, light, electromagnetic, electromagnetic waves, radio frequency (RF), Thread, 6LowPan, modem including 1G, 2G, 3G, 4G, 5G, GSM, etc. based mobile communications, powerline, wired, etc. with either secure/encrypted or unsecure communications. In addition to occupancy/motion sensors, photo sensors and daylight harvesting controls, simple (or more complex, sophisticated, etc.,) and low cost interfaces allow existing or other brands, makes, and models of daylight harvesting controls, photo sensors, occupancy/motion sensors to be connected to and control/dim the wireless SSL FLRs. These SSL FLRs are highly efficient. In some embodiments, the system includes demand response capability, including enabling and disabling lighting and other devices based on demand, reducing output current/power usage when demand is low, etc.

Any and all types of buildings and residences, small or large, that have/use electronic ballasts or magnetic with linear fluorescent tubes or compact fluorescent tube types (e.g., PL 2 and/or 4 pin) can use and directly benefit from the present invention.

Some embodiments of a lighting system include a wireless controller and monitor and sensors in accordance with some embodiments of the invention. Sensors can include, but are not limited to, occupancy/motion detectors/sensors and daylight harvesting sensors.

The wireless controller and monitor of a lighting system can feed control signals to one or more SSL FLR's, any number of which can be addressed and controlled, and can have the same or different or multiple colors or light wavelengths. The wireless controller/monitor can be interfaced to, for example, an intranet, the Internet, custom remote controls, autonomous controls, Bluetooth, etc. and can be securely encrypted or unsecure. In some embodiments, the SSL FLR's are direct fluorescent lamp replacements that can be snapped in or connected to any existing fluorescent light fixture and turned on without requiring electrical re-wiring to install. This makes switching to SSLs/LEDs as simple as changing a light bulb/tube: no rewiring or special handling required. The SSL FLR's can be powered by ballasts in, for example, but not limited to T8 (or T4, T5, T6, T9, T10, T10, PL, etc.) lighting fixtures and used in rewired fixtures where AC power is supplied directly to the lamps.

Some embodiments of the present invention include one or more multiple light emitting panels with fixed or movable mounts, such as, but not limited to, those disclosed in PCT Patent Application PCT/US15/32763 filed May 27, 2015 for “Lighting Systems” which is incorporated herein by reference for all purposes. For example, multiple panels can be mounted on moveable or articulating arms. Like a blooming flower the SSL system can be ‘folded’ to close and then opened to bloom. The light emitting panels can use monochrome, white, multi-color, color-changing, color-tuning, color adjusting, etc. LEDs, QDs and/or OLEDs or combinations of these, etc. which can be manually, automatically, remotely, sequenced, web-based, Internet, Internet-info based, spectrally based, sensor based including light sensor based, etc., other methods, ways, techniques, approaches, etc. discussed herein, etc., combinations of these, etc. Motors, gears, pulleys, chains, etc. may be used with the SSL system to unfold, fold, rotate, move, translate, etc. the light emitting panels. The light emitting panels (or petals of the blooming flower) may have any size or shape, may be symmetrical, asymmetrical, etc.

Any number of light emitting panels of any color or combination of colors can be included, and can also include point light sources if desired, as well as sensors, detectors, cameras, fans, reflectors, diffusers, etc. as desired.

An example SSL system can include multiple light emitting panels mounted on movable arms which can be adjusted to tilt the light emitting panels. The mounting system can be adapted as desired to allow any range of motion, rotation, etc. In some embodiments, multiple attachment points can be used on each light emitting panel to control position, tilt, etc. In some other embodiments, a single attachment point is used with a controllable mount, such as a motorized gimbal, on each light emitting panel, enabling each light emitting panel to be independently positioned, tilted, rotated etc.

The present invention may be used as a light source for multiple purposes including as a reading lamp, as a task lamp, as an ambient lamp, as a circadian rhythm regulator and adjuster, etc., an entertainment and mood lamp, emergency indicator or other indicator, guide light by shining or flashing different colors to indicate one or more paths simultaneously, sequencing including temporally sequencing the lighting to indicate directions to follow/take/etc., turning different parts including light source parts to indicate a direction or path, etc. to follow, a status indicator by shining various colors in various locations according to conditions to be identified, etc. Such emergency or identification or guide or other functions can be performed in combination or conjunction with other functions, including simultaneous lighting such as combining white illumination with colored indicators.

An example of the present invention includes, but is not limited to, a light source for train, bus, airplane, ship, boat, yacht, recreational vehicle (RV), SUV, limousine, van, submersible vehicles including, but not limited to, submarines, Navy boats, commercial jets, plant growth, etc.

The present invention can be used to produce various effects in, for example, a long distance travel by train, boat or plane in which the users can choose from soothing or exciting colors, certain wavelengths of light to help induce, reset, etc. circadian rhythms and melatonin production or suppression, etc., to address SAD conditions, to provide one or more types of light therapy, to provide a calming or exciting ambiance, to affect mood, emotions, sleep, rest, enjoyment, ambiance, environment, relaxation, alertness, focus, attention span, etc.

The present invention can be used, for example, on a commercial airplane to allow the passenger to adjust the local lighting by using, for example, Bluetooth, WiFi, or any other wireless method, way, protocol, etc. to, for example, communicate with the light/lamp to dim, change color temperature, change color or combinations of colors to change white color temperatures, to provide alerts, alarms, mood setting, light therapy, turn off, turn on, tilt, and/or combinations of these, etc.

The present invention can be attached/embedded/incorporated/integrated/etc. into a fan, including, but not limited to, a ceiling fan that in some embodiments can change speed and light intensity and/or colors as it rotates. The LED and/or OLED and/or QD lighting can be incorporated/attached/embedded/etc. on one or both sides of the fan blades as well as other parts of the fan.

As an example of the present invention, a 12 channel driver can separately and independently supply and wirelessly control (i.e., dim) each color of four RGB or three RGBA or RGBW SSL panels as well as 12 individual monochrome (e.g., white or other color) SSL panels, and/or a mix and match combination of both color, color-changing and/or white SSL panels. Of course more or less channels can be implemented.

The present invention can implement building block power supply approaches that can be mated with and sold with SSL panels, lightbars, lamps, strings, etc. as SSL lighting kits.

The driver electronics for the color changing/tunable SSL lighting allow, among other things, flexible, selectable lighting including warm, cool, daylight, etc., white light choices for residential consumers and business customers. These drivers also permit and support remote dimming, control, monitoring, data logging as well as analytics.

All of the above can be wirelessly interfaced, controlled and monitored using, for example, smart phones (i.e., iPhones, Androids), tablets (i.e., iPad, iPod touch, Droid, Kindle, Samsung, Dell, Acer, Asus, etc. tablets), laptops, desktops and other such digital assistants.

Universal drivers can also be used to support Triac and 0 to 10 Volt dimming as well as optional powerline (PLC) and wired and/or wireless remote control. As another example, the DC input power supply can support 0 to 10 volt dimming and can have optional wired and/or wireless control and monitoring.

Some embodiments of the present invention include power supplies and drivers specifically focused on OLEDs that address both the rather unique properties of OLEDs compared to, for example, even LEDs. In general, both OLEDs and LEDs should be current control driven—that is to safely operate both LEDs and OLEDs the power source should be current controlled and regulated as opposed to, for example, applying a constant, regulated voltage to the OLEDs or LEDs.

In general LEDs are point sources made up of certain mixtures/alloys of III-V semiconductors based, for example, binary gallium arsenide (GaAs) and gallium nitride (GaN) forming ternary alloys such as, but not limited to, aluminum gallium arsenide (AlGaAs) and aluminum gallium nitride (AlGaN). These and other such alloys allow a vast number of nearly single wavelength with a relatively small full width at half maximum (FWHM) optical emission which can include optical emission wavelengths that are visible to the human eye and are perceived as colors. White light LEDs can be achieved in a number of ways including color combining single color LEDs such as red, green and blue LEDs or using phosphors or QDs to perform wavelength conversion(s). LEDs are two terminal point source emitter devices which emit light when an electrical stimulus is applied. LEDs can be easily formed into parallel and/or series configurations occupying relatively small areas. OLEDs, on the other hand, are made of molecules that also emit light when electrical stimulus is applied. However, unlike LEDs, OLEDs are designed and configured as area sources and not point sources. There are a number of ways to also obtain white light OLEDs including homogenously mixing at, for example, the nanometer level red, green, blue or red, yellow, blue or other combinations of OLEDs, stacking layers of various colors of OLEDs vertically on top of each other, having stripes of various colors placed laterally close to each other, etc.

With LEDs, typically both the cathode and anode are available for, for example, each individual LED color to be connected in parallel and/or in series either individually or in groups/arrays/etc. such that often there are only two electrical power connections from the power to the LEDs and therefore the power supply/driver output and output connection configurations are often much simpler and more universal for LEDs than OLEDs. Of course, with the continued widespread growth and use of LEDs, there are and will be numerous exceptions to just the two connections per LED fixture or luminaire although such a generalization usually applies to LED lights and lamps such as, but not limited to, GU10, MR16, A Lamps, PAR 30, PAR 38, R30, T4, T5, T6, T8, T9, T10, T12, PL 2 and 4 pin, etc. and other SSL/LED/OLED/QD/etc. lamp replacements. Unless there is only one OLED panel that has only two electrode connections for a given lighting application, an optimized power supply design for multi-electrode (i.e., more than two electrodes) OLED panel(s) can involve consideration of a number of factors including, among others, ensured proper current sharing, size/gauge of wires used, over-current protection, over-voltage protection, individual OLED panel fault detection/correction, OLED lifetime aging, OLED differential color aging (e.g., blue color lifetime being lower than typically other OLED colors), whether to put multiple OLED panels in parallel or series or combinations of both, voltage drops in the interconnect wiring between the power supply and the OLED panels for OLED fixtures and luminaires.

The present invention provides solutions that include OLED lighting kits that would include power supplies/drivers, connectors/interconnects and OLED panels that are all designed to be mated to each other. In addition interfaces can provide significant assistance and aid in connecting multiple OLED panels to power supplies and drivers safely and correctly. This simple interface will use an OLED identification system that allows the power supply/driver and each of the individual OLED panels to communicate with each other in a similar but much simpler (and slower) fashion as, for example, the Telecommunications Industry Association/Electronic Industries Alliance (TIA/EIA) 485 also known as RS485 interface (which is also the basis of, for example, Modbus, Profibus, DMX512, etc.) 2 wire systems.

In addition, articulating desk lamps with one or more rotatable solid state lighting panels can be provided in some embodiments of the invention. As a non-limiting example, a desk lamp can include one or more support members connected by hinges and mounted by a rotating sleeve to a base, allowing the lighting panel to be pointed in any desired direction. The support structure is not limited to any particular articulating arm assembly, but can include any device or assembly suitable for positioning and orienting the lighting panel, such as, but not limited to, a ball and socket chain, gimbaled arm, etc. A power supply/dimming control circuit can be provided to power and control the lighting panel and can be positioned in any suitable location, such as in the base. An IR receiver and/or other wired or wireless connection can be provided to link the desk lamp to other parts of an automation system, enabling the illumination level, color, on/off state to be controlled, scheduled, sequenced, etc. This can also be applied and used with the inventions disclosed in PCT Patent Application PCT/US16/69054 filed Dec. 28, 2016 for “Personalized Lighting Systems” which is incorporated herein by reference for all purposes.

In some embodiments of an articulating desk lamp the position and/or orientation of the lighting panel can be automatically controlled. The desk lamp includes one or more support members connected by hinges and mounted by a rotating sleeve to a base, allowing the lighting panel to be pointed in any desired direction. In some embodiments the position can be controlled by motors such as stepper motors, DC motors or other actuators. For example, IR receivers are provided on the motors and/or motor controllers in some embodiments to remotely control/schedule motor movements. Encoders, decoders, etc. can be used to monitor, track, store, record, remember, replay, spin around, spin in circles, control speed, angular speed, velocity, angular velocity, movement, angular position, angular position, acceleration, angular acceleration, spinning at various speeds including relatively very slow to relatively fast speeds, move to, etc. existing and previous positions, locations, etc. and can also be used to respond to, interact with, track, move, position, speed, velocity, acceleration, pitch, etc. the present invention based on, for example, but not limited to one or more inputs, information, sensing, detection, time of day, date, ambient temperature, light intensity, movement, proximity, location, GPS information, atomic clock information, people animals, plants, insects, heat, cold, temperature, thermal gradients, thermal leakage, fire, smoke, gases, etc.

Lamps used with the present invention can have any shape, configuration, size, materials, etc. For example, a light emitting panel can be mounted in a support frame or mounted more directly in a sleek form factor. A desk lamp in general of any type and form can be incorporated into groups, systems both individually and/or collectively and, for example, but not limited to, can include one or more support members connected by hinges and mounted by a rotating sleeve to a base, allowing the lighting panel to be pointed in any desired direction. The support structure is not limited to any particular articulating arm assembly, but can include any device or assembly suitable for positioning and orienting the lighting panel, such as, but not limited to, a ball and socket chain, gimbaled arm, etc. A power supply/dimming control circuit can be provided to power and control the lighting panel and can be positioned in any suitable location, such as in the base. An IR receiver and/or other wired or wireless connection can be provided to link the desk lamp to other parts of an automation system, enabling the illumination level, color, on/off state to be controlled, scheduled, sequenced, etc. In some embodiments the position can be controlled by motors such as stepper motors, DC motors or other actuators. For example, IR receivers are provided on the motors and/or motor controllers in some embodiments to remotely control/schedule motor movements. Encoders, decoders, etc. can be used to monitor, track, store, record, remember, replay, move to, etc. existing and previous positions, locations, etc. and can also be used to respond to, interact with, track, move, position, etc. the present invention based on, for example, but not limited to one or more inputs, information, sensing, detection, time of day, date, ambient temperature, light intensity, movement, proximity, location, GPS information, atomic clock information, etc.

It should be noted that the basics and essentials of the OLED desk lamp including color, multicolor, color plus white, multicolor plus white, various colors and ‘shades’ of white, amber and/or blue OLEDs and/or LEDs or QDs, etc., combinations of these, etc. can be modified to produce and be used in, for example, under-cabinet lighting for kitchens, bathrooms, vanities, etc. as well as accent and sconce lighting.

Additional features and functionalities can be added to the OLED desk, task and table, sconce, under-counter and over/above-counter lighting including but not limited to proximity detection, daylight harvesting, voice recognition, voice detection, proximity, heat, thermal, other ways, methods, techniques, approaches, etc. discussed herein, combinations of these, etc.

The OLED power supplies and example associated innovative lighting and luminaire applications including the circadian rhythm cycle regulation lighting system can also be portable OLED or LED lighting that can be charged by AC, direct current (DC) or solar power/energy sources. Such innovative OLED and LED lighting can be used for camping, emergency, outdoors, indoors, and general portable, etc. compact and rechargeable illumination applications including circadian rhythm regulation, SAD and other types of light therapy applications in these varied environments, etc. With properly designed high efficiency power supplies/drivers, portable OLED and LED lighting sources provide highly innovative, attractive, flexible and even colorful and also entertaining lighting as well as being lightweight and able to support novel shapes and form-factors while still providing circadian rhythm cycle regulation that can be individually modified and adjusted for these and other (e.g., work time, work space, shift time, etc.), environments.

The present invention includes OLED power supplies and associated innovative OLED lighting for desk, and task applications and innovative color changeable OLED RGB (or RYB, RGBA, RTBA, RGBAW, RGBYW, etc. and/or additional colors, etc.) power supplies and drivers. The embodiments of the present invention are very flexible in design and application space.

The present invention includes power supplies for OLEDs, LEDs, QDs, etc. including ones designed for universal AC or DC input voltages and Triac and other dimming formats including 0 to 10 V, powerline, wireless, etc. Such power supplies can be adapted to be highly efficient. Embodiments of the present invention include a number of high performance power supplies and drivers for both monochromatic and multiple color/color changing/color tunable OLED lighting panels, including for example 12 channel common anode and/or common cathode OLED drivers that can be individually addressed and controlled/dimmed by wired and wireless interfaces and smart dimmable OLED desk/task lamps. Matched and mated power supplies/drivers for OLED and OLED panel kits can also be used for:
Highly efficient OLED lighting.
Flexible OLED lighting.
Do-It-Yourself (DIY) building block kit products to significantly expand the usage of OLED lighting applications and markets.
Smart/Intelligent OLED products
Wide range of AC and DC power supply/driver for OLEDs products
Color changing OLED products
Low, medium and high power OLED products
Low cost OLED power supplies and drivers
OLED products aimed at specialized and specific applications, products and markets
High performance OLED products
Task/table/kitchen/closet/compartment, sconce, accent lighting OLED products
Individually personalized OLED products
Energy saving LED light
Color changing
Color tuning
Voice command
Gesturing and proximity detection
Health and Happiness and Entertainment
Retrofit or new construction

A circadian rhythm management lighting system with a wearable monitor can be provided in accordance with some embodiments of the invention. In some embodiments, the wearable monitor is a circadian rhythm detector or detectors. A master coordinator and control unit receives data from the wearable monitor and controls LED and OLED lighting, in some embodiments comprising portable lighting, based at least in part on the data sensed by the wearable monitor including FitBit, Apple, Nike, etc.

In an example embodiment of the present invention, portable wireless controlled lighting for the circadian rhythm regulation system can be set to white, blue (for wake-up), green, red, yellow (for blue-free light to promote sleep) and amber-orange (also for blue-free light to promote sleep).

To appropriately synchronize daily rhythms in behavior, physiology and brain functioning with environmental time, terrestrial species have evolved an endogenous, circadian timekeeping system. Circadian rhythms are generated by a hierarchy of central and peripheral oscillators with the suprachiasmatic nucleus (SCN) of the anterior hypothalamus acting as the master circadian pacemaker. The circadian system evolved such that environmental light input from the retina synchronizes internal timing, with the daily environmental cycle of sunlight and darkness as the primary time setter and keeper.

The use of artificial lighting has led to unnatural light exposure, and persistent pattern changes have impacted circadian rhythms and sleep physiology. The use of artificial lighting can lead to some degradation of mental and physical health among human populations. For example, flight attendants frequently traveling across time zones exhibit gross cognitive deficits associated with reductions in temporal lobe structures. Likewise, numerous studies indicate that circadian disruption leads to an increased incidence of cancer, diabetes, ulcers, hypertension and cardiovascular disease, and a degradation of mental health. Exposure to certain types of artificial light at night can result in circadian rhythm misalignments leading to cognitive decline, increased incidence of depression and anxiety disorders, and a host of metabolic disorders. There are concerns regarding circadian rhythm misalignments as they are known to affect response time, judgment and planning, as well as psychomotor skills, and can increase the prevalence of certain illnesses and chronic issues.

By developing strategies to correct/mitigate disruptions to circadian function and misalignment between endogenous cycles in circadian and sleep physiology with the external environment (e.g., following jet lag, shift work, night work, etc.), one can recover diminished human performance as well as improve human health, reduce risk of disease, and enhance cognitive functioning and performance Strategies that use pharmacological approaches or bright light presentation are often largely ineffective, as chronotype, circadian phase and amplitude, and other variables that vary largely across individuals are not considered in the treatment regimen. For example, a wearable device can be used with a wireless system that can be utilized as a personal circadian rhythm monitor and regulation device capable of rapidly realigning the circadian rhythm of users to the local environment. In other situations the system adjusts the user to the work, mission or sleep cycle requirements, leading to improved sleep and performance. The lighting system continuously measures and collects data indicative of circadian phase and uses these data to drive the presentation of light of appropriate wavelengths during optimal times in the circadian cycle known to maximize circadian adjustment and sleep quality. Additionally, the data the device collects is self-reported with data from other wireless monitors of sleep quality for periodic examination of cognitive function and decision making to further enhance light presentation.

An integrated solution of circadian rhythm estimation and light-based circadian rhythm adjustment allows effective regulation of circadian rhythms and avoidance of circadian misalignment, leading to improved health, sleep and performance. The present invention includes an optional integrated wearable device coupled with a wireless system that can be utilized as a personal circadian rhythm monitor and regulation device/system capable of rapidly realigning the circadian rhythm of service members to the local environment or, depending on the situation, aligned to provide an artificial environment to ensure both the rhythm of light and user are in sync with the rhythm of activity and sleep, leading to improved sleep and performance. This device and system continuously measures and collects physiological signals, synthesizes them into continuous circadian rhythm estimation, monitors the ambient light to detect circadian misalignments, and controls artificial light presentation. Secure storage of the data set is on the device/system to allow the user and, with proper approval(s), health professionals to perform further evaluation. The data set includes collected physiological signals, estimated circadian rhythm data, and circadian light monitor control information, as well as user input on self-assessed sleep quality and alertness. The host system can include mobile devices including but not limited to Smart phones, user/operator control stations or integrations into platform avionics suites and work environments. Integration, portability and interoperability across these platforms and their advanced performance management/training environments are important considerations. The present invention can also be used for SAD and other light therapy applications.

The present invention is on lighting systems that can interface with technologies to regulate circadian rhythm for health and performance that can, for example, include a low cost, human wearable system that includes at least two and typically/optionally more than two connected components: the first accurately monitors the user's circadian rhythms to produce reliable circadian phase and amplitude markers and the second is an integrated light presentation unit whereby the timing, wavelength, and intensity of light is driven by the data collected from the first component. The present invention can also be used for SAD and other light therapy applications.

The present invention can be used to increase the effectiveness of utilizing an integrated system and its impact on real-world outcomes of circadian rhythm regulation, sleep, and alertness including accuracy, reliability, and usability of the devices in the system as well as those suffering from SAD and other maladies, diseases, disorders, illnesses, dementia, muscle, physiological or brain disorders, etc.

The present invention can be also be utilized for personal circadian rhythm regulation by synthesizing physiological signals into a circadian rhythm estimate and adjusting the circadian rhythm control light input based on the estimate. The lighting system seamlessly integrates with other peripheral device(s), web-based and Smartphone applications, and provides additional feedback and monitoring tools for long-term health assessment. In addition, the lighting system has numerous uses for various commercial consumers for improving general health of shift workers, students in classrooms, hospital patients, and workers in controlled lighting areas, sleep deprived individuals and aviation operators, including both aircrew and passengers.

Implementations of the present invention include a master coordinator/controller (MCC) that wirelessly receives information as input from the circadian rhythm detector device(s).

The present invention can include wireless commands to control the lighting sources to be able to regulate and entrain the circadian rhythm cycle. Wireless control signals can be transmitted from the MCC to the lighting sources to include light emitting diodes (LEDs) and organic light emitting diodes (OLEDs) and quantum dots (QDs) using appropriate libraries, class(es), frameworks, object oriented languages, etc.

The present invention includes cost-effective, portable, accurate, and transparent methods to monitor, assess, maintain, regulate, realign, and if necessary, reset the circadian rhythm of a person to help ensure optimum health and performance.

The Master Coordinator Control (MCC) unit can be adapted to store, interpret, analyze, and transmit control signals to the lighting modules to apply the range of wavelengths necessary to modify (e.g., for maintaining, resetting and entraining) circadian rhythms

In some embodiments the circadian rhythm management lighting system with a wearable monitor is adapted to communicate wirelessly with controllers such as a smart phone, tablet, etc. A master coordinator and control unit (MCC) communicates with the wearable circadian rhythm detector(s) via the smart phone/tablet, with either one-way or two-way communications with the smart phone/tablet also acting as an optional method and way to display circadian rhythm and the circadian rhythm regulation system information and data, including those for the control and monitoring of the lighting and other environmental information. Other embodiments of the present invention can also be used for SAD and other light therapy applications.

The light sources can include light emitting diodes (LEDs) and organic light emitting diodes (OLEDs) and quantum dots (QDs) including ones that are designed to install in conventional legacy light sockets and fixtures and/or portable light sources. Embodiments of the present invention can be implemented whereby the MCC communicates with wirelessly-controlled lighting that fits directly into conventional legacy light fixtures (without any changes in the electrical wiring or overhead lighting or lamp design). These LED and OLED lighting sources can change from (non-color) ‘white’ light illumination to any color combination of white light plus primary colors such as, but not limited to, red, green, blue (RGB) or red, green, blue, amber (RGBA) or other color temperatures of white depending on the needs indicated by the MCC unit. The MCC or other controllers control features and functions including alarm clock mode, scheduling, synchronization with local time, daylight harvesting and occupancy sensing, etc. These LED and OLED and/or QD light sources are inherently portable, can be fully deployed typically in a time frame of minutes and is easily system integrated to work locations in conjunction with wearable circadian rhythm (CR) devices to provide light feedback for the circadian rhythm regulation and performance systems. In addition they are rugged, highly reliable, provide controlled dimming and can withstand repeated on/off cycles with no impact on life expectancy. In example embodiments with three color red, green, blue (RGB) or RGB plus amber (RGBA) OLED panels, each individual color can be obtained by turning off the other two colors. To facilitate wake onset and morning circadian phase resetting, a lighting choice with a significant blue color component is selected. To promote sleep onset and permit the nightly evening rise in melatonin a color choice essentially devoid of blue color is selected.

Firmware and software frameworks for bioinformatics, signal processing and interpretive feedback control can be used with the present invention. The software framework can be designed to be interoperable and multiplatform compatible, and incorporate protections for personally identifiable information and health care privacy regulations and to run on a number of platforms including smartphones and tablets running iOS, Android, and Windows Phone operating systems, computers and laptops running Windows, Linux and Apple operating systems as well as having web interfaces. All data regarding individual users can treated and designed to be kept private with encryption and tamper-resistant access permission.

Alternatives and complimentary control effectors such as acoustic spectra, magnetic fields, acupressure, electrical signals, or aromatics can also be included. The wearable circadian rhythm detector can include any suitable sensors, such as, but not limited to, motion sensors or biosensors to track sleep patterns, heart rate sensors, muscle movement sensors, brain activity sensors, blood pressure sensors, oximeters, etc. The present invention can be used in environment(s) that can be highly variable (e.g., while sleeping, traveling, portable locations, etc.) as well as fixed environments (home, barracks, longer-term temporary quarters and housing, etc.).

The functions of the system can be implemented and distributed among system elements in any suitable manner. For example, some embodiments of a circadian rhythm management lighting system include a wearable monitor, LED and/or OLED portable lighting modules or other light sources, and a master coordinator and control unit in direct communication with smart phones, tablets, laptop computers, other computers, etc. Notably, in some embodiments the user can also self-report information using the smart phone/tablet which can also act as an optional way to display circadian rhythm and the circadian rhythm regulation system information and data including for the control and monitoring of the lighting and other environmental information. Other embodiments of the present invention can use sensors, detectors, IOT, etc. including but not limited to optical, light, spectral, etc. sensors including but not limited to those herein to work with the control and monitoring discussed herein or be part of or the control for the functions, operations, features, etc. discussed herein.

The present invention lighting allows virtually any level and ‘size’ of lighting from highly compact lighting that is only a few inches square weighing much less than one pound that can be powered by, for example, batteries to SSL/LED lighting that can be quickly and easily installed in bedrooms, entire houses and apartment buildings to office buildings of practically any size.

Implementations of the present invention allow comparison of circadian rhythm or phase information from commercial off the shelf (COTS) systems whether currently known or developed in the future, as well as devices with well-established markers of circadian phase, including dim light melatonin onset (DLMO) through salivary measures and sleep midpoint analysis.

Implementations of the master coordinator/controller (MCC) wirelessly receive information as input from the circadian rhythm device using any means, including but not limited to WiFi, Bluetooth of all types and flavors, Zigbee of all types and flavors, ISM, WeMo, hubs, gateways, bridges, Link, Wink, LiFi, other wireless, wired, etc. discussed herein, and Near Field Communications with added channels and/or drivers as desired. The MCC receives signals from smart phones, tablets, laptops, desktops, etc., and the wearable circadian rhythm detection device(s) are in some embodiments able to communicate with, for example, a smart phone, tablet, etc. Sensors, such as cameras and motion detection, can also be used in embodiments of the present invention. Industrial, scientific and medical frequency (ISM) bands and additional sensors as desired can be included in the MCC module. Smart Phone+MCC modules that are portable inexpensive, high powered, optimized can also be used. Software apps can be used to gather, transfer and transmit the pertinent information from the wearable circadian rhythm sensor(s) that is periodically or continuously transmitted to the mobile device and MCC module.

The present invention allows for the ability to integrate, log, archive and catalog data. Data management for collected physiological signals, estimated circadian rhythm, user performance metrics and circadian light modifier control signal information can be used to determine the storage details of how and where the collected physiological signals, estimated circadian rhythm, circadian light control information, the sensor(s) information, the information gathered from the circadian rhythm detector(s), and the control status information along with date, time and location stamps is stored (e.g., in Flash memory, solid-state drives, USB ‘thumb’ drives, SD cards, hard drives, etc.), hard drives, and other types of storage devices. This information can also be synced up to store on additional mobile devices, PDAs, computers, laptops, etc. to, among other purposes, allow health professionals (with privacy protection) further evaluation.

Example features and functions including, as an example, an alarm clock mode with blue wavelength light content to facilitate waking and to and maximize circadian rhythm phase alignment which could also contain amber wavelength or other wavelengths suitable for use near or at or even during sleep time including in hospital, other care-giving facilities, dormitories, schools, overnight camps, military installations, retirement homes and facilities, convalescent facilities, urgent care facilities, recuperation locations and facilities including temporary, mobile, and permanent ones, etc., combinations of these and other discussed herein, etc.

In some embodiments, timing of light presentation and wavelength can be run through a simulation to determine the anticipated impact on circadian phase based on existing models of human circadian functioning. The MCC can be modified or adjusted accordingly if there is incongruence between the timing of light presentation and the required adjustments in circadian phase.

The white plus color changing lighting or white changing plus color changing light can be controlled such that, for example, the white and blue LEDs can be selected (enabled) or deselected (disabled) depending on the phase of the circadian rhythm and other measured and available signals and information or to support SAD or other light therapies.

Wireless commands are used to control the lighting sources to regulate and entrain the circadian rhythm cycle. For example some embodiments can use wireless-controlled white plus color-changing or white color changing plus color-changing LED and/or OLED lighting (including, but not limited to, A-lamp, PAR 30, PAR 38 R30, R40, MR16, GU10, both high and low voltage track lighting, magnetic lighting, 1 ft., 2 ft. 3 ft., 4 ft., 5 ft., 6 ft., and longer linear fluorescent lamp replacement LED tube lamps, PL 2 and 4 pin, U shaped fluorescent lamps, etc., combinations of these, sconces, under-cabinet, over cabinet, wall lights, ceiling lights, night lights, marker lights, HID lamp replacements of all types and forms, etc., combinations of these, etc.) to work with the MCC prototype unit.

Existing sensors including daylight harvesting sensors, other photo/light sensors, motion/occupancy sensors, other environment/ambient sensors, etc. can be used with the present invention. The circadian rhythm regulation system can prompt, notify, alert the user if an inappropriate light source such as, for example, a smart phone/tablet or television set is detected that is emitting inappropriate wavelengths for that part/phase of the circadian rhythm cycle. If the user does not respond to the prompts, notifications and/or alerts, the circadian rhythm regulation system will attempt to modify the offending light source to be circadian rhythm cycle phase-compliant. Such prompts can be sent to, among others and not limited to, family, friends, medical staff, hospital staff, doctors, care givers, emergency responders, etc. by any means including but not limited to cell phones, land line phones, smart phones, mobile phones, tablets, computers, answering machines, text messages, e-mails, pictures, etc., more than one of these, combinations of these, other methods, ways, etc. discussed herein, etc.

Software apps can be used to gather information including geographical location, time zone, ambient light, settings of in-use digital devices including cell/smart phones, tablets, laptop computers, desktop computer displays and monitors, (if possible) televisions, MP3 players, etc. The system uses this information to adjust the display settings to support circadian rhythm cycle alignment and circadian rhythmicity and to avoid or mitigate circadian desynchrony and circadian disruption as well as treat SAD and provide other types of light therapy.

Embodiments of the present invention can include low-cost portable battery-powered/solar powered optical color ‘notch’ filters so as to be able employ these color filters as and where needed to provide additional optical sensory information and feedback to the MCC unit to aid in circadian rhythm regulation.

Some embodiments of the present invention thus provide a means to improve circadian rhythm, SAD, and other illnesses, diseases, disorders, etc. discussed herein by, for example, but not limited to, providing the appropriate wavelengths of light at appropriate times, based on data from sensors and/or information gathered from various sources and control interfaces, including but not limited to:
Internal and external photosensors including wavelength specific or the ability to gather entire or partial spectrums
Atomic clock(s) signals
Other broadcast time signals
Cellular phone times
Smart phone, tablet, computers, personal digital assistants, etc.
Remote control via dedicated units, smart phones, computers, laptops, tablets, etc.

The present invention can be used in general for all types of light therapy including but not limited to circadian rhythm light therapy, SAD light therapy, and other types of light therapy to assist with, treat, improve, etc., illnesses, diseases, cancers, disorders and general well-being.

Particular embodiments depicted and disclosed herein are merely examples and are not intended to be limiting, but can use a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level. The circuits remove the requirement that a reference level and a comparison to the reference level are required to detect the amplitude of the waveform.

An AC input can be connected, for example, to the pins in a fluorescent light fixture, either with a ballast in place or in some embodiments removed/bypassed. Fuses provide protection, and AC coupling capacitors are provided in some embodiments at the input. A diode bridge rectifier rectifies the AC input, yielding a Pre_LEDP voltage. A series diode is provided in some embodiments, yielding output voltage LEDP to output. A filter capacitor can be provided across the output between output nodes LEDP and LEDN. In some embodiments, a current sense resistor is provided in series with the output. In other embodiments, a variable impedance can be used to control implementations of the present invention.

In some embodiments, a startup sequence circuit for a solid state fluorescent replacement can be included. The startup sequence circuit generates a pulse sufficient to allow ballasts of certain types including certain rapid start ballasts to operate correctly.

In some embodiments, a startup power detection circuit can be included, such as, but not limited to, that disclosed in PCT Patent Application PCT/US15/32763 filed May 27, 2015 for “Lighting Systems” which is incorporated herein by reference for all purposes.

The present invention can be used to provide the electronics for a direct fluorescent lamp replacement that uses for example LEDs or OLEDs or both or QDs or combinations of these, etc. The AC (low 50 or 60 Hz) frequency or electronic ballast (high typically ˜30 to 100 kHz) frequency can be detected using for example but not limited to a microprocessor, microcontroller, FPGA, DSP, ASIC, IC, etc. or combinations of these, etc.—such a detector (using for example a microcontroller or microprocessor, etc.) can also be used to provide the functions disclosed herein.

As some ballasts perform various status, fault, failure, protection detection, sensing, and correction, embodiments of the present invention provide the necessary electronics, circuits including either in analog and digital (or both) implementations and associated firmware/software if needed to provide the proper sequence so that the ballast performs properly with the present direct replacement LED FLRs including rapid start ballasts. For example, circuits in the startup sequence circuit generate a pulse sufficient to ballasts of certain types including certain rapid start ballasts to operate and provide power to the present invention. In addition remote operation including dimming or intensity level changes can be performed, as well as remote monitoring. Remote dimming/level changes can be accomplished for example by, for example but not limited to, inserting the output of a wireless receiver either with a built-in or separate digital to analog converter (DAC) such that the DAC is controlled by the received information from the receiver such that the output of the DAC which is connected to the input of resistor provides the programmable/controllable reference signal/voltage used to set the output current to the LEDs or OLEDs for these embodiments of the direct replacement FLR present invention. An RC circuit can be used to provide a temporary recharging voltage should the DAC (and therefore the output current) be commanded to zero. Notably, more than one DAC can be included for, for example, multi-channel uses in/with the present invention as well as analog to digital converter(s) (ADC(s)) to read various settings and operational info and report this back for example using a transceiver or transmitter, etc.

Low voltage (12 V) AC and DC lighting systems and components including MR16 can also be used for the present invention including RGBW and the use of RGBAW (i.e., R and/or A (amber) and in some cases G to produce yellow for night time, sleep time, sleep, etc. mode and BW to produce light suitable for wake up mode) as well as RGBW and the use of RGBAW with more than one white color temperature which can be in any form and could include but is not limited to a wireless or wired or powerline control (PLC) receiver, transceiver, transmitter, etc. Although a low voltage MR16 was discussed, the present invention also equally applies to all types and forms of general lighting including, but not limited to, GU10, A-lamps, E26 socket lighting, E27 socket lighting, PAR30, PAR38, R30, T12, T10, T9, T8, T5, T4, PL 2 and 4 pin, etc. and other types and forms of SSL/LED/OLED/QD lighting.

The RGBW can consist of discrete LEDs or packaged LEDs of any size and form and also could consist of additional colors and quantities such as RGBWA, RGBWB, multiple white (W) color temperatures, etc.

The present invention also includes dies of any type and form and arrangement that consist of four or more LEDs in which one of the LEDs is white—again, for example, RGBW, RGBWA (or RGBAW, etc.). The package, substrate, die, etc. that the four or more LEDs with one LED being white (e.g., RGBW) include plastic, ceramic, composite, polymers, metal, etc., combinations of these, etc. The ceramic(s) can be of any type including but not limited to oxides, nitrides, etc. such as aluminum oxide, sapphire, quartz, aluminum nitride, beryllium oxide, boron nitride, etc. Any shape can be used including essentially round, square, rectangular, elliptical, parabolic, semi-circle, semi-sphere, sphere and other standard and non-standard essentially 2 and 3 dimensional shapes and forms, etc. Two wires/pads/pins/etc. may be used per LED color or some wires/pads/pins/etc. may be reduced to reduce count, etc. for example, but not limited to, common anode or common cathode arrangements, etc.

If heat sinking is insufficient to support high power RGBW then the present invention can automatically insure that the power is either scaled back for all channels or automatically turn off, for example, the white channel or other color channels and keep the white channel on or dim one or more channels including color and/or white channel(s). In emergency or other types of situations, such heat management control may be overridden to produce additional light (i.e., higher lumens), etc.

For any of the present inventions discussed herein, power supplies of any type, form, topology, architecture, etc. including but not limited to non-isolated and/or isolated power supplies and drivers such as buck, buck-boost, boost-buck, boost, Cuk, SEPIC, forward converters, push-pull, current mode, voltage mode, current fed, voltage fed, one-stage, two-stage, multi-stage, high power factor, linear, switching, resonant converters, half bridge, full bridge, combinations of these, etc.

Embodiments of the present invention include multi-panel configurations including parallel (i.e., same voltage, shared total current through each panel) and series (i.e., same current, stacked voltage). Currently most OLED panels, whether single or multi-color, operate at a total voltage of less than 10 VDC and are typically connected in parallel. White-changing OLED panels also provide a certain subset of color changing/tunability. The circadian rhythm lighting and/or SAD and/or light therapy products can use the white-changing/tunable OLED panels to provide blue wavelength enhanced lighting for the ‘wakeup’ and blue wavelength depressed lighting for the ‘sleep-time’ for example, by using layered blue OLEDs and yellow (or amber or orange or similar wavelength color) OLEDs, respectively in any method including layered on top of each other or side-by-side stripes/strips, etc. These respective OLEDs can be color-tuned/turned on, for example, by providing an appropriate current (or in some cases, voltage) to certain electrodes turn on and excite the proper and desired color or colors depending on the particular point and phase in the circadian rhythm cycle. Implementations of the present invention for both fixed and portable circadian rhythm applications include, but are not limited to, main lighting, under-cabinet and over cabinet lighting for bedrooms, reading rooms, living rooms, dens, family rooms, offices, barracks, hotels, hotel rooms, motel rooms, bed and breakfasts, office buildings, kitchens, bathrooms, etc., desk, table, task, reading, and portable lamps/lights, accent lamp/lights and special environment lighting and other discussed herein, etc. Some embodiments of the present invention apply multiple floating output current control to driving the respective OLEDs/LEDs/QDs/other forms of SSL, etc., combinations of these, etc.

LEDs, OLEDs, QDs, light sources and panels that are color changing, blue enhanced and blue depressed (for example, but not limited to, orange, amber, yellow, reddish, red, etc.), white changing and special purpose OLEDs can be used for circadian rhythm cycle regulation and assistance and/or SAD and/or other lighting described herein as well as for medical, cleanroom, warehouse, office space, museums, event-spaces, multi-use, multipurpose, gyms, classroom, nursery, prenatal care, urgent care, long term care, critical care, intensive care, architecture design, etc. and, general lighting, etc.

The present invention applies to OLEDs, LEDs, QDs, other types of SSLs, combinations of these, etc. in general including white and other fixed color, white-changing, color-changing and multi-color, multi-panel applications including OLEDs of any type including but not limited to stacked, layered, multi-electrode, striped, patterned, etc., OLEDs and edge emitter, edge lit, and waveguided LEDs, QDs, etc.

All of the above can be wirelessly interfaced, controlled and monitored using, for example, smart phones (i.e., iPhones, Androids), tablets (i.e., iPad, iPod touch, droid, etc.), laptops, desktops and other such digital assistants and also other dimming including 0-10 Volt dimming and powerline (PLC) dimming/control. The universal drivers can also support Triac and other forward/reverse phase cut dimming.

In some embodiments a quasi-uniform lighting panel is provided using an array of solid state point light sources such as LED's, QD's, etc., thereby simulating a lighting panel such as an OLED. Electrical connections can be provided around edges of the panel or in any other suitable manner, providing power and control/addressing of individual point light sources or groups of point light sources. For example, LEDs of different color groups can be controlled as groups in some embodiments. The light sources can be positioned in a rectilinear array or in any suitable pattern, and can have any number of colors, RGBW, RGBWA (or RGBAW), with one or more white (W) color temperatures, etc., different colors than RGB including mint, cyan, purple, pink, amber, yellow, etc., more than 3, 4, 5, 6, etc. colors, combinations of these, etc.

An array of LEDs in an OLED equivalent array lighting panel can be included in accordance with some embodiments of the invention. LEDs can be mounted so that they are facing down onto a reflective surface, thereby producing a no-glare OLED equivalent. One or more LEDs may be positioned in each location. In some embodiments of the present invention, more than one color LED may be used. Embodiments of the present invention can provide one or more colors including, but not limited to, two colors such as blue and amber/yellow, multi-colors, RGB, 3 colors, more than 3 colors, monochrome, white, RGBA (where A is amber), RGBW (where W is white), RGBWA, RGBWA plus additional colors, etc. The LEDs can be wired in series and/or parallel and/or combinations of these. The LEDs can be at the corners, along the sides, through inserts into the reflective surface, etc.

In some embodiments the solid state lighting is embodied in fluorescent tube replacements, such as, but not limited to, T4, T5, T6, T8, T9, T10, T12, PL 4 pin and 2 pin etc. An example embodiment of a FLR includes a single strip of LEDs mounted on a printed circuit board between end caps. One or more mounting/connection pins are provided at each end. A lens/cover/reflector etc. can be provided over one or both sides of the FLR.

Circuits can be provided on the printed circuit board, such as, but not limited to, power supply circuits, driver circuits, control circuits, monitoring circuits, reporting circuits, interface circuits, etc. In some embodiments, circuits can include sensors such as, but not limited to, temperature sensors/thermostats, cameras, biometrics, facial recognition, thermal imaging arrays, etc. Such circuits can be located inline with LEDs, or alongside the LEDs to avoid interrupting the array of LEDs, in end caps or at any other location.

In some other embodiments, a SSL FLR includes a double strip of LEDs mounted on a printed circuit board between end caps. One or more mounting/connection pins are provided at each end. A lens/cover/reflector etc. can be provided over one or both sides of the FLR. The printed circuit board can be mounted across the widest section of the cylindrical housing, with top and/or bottom covers/lenses/diffusers/reflectors as desired. In other embodiments, the printed circuit board can be mounted nearer the top or bottom of the cylinder, as desired. More than two (double) arrays of LEDs can be used for implementations of the present invention.

In some other embodiments, a SSL FLR includes a triple strip of LEDs mounted on a printed circuit board between end caps. One or more mounting/connection pins are provided at each end. A lens/cover/reflector etc. can be provided over one or both sides of the FLR. Again, the SSL FLR can include LEDs of one or more colors including, but not limited to, two colors such as blue and amber/yellow, multi-colors, RGB, 3 colors, more than 3 colors, monochrome, white, RGBA (where A is amber), RGBW (where W is white), RGBWA, RGBWA plus additional colors, etc. Differently colored LEDs can be arranged in any desired layout/arrangement/pattern with any number of different or the same color, types of LEDs and/or OLED, QDs, other SSL, other lighting, etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, photometrics, photo-optics, other photo/optical data, etc., sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations including but not limited to in, on, into, through ceilings, walls, floors, closets, partitions, in between ceilings and roofs, crawl spaces, duct work, duct spaces, above false ceilings, etc. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless including as discussed above, powerline, etc. and can be implemented in any part of the circuit for the present invention. The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments of the present invention allow the capability to control a lamp via the AC line, via, for example but not limited to connecting the control wires directly to the AC line and using powerline communications and/or phase cut information to control among others but not limited to the dimming, the trimming, the optional color temperature/white, color tuning, etc. such that the the lamps/lights may or may not be powered by the ballast and receive control signal via the AC line ahead of the ballast (which is powered by the AC line). These embodiments can be used to increase and enhance security, range, protocol choice, etc., the need to run low-voltage wires, and then, for example, but not limited to, simply swap out the fluorescent lamps for these implementations of the present invention and join/connect the control wires to the AC-line via wire nuts or any other acceptable method.

In the case of direct-AC-line, some embodiments of the present invention can provide a somewhat shorter lamp than the traditional 2 ft, 3 ft, 4 ft, etc. lamps, U-bend lamps, etc.; for example, but not limited to, 0.5 inches shorter. On each end, add a 0.25-inch device which clicks into place within traditional tombstones. Once clicked into place, these devices provide a degree of holding/friction such that the inside lamp twists out easier than the end pieces, so when a lamp is removed, the end pieces stay in place. The end pieces could be labeled something to the effect: “no ballast in place; do not use fluorescent lamps,” or “LED only,” and would not have a traditional bi-pin connection between the end piece and the lamp (for example, could have a unique connection to the LED lamp).

Some embodiments include an over-voltage protection (OVP) circuit that shunts/shorts or limits the ballast output and/or the output to the load such as a LED array in the event that the output voltage exceeds a set value.

Some embodiments include an over temperature protection (OTP) circuit that shunts/shorts or limits the ballast output and/or the output to the load such as a LED array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention, although described primarily for motion and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (PETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unij unction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components. For example, op amp and comparator in most cases may be used in place of one another in this document.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A flexible lighting system comprising:
a plurality of lamp fixtures;
at least one solid state lighting driver connected to the plurality of lamp fixtures;
a controller configured to control electrical current through the at least one solid state lighting driver;
a monitor configured to monitor at least one electrical characteristic of power to the plurality of lamp fixtures; and
at least one sensor connected to the controller.

2. A flexible lighting system comprising:
a backplane;
a plurality of tombstone connector connection points on the backplane, configured to allow connection of a plurality of solid state fluorescent lamp replacement to the backplane at the tombstone connector connection points.

3. The flexible lighting system of claim 2, wherein the tombstone connector connection points are evenly spaced across the backplane.

4. A flexible lighting system comprising:
a backplane;
a plurality of tombstone connectors each configured to enable connection of a solid state fluorescent lamp replacement to the backplane at any location across the backplane.
